(19) United States
(12) Patent Application Publication
(10) Pub. No.: US 2004/0043338 A1
(43) Pub. Date: Mar. 4, 2004

(54) Thermally developable photosensitive material and image forming method

(75) Inventor: Hiroyuki Yanagisawa, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Corporation, Tokyo (JP)

(21) Appl. No.: 10/631,910

(22) Filed: Jul. 31, 2003

(30) Foreign Application Priority Data
Aug. 13, 2002 (JP) JP2002-235612

(51) Int. Cl. G03C 1/498; G03C 1/295; G03C 1/42; G03C 5/16

(52) U.S. Cl. 430/350; 430/218; 430/264; 430/363; 430/618; 430/619; 430/945

(57) ABSTRACT

A thermally developable light-sensitive material comprising a support having thereon light-sensitive silver halide grains, an organic silver halide salt and a reducing agent, wherein when a regression line is obtained by plotting color coordinates (u*, v*) of the thermally developable light-sensitive material at optical densities of 0.5, 1.0, 1.5 and the minimum density on a two dimensional coordinates of CIE 1976 (L* u* v*) color space, in which the abscissa is u* and the ordinate is v*, a coefficient of determination R² of the regression line is from 0.998 to 1.000.

### TECHNICAL FIELD

The present invention relates to a thermally developable light-sensitive material and an image forming method.

### BACKGROUND OF THE INVENTION

Hitherto, in the field of the medical and printing plate making, a problem of the liquid waste accompanied with the wet processing of the image forming material is raised as to the operation suitability. Recently, the reduction of the liquid waste is strongly demanded from the viewpoint of the environment protection and the space saving.

Consequently, technology relating a photo-thermal photographic material is required, which can be effectively exposed by a laser imager or a laser image setter and a clear black image with high resolution can be obtained.

As such the technology, a thermally developable light-sensitive material comprising a support having thereon an organic silver salt, light-sensitive silver halide grains and a reducing agent has be known, such as that described in U.S. Pat. Nos. 3,152,904 and 3,487,075 by D. Morgan and B. Shely, and D. H. Klosterboer “Dry Silver Photographic Materials” Hand Book of Imaging Materials, Marcel Dekker Inc., p. 48, (1991). The thermally developable light-sensitive material can provide a simpler and no environment destructing system to users since any liquid processing chemical is not used at all in the system.

Further improvement in the image quality is demanded as the eternal theme relating the thermally developable light-sensitive material. Particularly, high image quality is required in the medical field, by which further accurate diagnosis can be performed. It is occasionally pointed out that the image quality of the thermally developable light-sensitive material is inferior to that of the wet processing silver salt light-sensitive material usually used for the medical image diagnosis.

### SUMMARY OF THE INVENTION

An aspect of the invention is to provide a thermally developable light-sensitive material and an image forming method, which are superior or equal to a conventional wet processing silver halide light sensitive material in the image quality and the image diagnosis property.

The aspect of the invention can be achieved by the following structures.

1. A thermally developable light-sensitive material comprising a support having thereon light-sensitive silver halide grains, an organic silver halide salt and a reducing agent, wherein when a regression line is obtained by plotting color coordinates (u*, v*) of the thermally developable light-sensitive material at optical densities of 0.5, 1.0, 1.5 and the minimum density on a two dimensional coordinates of CIE 1976 (L* u* v*) color space, in which the abscissa is u* and the ordinate is v*, a coefficient of determination R² of the regression line is from 0.998 to 1.000.

2. The thermally developable light-sensitive material according to above-described item 1, wherein v* value of the regression line is within a range of −5 to 5 when u* is 0.

3. The thermally developable light-sensitive material according to above-described item 1, wherein the regression line has a gradient (u*/v*) of 0.7 to 2.5.

4. A thermally developable light-sensitive material comprising a support having thereon light-sensitive silver halide grains, an organic silver halide salt and a reducing agent, wherein when a regression line is obtained by plotting color coordinates (a*, b*) of the thermally developable light-sensitive material at optical densities of 0.5, 1.0, 1.5 and the minimum density on a two dimensional coordinates of CIE 1976 (L* a* b*) color space, in which the abscissa is a* and the ordinate is b*, a coefficient of determination R² of the regression line is from 0.998 to 1.000.

5. The thermally developable light-sensitive material according to above-described item 4, wherein b* value of the regression line is within a range of −5 to 5 when a* is 0.

6. The thermally developable light-sensitive material according to above-described item 4, wherein the regression line has a gradient (a*/b*) of 0.7 to 2.5.

7. A thermally developable light-sensitive material comprising a support having thereon light-sensitive silver halide grains, an organic silver halide salt and a reducing agent,

wherein when a regression line is obtained by plotting color coordinates (u*, v*) of the thermally developable light-sensitive material at optical densities of 0.5, 1.0 and 1.5 on a two dimensional coordinates of CIE 1976 (L* u* v*) color space, in which the abscissa is u* and the ordinate is v*,

a coefficient of determination R² of the regression line is from 0.998 to 1.000.

8. The thermally developable light-sensitive material according to above-described item 7, wherein v* value of the regression line is within a range of −5 to 5 when u* is 0.

9. The thermally developable light-sensitive material according to above-described item 7, wherein the regression line has a gradient (u*/v*) of 0.7 to 2.5.

10. A thermally developable light-sensitive material comprising a support having thereon light-sensitive silver halide grains, an organic silver halide salt and a reducing agent,

wherein when a regression line is obtained by plotting color coordinates (a*, b*) of the thermally developable light-sensitive material at optical densities of 0.5, 1.0 and 1.5 on a two dimensional coordinates of CIE 1976 (L* a* b*) color space, in which the abscissa is a* and the ordinate is b*,

a coefficient of determination R² of the regression line is from 0.998 to 1.000.

11. The thermally developable light-sensitive material according to above-described item 10, wherein b* value of the regression line is within a range of −5 to 5 when a* is 0.

12. The thermally developable light-sensitive material according to above-described item 10, wherein the regression line has a gradient (a*/b*) of 0.7 to 2.5.

13. The thermally developable light-sensitive material according to any one of above-describe items 1 to 12, comprising a reducing agent represented by following Formula (A-1) and a compound represented by following Formula (A-4),

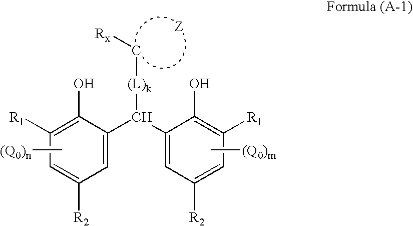

wherein Z is a group of atoms necessary for forming a 3- through 10-membered ring together with the carbon atom; Rₓ is a hydrogen atom, an alkyl group, an alkenyl group or an alkynyl group; R₁, R₂ and Q₀ are each a group capable of substituting on the benzene ring; L is divalent linking group; k is an integer of 0 or 1; and n and m are each an integer of 0 through 2; plural R₁, R₂ and Q₀ each may be the same or different,

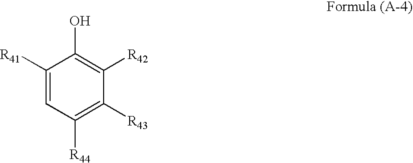

wherein R₄₁ is a substituted or unsubstituted alkyl group; R₄₂ is a hydrogen atom; a substituted or unsubstituted alkyl group or a substituted or unsubstituted acylamino group provided that R₄₁ and R₄₂ are not a 2-hydroxyphenylmethyl group; R₄₃ is a hydrogen atom of a substituted or unsubstituted alkyl group; and R₄₄ is a substituent capable of substituting on the benzene ring.

14. The thermally developable light-sensitive material according to above-described item 13, wherein at least one of R₄₁ and R₄₂ in Formula (A-4) is a divalent or trivalent alkyl group.

15. The thermally developable light-sensitive material according to above-described item 13 or 14, wherein the reducing agent represented by Formula (A-1) is a reducing agent represented by following Formula (A-2),

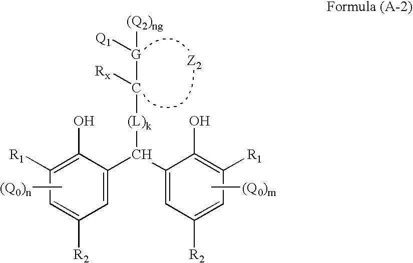

wherein Q₁ is a halogen atom, an alkyl group, an alkenyl group, an alkynyl group, an aryl group or a heterocyclic group; Q₂ is a hydrogen atom, a halogen atom, an alkyl group, an alkenyl group, an alkynyl group, an aryl group or a heterocyclic group; G is a nitrogen atom or a carbon atom that ng is 0 when G is the nitrogen atom and ng is 0 or 1 when the G is the oxygen atom; Z₂ is is a group of atoms necessary for forming a 3- through 10-membered non-aromatic ring together with the carbon atom and G; and R₁, R₂, Rₓ, Q₀, L, k, n and m are each the same as those in Formula A-1.

16. The thermally developable light-sensitive material according to above-described item 15, wherein the nonaromatic ring formed by Z₂ together with the carbon atom and G in Formula (A-2) is a 6-member non-aromatic ring.

17. The thermally developable light-sensitive material according to any one of above-described items 1 to 16, wherein the thermally developable light-sensitive material further comprises a silver saving agent selected from the group consisiting of vinyl compounds, hydrazine derovatives, silane compounds and tetravalent onium salt on the silver halide grain side of the support.

18. An image forming method comprising the step of forming an image by developing the thermally developable light sensitive material according to any one of above-described items 1 to 17 under a temperature of from 110° C. to 140° C. for a time of from 5 seconds to 20 seconds.

19. An image forming method comprising the step of forming an image by exposing the thermally developable light-sensitive material according to any one of above-described items 1 to 17 with a laser having an wavelength of from 400 nm to 830 nm.

20. An image forming method comprising the step of forming an image by exposing the thermally developable light-sensitive material according to any one of above-described items 1 to 17 with an laser having an wavelength of from 780 nm to 830 nm.

### BRIEF DESCRIPTION OF THE DRAWINGS

FIG. 1 shows a crosssectional view of a concrete example of thermal developing apparatus.

FIG. 2 shows the regression line prepared by plotting the u*, v* at respective density on the two-dimensional coordinate of the color space of CIE 1976 (L*u*v*), in which the abscissa is u* and the ordinate is v*.

FIG. 3 shows the regression line prepared by plotting the a*, b* at respective density on the two-dimensional coordinate of the color space of CIE 1976 (L*a*b*), in which the abscissa is a* and the ordinate is b*.

### DETAILED DESCRIPTION OF THE INVENTION

The invention is described in detail below. Heretofore, it has been tried to obtain a diagnostic image having a preferable visual tone by controlling the values of u* and v* in CIE 1976 (L* u* v*) color space or the values a* and b* in CIE 1976 (L* a* b*) color space to specified values at an optical density about 1.0. For example, U.S. Pat. No. 6,174,657 describes a preferable color tone (hue angle) for a thermally developable light-sensitive material. However, it was found that such the diagnostic image is inferior to that obtained by a usual wet processing silver halide light-sensitive material in the diagnostic suitability. It is found by the investigation by the inventors that an image having diagnostic suitability higher than that of the usual wet processing silver halide light-sensitive material can be obtained by controlling the regression line so as to be within the region of the invention; the regression line is prepared by plotting the points of u* and v* or a* and b* at the various photographic density of the image on a graph of CIE 1976 (L* u* v*) color space or CIE 1976 (L: a* b*) color space in which the abscissa is u* or a* and the ordinate is v* or b*.

The methods to obtain the thermally developable light-sensitive material of the present invention are not limited. For example, an agent capable of changing the shape of the developed silver or a compound capable of saving the amount of the silver necessary for obtaining a predetermined silver image density can be utilized. Further, the characteristics of the thermally developable light sensitive material can be controlled by adjusting the addition amount of the above-described compounds, and combining such compounds, appropriately.

Reducing agents can be cited as an agent capable of changing the shape of developed silver. In the invention, a phenol derivative is preferably employed as the reducing agent singly or in combination with another reducing agent having the chemical structure different from the phenol derivative. In the thermally developable light-sensitive material according to the invention, the shape of developed silver is changed by using such the reducing agent, appropriately, so that the regression line can be controlled so as to be within the range of the invention in CIE 1976 (L*u*V*) or (L*a*b*) color space. Consequently, the agnostic suitability can be raised to equal or more level of the usual wet processing silver salt light-sensitive material.

In the invention, the reducing agents represented by Formula A-1 are preferably employed, more preferably those represented by Formula A-2, are employed.

In Formula A-1, Z is a group of atoms necessary to form a 3- to 10-membered ring, such the ring is preferably a non-aromatic ting. Concrete examples of such the ring include 3-membered rings such as a cyclopropyl ring, an azyridyl, and an oxylanyl ring; 4-membered rings such as a cyclobutyl ring, a cyclobutenyl ring, an oxetanyl ring and an azetidinyl ring; 5-membered rings such as a cyclopentyl ring, a cyclopentenyl ring, cyclopentadienyl ring, a terahydrofuranyl ring, purrolydinyl ring and terahydrothienyl ring; 6-membered rings such as a cyclohexyl ring, a cyclohexenyl ring, cyclohexanedienyl ring, tetrahydropyranyl ring, a pyranyl ring, a piperidinyl ring, a dioxanyl ring, a tetrahydrothiopyranyl ring, a norcaranyl ring, a norpyranyl ring and a norbornyl ring; 7-membered rings such as a cyloheptyl ring, a cycloheptinyl ring and a cycloheptadienyl ring; 8-membered ring such as a cyclooctanyl ring, a cyclooctenyl ring, a cyclooctadienyl ring and a cyclooctatrienyl ring; 9-membered rings such as a cyclononanyl ring, a cyclononenyl ring, cyclononadienyl ring and a cyclononatrienyl ring; and 10-membered rings such as a cycrodecanyl ring, a cyclodecenyl ring, a cyclodecadienyl ring and a cyclodecatrienyl ring.

The 3- to 6-membered rings are preferable, 5- to 6-membered rings are more preferable and 6-membered rings are most preferable. Of these, the hydrocarbon rings containing no hetero atom are preferred. Such the ring may be form a spiro bond with another ring via the spiro atom, and the ring may be condensed in any state together with another ring including an aromatic ring. The rings each may have an optional substituent thereon. It is particularly preferable that the hydrocarbon ring is a hydrocarbon ring having an alkenyl or an alkynyl structure each including a —C═C— group or a —C≡C— group.

Concrete examples of the substituent include a halogen atoms such as a fluorine atom, a chlorine atom, a bromine atom; alkyl groups such as a methyl group, an ethyl group, a propyl group, a butyl group, a pentyl group, an iso-pentyl group, a 2-ethyl-hexyl group, an octyl group and a decyl group; cycloalkyl groups such as a cyclohexyl group and a cycloheptyl group; alkenyl groups such as an ethenyl-2-propenyl group, a 3-butenyl group, an 1-methyl-3-propenyl group, a 3-pentenyl group and an 1-methyl-3-butenyl group; cycloalkenyl groups such as an 1-cycloalkenyl group and a 2-cycloalkenyl group; alkynyl groups such as an ethynyl group and an 1-propynyl group; alkoxyl groups such as a methoxyl group, an ethoxyl group and a propoxyl group; alkylcarbonyloxyl groups such as an acetyloxyl group; alkylthio groups such as a methylthio group and atrifluoromethylthio group; carboxyl groups; alkylcarbonylamino groups such as an acetylamino group; ureido groups such as a methylaminocarbonylamino group; alkylsulfonylamino groups such as a methanesulfonyl group and a trifuluoromethanesulfonyl group; carbamoyl groups such as a carbamoyl group, an N,N-dimethylcarbonyl group and an N-morpholinocarbonyl group; sulfamoyl groups such as a sulfamoyl group, an N,N-dimethylsufamoyl group and a morpholinosulfamoyl group; a trifluoromethyl group; a hydroxyl group, a nitro group; a cyano group; alkylsulfonamido groups such as a methanesulfonamido group and a butanesulfonamido group; alkylamino groups such as an amino group, an N,N-dimethylamino group and an N,N-diethylamino group; a sulfo group; a phosphono group; a sulfite group; a sulfino group; alkylsulfonylaminocarbonyl groups such as a methanesulfonylaminocarbonyl group and ethanesulfonylaminocarbonyl group; alkylcarbonylaminosulfonyl groups such as an acetoamidosulfonyl group and a methoxyacetoamidosulfonyl group; alkynylaminocarbonyl groups such as an acetoamidocarbonyl group and a methoxyacetoamidocarbonyl group; and alkylsulfinylaminocarbonyl groups such as a methanesulfinylaminocarbonyl group and ethanesulfinylaminocarbonyl group. When there are two substituents, they may be the same or different from each other. Particularly preferred substituent is the alkyl group.

R₁ and R₂ are each a group capable of substituting on the benzene ring, for instance, hydrogen atom, an alkyl group, an alkenyl group, an alkynyl group and an aryl group or a heterocyclic group. Among them, hydrogen atom, an alkyl group, an aryl group or a heterocyclic group is preferable. In concrete, the alkyl group is preferably an alkyl group having from 1 to 10 carbon atoms. For example, the alkyl group is preferably a methyl group, an ethyl group, a propyl group, an iso-propyl group, a butyl group, a t-butyl group, a pentyl group, an iso-pentyl group, a 2-ethyl-hexyl group, an octyl group, a decyl group, a cyclohexyl group, cycloheptyl group and an 1-methylcyclohexyl group, the alkenyl group is preferably an ethenyl-2-propenyl group, 3-butenyl group, an 1-methyl-3-propenyl group, a 3-pentenyl group, an 1-methyl-3-butenyl group, an 1-cycloalkenyl group, a 2-cycloalkenyl group, the alkynyl group is preferably an ethynyl group and an 1-propinyl group. Methyl group, ethyl group, iso-propyl group, t-butyl group, cyclohexyl group and 1-methylcyclohexyl group are more preferable. Among them, the methyl group, tbutyl group and 1-methylcyclohexyl group are still more preferable, and methyl group is most preferable. Concrete example of the aryl group is a phenyl group, a naphthyl group and an anthranyl group. Examples of the heterocyclic group include an aromatic heterocyclic group such as a pyridyl group, a quinolyl group, an iso-quinolyl group, an imidazolyl group, a pyrazolyl group, a triazolyl group, an oxazolyl group, a thiazolyl group, an oxadiazolyl group, a thiadiazolyl group and a tetrazolyl group; and a non-aromatic heterocyclic group such a pyperidino group, a morpholino group, a tetrahydrofuryl group, a tetrahydrthienyl group and a tetrahydropyranyl group. These groups each may have a substituent. The substituent may be those listed as the substituent on the foregoing rings The groups represented by R₁ and R₂ may be the same or different from each other. It is most preferable both of the groups represented by R₁ and R₂ are methyl group.

Rₓ is a hydrogen atom, an alkyl group, an alkenyl group or an alkynyl group. The alkyl group is preferably an alkyl group having from 1 to 10 carbon atoms. Concrete examples include a methyl group, an ethyl group, a propyl group, an iso-propyl group, a butyl group, a t-butyl group, a pentyl group, an iso-pentyl group, a 2-ethylhexyl group, an octyl group, a decyl group, a cyclohexyl group, a cycloheptyl group, an 1-methylcyclohexyl group, an ethenyl-2-propenyl group, a 3-butenyl group, an 1-methyl-3-propenyl group, a 3-pentenyl group, an 1-methyl-3-butenyl group, an 1-cycloalkenyl group, a 2-cycloalkenyl group, an ethynyl group and an 1-propinyl group. Among them, methyl group, ethyl group and iso-propyl group are more preferable. Rₓ is most preferably a hydrogen atom.

Q₀ is a group capable of substituting on the benzene ring. Concrete examples of the group represented by Q₀ include an alkyl group having from 1 to 25 carbon atoms such as a methyl group, an ethyl group, a propyl group, a tertbutyl group, a pentyl group, a hexyl group and a cyclohexyl group; a halogenated alkyl group such as a trifluoromethyl group and a perfluorooctyl group; a cycloalkyl group such as a cyclohexyl group and a cyclopentyl group; an alkynyl group such as a propalgyl group; a glycidyl group; an acrylate group; a methacrylate group; an aryl group such as a phenyl group; a heterocyclic group such as a pyridyl group, a thiazolyl group, an oxazolyl group, an imidazolyl group, a furyl group, a pyrrolyl group, a pyrazinyl group, a pyrimidinyl group, a pyridazinyl group, a selenazolyl group, a suliforanyl group, pyperidinyl group, a pyrazolyl group and a tetrazolyl; a halogen atom such as a chlorine atom, a bromine atom, an iodine atom and a fluorine atom; an alkoxyl group such as a methoxyl group, an ethoxyl group, a propyloxyl group, a pentyloxyl group, a cyclopentyloxly group, a hexyloxyl group and a cyclohexyloxyl group; an aryloxyl group such as a phenoxyl group; an alkoxycarbonyl group such as a methyloxycarbonyl group, an ethyloxycarbonyl group and butyloxylcarbonyl group; an aryloxycarbonyl group such as a phenyloxycarbonyl group; a sulfonamide group such as a methanesulfonamido group, an ethanesulfonamido group, a butanesulfonamide group, a hexanesulfonamide group, a cyclohexanesulfonamido group and a benzenesulfonamido group; a sulfamoyl group such as an aminosulfonyl group, a methylaminosulfonyl group, dimethylaminosulfonyl group, a butylaminosulfonyl group, a hexylaminosulfonyl, a cyclohexylaminosulfonyl group, a phenylaminosulfonyl group and a 2-pyridylaminosulfonyl group; a urethane group such as a methylureido group, an ethylureido group, a pentylureido group, a cyclohexylureido group, a phenylureido group and a pyridylureido group; an acyl group such as an acetyl group, a propionyl group, a butanoyl group, a hexanoyl group, a cyclohexanoyl group, a benzoyl group and a pyridinoyl group; a carbamoyl group such as an aminocarbonyl group, a methylaminocarbonyl group, a dimethylaminocarbonyl group, a propylaminocarbonyl group, a pentylaminocarbonyl group, a cyclohexylaminocarbonyl group, a phenylaminocarbonyl group and a 2-pyridylaminocarbonyl group; an amido group such as an acetoamido group, a propionamido group, a butanamido group, a hexanamido group and a bezamido group; a sulfonyl group such as a methylsulfnyl group, an ethylsufonyl group, a butylsulfonyl group, a cyclohexylsulfonyl group, a phenylsulfonyl group and a 2-pyridylsulfonyl group; an amino group such as an amino group, an ethylamino group, a dimethylamino group, a butylamino group, a cyclopentylamino group, an anilino group and a 2-pyridylamino group; a cyano group; a nitro group; a sulfo group; a carboxyl group; a hydroxyl group; and a oxamoyl group. The above groups each may be substituted by one or more of these groups. n and m are each represent an integer of from 0 to 2. Most preferably both of n and m are zero.

L is a divalent linking group, which is preferably an alkyl group such as a methyl group, an ethyl group and a propyl group. The number of the carbon atoms of the alkyl group is preferably from 1 to 20, more preferably from 1 to 5. k is an integer of o or 1, most preferably 0.

In Formula A-2, Q₁ is a halogen atom, an alkyl group, an alkenyl group, an alkynyl group, an aryl group or a heterocyclic group; and Q₂ is a halogen atom, an alkyl group, an alkenyl group, an alkynyl group, an aryl group or a heterocyclic group. The concrete halogen atom is a chlorine atom, a fluorine atom, a bromine atom or an iodine atom, and a chlorine atom, a fluorine atom, a bromine atom are preferable. The alkyl group is preferably an alkyl group having from 1 to 10 carbon atoms. Concrete examples of the alkyl group include a methyl group, an ethyl group, a propyl group, an iso-propyl group, a butyl group, a t-butyl group, a pentyl group, an iso-pentyl group, a 2-ethyl-hexyl group, an octyl group, a decyl group, a cyclohexyl group, a cyclobutyl group, an 1-methylcyclohexyl group, an ethenyl-2-propenyl group, a 3-butenyl group, an 1-methyl-3-propenyl group, a 3-pentenyl group, an 1-methyl-3-butenyl group, an 1-cycloalkenyl group, a 2-cycloalkenyl group, an ethynyl group and a propinyl group. The methyl group and ethyl group are preferred. Concrete examples of the aryl group include a phenyl group and a naphthyl group. As the heterocyclic group, a 5- and 6-membered aromatic heterocyclic group such as a pyridyl group, a furyl group, a thienyl group and oxazolyl group are preferable. G is a nitrogen atom or a carbon atom, and the carbon atom is preferred. n_{g} is 0 or 1, and preferably 1.

Q₁ is most preferably a methyl group. Q₂ is preferably a hydrogen atom or a methyl group, most preferably a hydrogen atom.

Z₂ represents a group of atoms necessary to form a 3- to 10-membered non-aromatic ring. The 3- to 10-membered non-aromatic rings are the same as those in the foregoing Formula A-1.

R₁, R₂, Rₓ, Q₀, k, n and m are each the same as those defined in Formula A-1, respectively.

In the invention, it is preferable that a compound represented by Formula A-1 and a compound represented by the following Formula A-3 in combination. The using ratio of (Weight of compound of Formula A-1):(Weight of compound of Formula A-3) is preferably from 95:5 to 55:45, more preferably from 90:10 to 60:40.

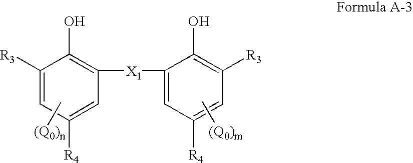

In Formula A-3, X₁ is a chalcogen atom or a —CH(R)—. The chalcogen atom is a sulfur atom, a selenium atom or a tellurium atom. R in the —CH(R)— is a hydrogen atom, a halogen atom, an alkyl group, an alkenyl group and an alkynyl group. The halogen atom is, for instance, a fluorine atom, a chlorine atom or a bromine atom. As the alkyl group, a substituted or unsubstituted alkyl group having from 1 to 20 carbon atoms is preferable. Concrete examples of the alkyl group include a methyl group, an ethyl group, a propyl group, a hexyl group, a vinyl group, a butenyl group, a hexadienyl group, an ethenyl-2-propenyl group, a 3-butenyl group, a 1-methyl-3-propenyl group, a 3-pentenyl group and a 1-methyl-3-butenyl group.

The foregoing groups each may have a substituent. Examples of the substituent include a halogen atom such as a fluorine atom, a chlorine atom and a bromine atom; a cycloalkyl group such as a cyclohexyl group and a cycloheptyl group; a cycloalkenyl group such as an 1-cycloalkenyl group and a 2-cycloalkenyl group; an alkoxyl group such as a methoxyl group, an ethoxyl group and a propoxyl group; an alkylcarbonyl group such as an acetyloxyl group; an alkylthio group such as a methylthio group and a trifluoromethylthio group; a carboxyl group; an alkylcarbonylamino group such as an acetylamino group; a ureido group such as a methylaminocarbonylamino group; an alkylsulfonylamino group such as a methanesulfonylamino group; an alkylsulfonyl group such as a methanesulfonylamino group and a trifluoromethanesulfonylamino group; an alkylsulfonyl group such as a methanesulfonyl group and trifluoromethanesulfonyl group; a carbamoyl group such as a carbamoyl group, an N,N-dimethylcarbamoyl group and an N-morpholinocarbonyl group; a sulfamoyl group such as a sulfamoyl group, an N,N-dimethylsulfamoyl group and a morpholinosulfamoyl group; a trifluoromethyl group; a hydroxyl group; nitro group; a cyano group; an sulfonamido group such as a methanesulfonamido group and a butanesulfonamido group; an alkylamino group such as an amino group, an N,N-dimethylamino group and an N,N-diethylamino group; a sulfo group; a phosphono group; a sulfite group; a sulfino group; an alkylsulfonylaminocarbonyl group such as a methanesulfonylaminocarbonyl group and an ethanesulfonylaminocarbonyl group; an alkylcarbonylaminosulfonyl group such as an acetoamidosuofonyl group and a methoxyacetoamidosulfonyl group; an alkynylaminocarbonyl group such as an acetoamidocarbonyl group and a methoxyacetoamidocarbonyl group; and an alkylsulfinylaminocarbonyl group such as a methanesulfinylaminocarbonyl group and an ethanesulfinylaminocarbonyl group. When there are two or more substituents, they may be the same or different from each other.

Each R₃ is an alkyl group and may be the same or different and at least one of R₃ is a secondary or tertiary alkyl group. The alkyl group is preferably a substituted or unsubstituted alkyl group having from 1 to 20 carbon atoms. Concrete examples of the alkyl group include a methyl group, an ethyl group, a propyl group, an iso-propyl group, a tbutyl group, a t-amyl group, a t-octyl group, a cyclohexyl group, cyclopentyl group, a 1-methylhexyl group and a 1-methylcyclopropyl group.

There is no limitation on the substituent of the alkyl group. Examples of the substituent include an aryl group, a hydroxyl group, an alkoxyl group, an aryloxyl group, an alkylthio group, an arylthio group, an acylamino group, a sulfonamido group, a sulfonyl group, a phosphoryl group, an acyl group, a carbamoyl group, an ester group and a halogen atom. The substitute may form a saturated ring with (Q₀)ₙ and (Q₀)ₙ. R₁ is preferably a secondary or tertiary alkyl group and the number of the carbon atom of the alkyl group is preferably from 2 to 20. The tertiary alkyl group is more preferable. A t-butyl group, z t-amyl group and a 1-methylcyclohexyl group are more preferable and the 1-methylcyclohexyl group is most preferable.

R₄ is a group capable of being a substituent of the benzene ring. Examples of such the group include a halogen atom such as a fluorine atom, a chlorine atom and a bromine atom, an alkyl group, an aryl group, a cycloalkyl group, an alkenyl group, a cycloalkenyl group, an alkynyl group, an amino group, an acyl group, an acyloxyl group, an acylamino group, a sulfonylamino group, a sulfamoyl group, a carbamoyl group, an alkylthio group, a sulfonyl group, an alkylsulfonyl group, a sulfinyl group, a cyano group and a heterocyclic group. The plural groups represented by R₃ and R₄ may be the same of different.

The group represented by R₄ is preferably one having from 1 to 5, preferably 1 or 2, carbon atoms. These groups each may further have a substituent. Examples of the substituent include a halogen atom such as a fluorine atom, a chlorine atom and a bromine atom; an alkyl group such as a methyl group, an ethyl group, a propyl group, a butyl group, a pentyl group, an iso-pentyl group, a 2-ethylhexyl group, an octyl group and a decyl group; a cycloalkyl group such as a cyclohexyl group and a cycloheptyl group; an alkenyl group such as an ethenyl-2-propenyl group, a 3-butenyl group, an 1-methyl-3-propenyl group, a 3-pentenyl group and an 1-methyl-3-butenyl group; a cycloalkenyl group such as an 1-cycloalkenyl group and a 2-cycloalkenyl group; an alkynyl group such as an ethynyl group and an 1-propynyl group; an alkoxyl group such as a methoxyl group, an ethoxyl group and a propoxyl group; an alkylcarbonyloxyl group such as an acetyloxyl group; an alkylthio group such as a methylthio group and a trifluoromethylthio group; a carboxyl group; an alkylcarbonylamino group such as an acetylamino group; a ureido group such as a methylaminocarbonylamino group; an alkylsulfonylamino group such as a methanesulfonylamino group; an alkylsulfonyl group such as a methanesulfonyl group and a trifluoromethanesulfonyl group; a carbamoyl group such as a carbamoyl group, an N,N-dimethylcarbamoyl group and a N-morpholinocarbonyl group; a sulfamoyl group such as a sulfamoyl group, an N,N-dimethylsulfamoyl group and a morpholinosulfamoyl group; a trifluoromethyl group; a hydroxyl group; a nitro group; a cyano group; an alkylsulfonamido group such as a methanesulfonamido group and a butanesulfonamido group; an alkylamino group such as amino group, an N,N-dimethylamino group and an N,N-diethylamino group; a sulfo group; a phosphono group; a sulfite group; a sulfino group; an alkylsulfonylaminocarbonyl group such as a methanesulfonylaminocarbonyl group and an ethanesulfonylaminocarbonyl group; an alkylcarbonylaminosulfonyl group such as an acetoamidosulfonyl group and an methoxyacetoamidosulfonyl group; an alkynylaminocarbonyl group such as an acetoamidocarbonyl group and a methoxyacetoamidocarbonyl group; an alkylsulfinylaminocarbonyl group such as a methanesulfinylaminocarbonyl group and an ethanesulfinylaminocarbonyl group. R₄s are either an alkyl group having from 1 to 20 carbon atoms, and the methyl group is most preferable.

Q₀ is the same as that in Formula A-1. Q₀ may form a saturated ring together with R₄. Q₀ is preferably a hydrogen atom, a halogen atom or an alkyl group. The hydrogen atom is preferable.

Concrete examples of the compound represented by Formula A-1, A-2 or A-3 are described below. However, the compound is not limited to the followings.

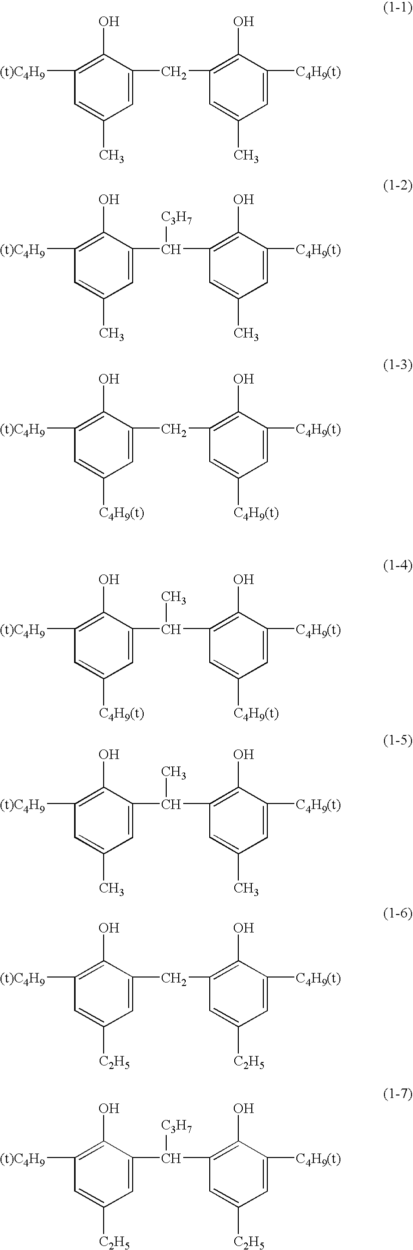

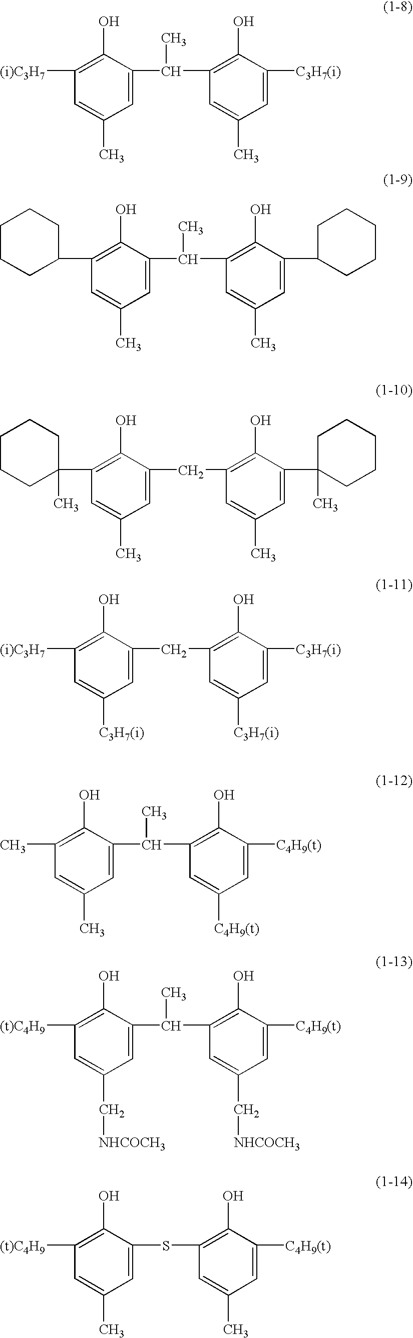

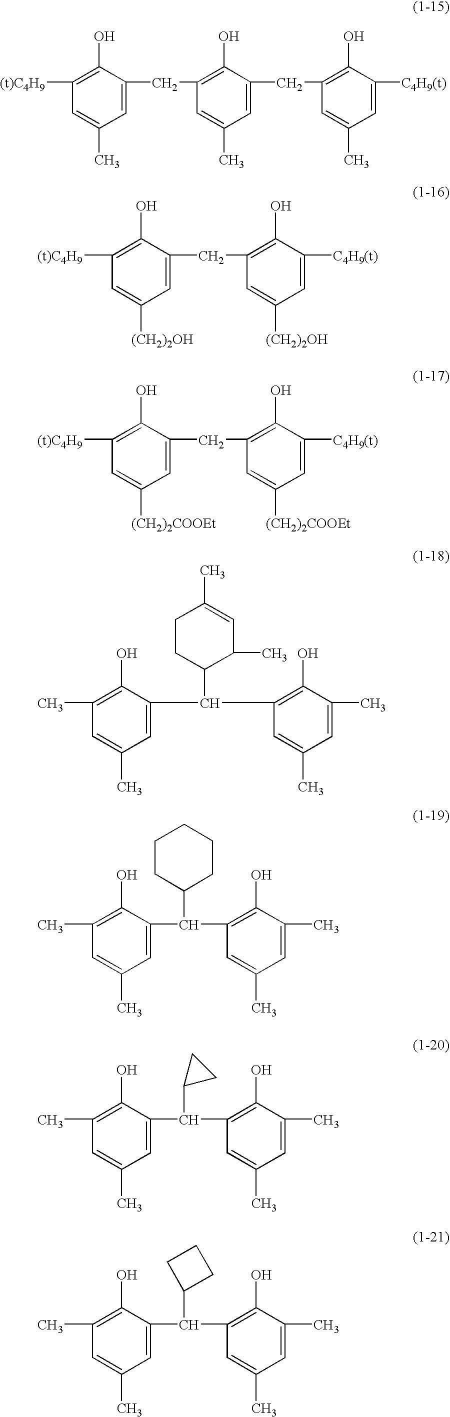

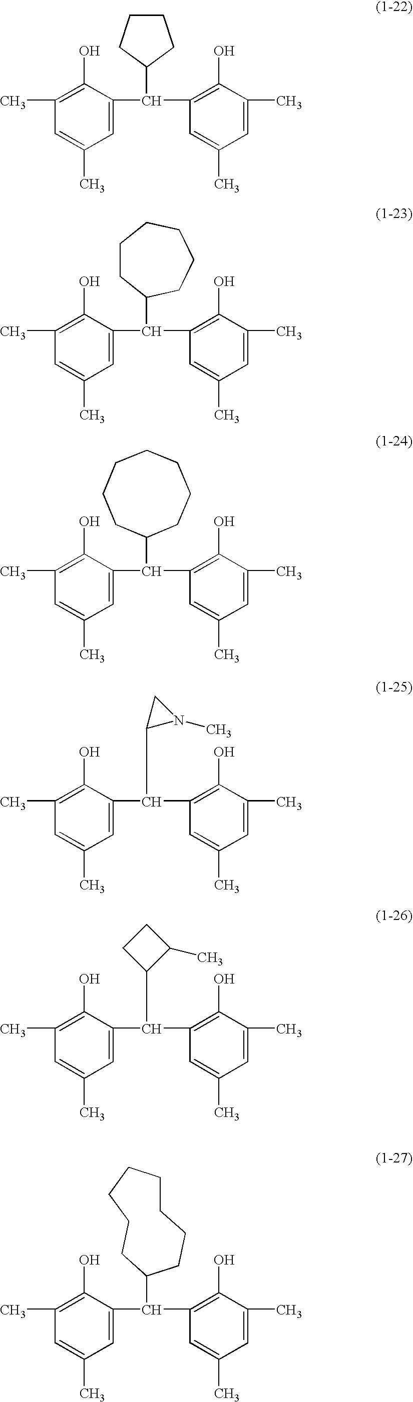

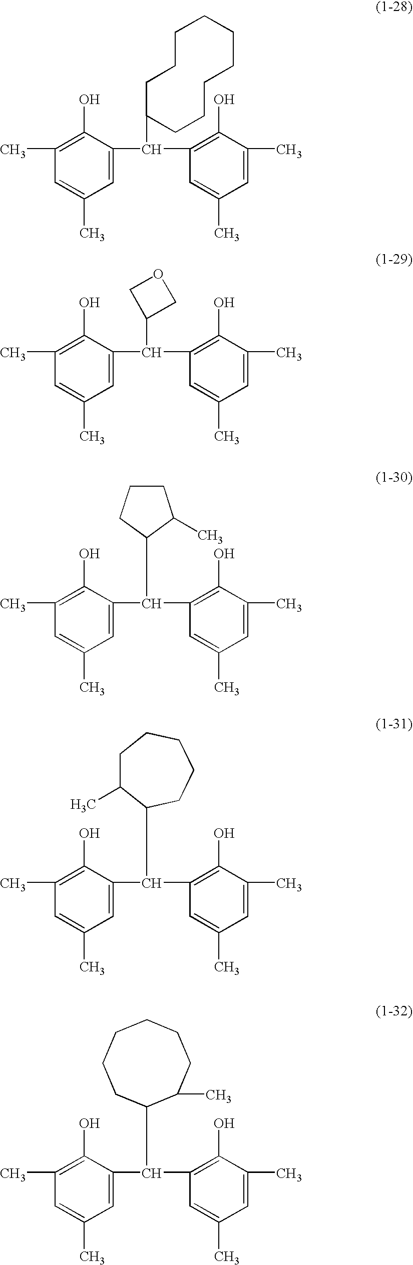

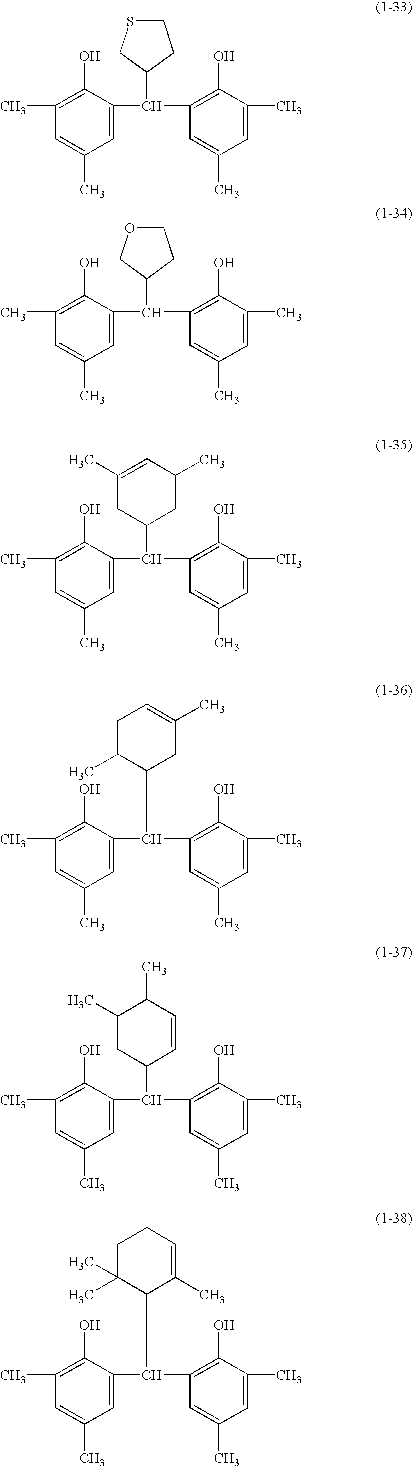

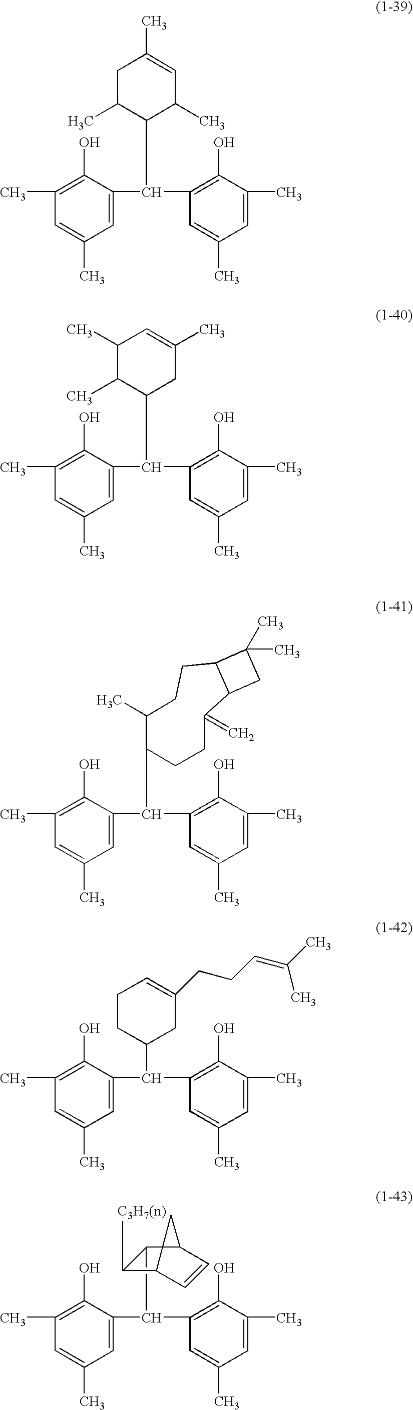

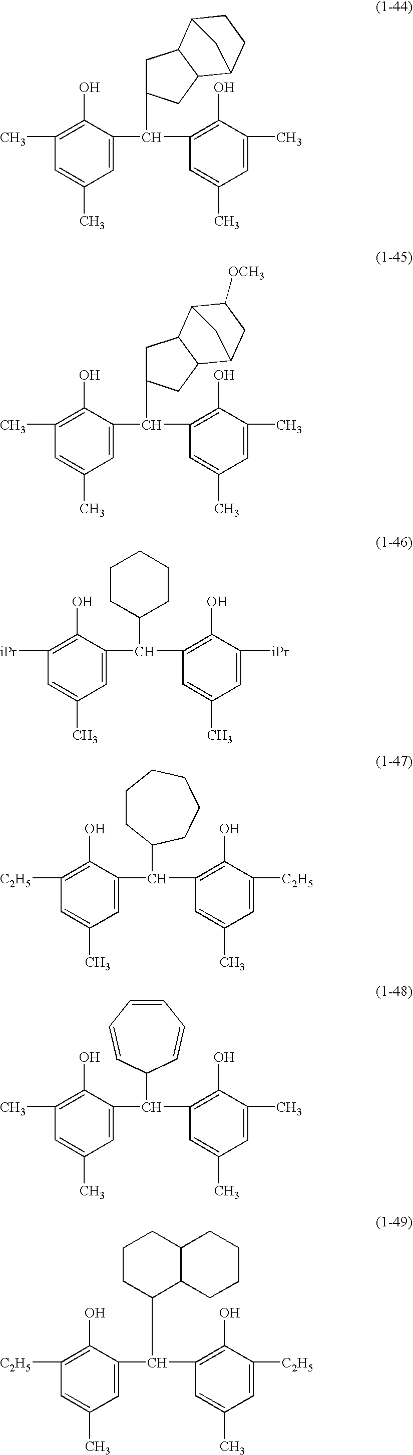

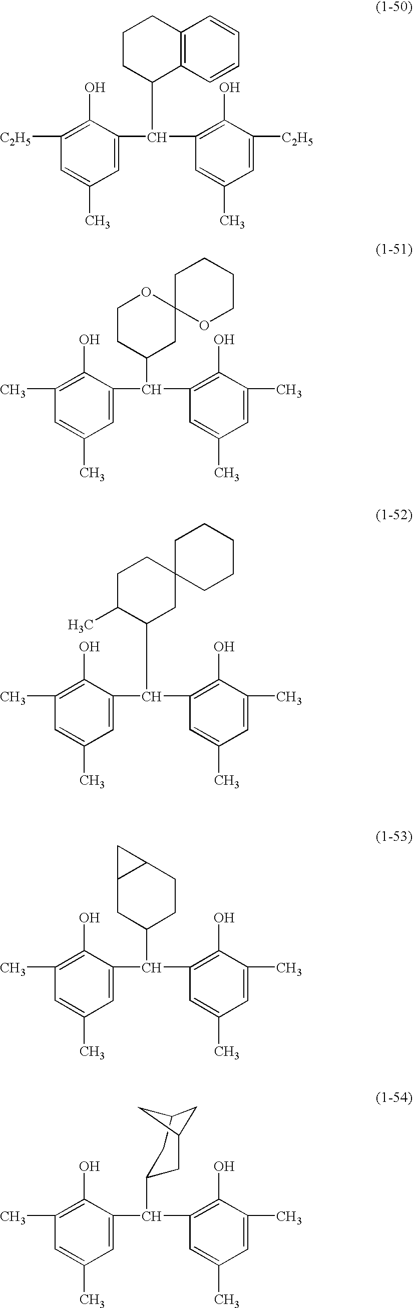

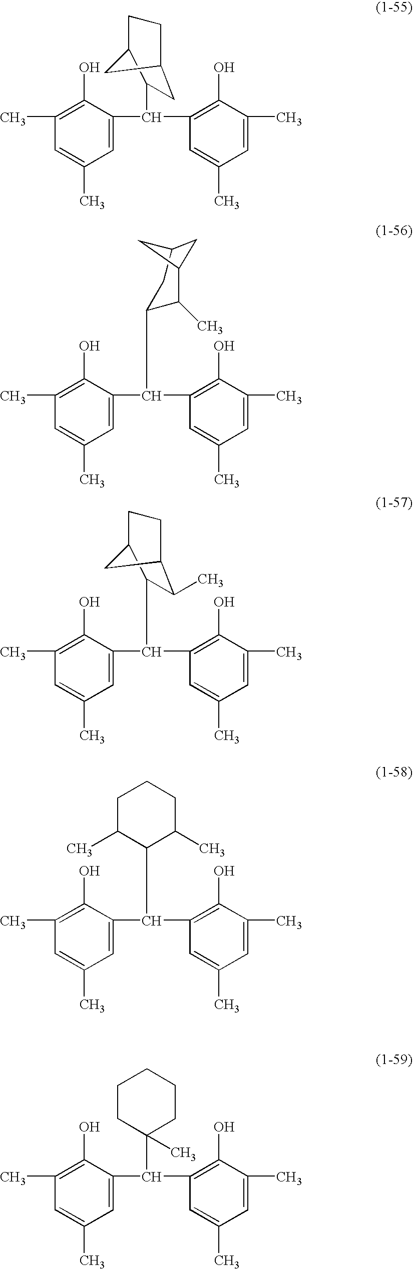

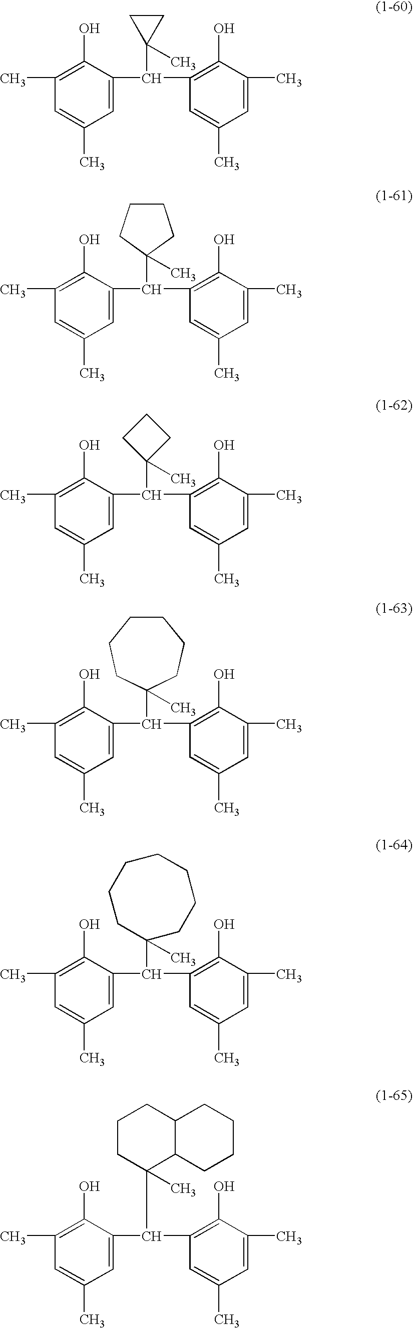

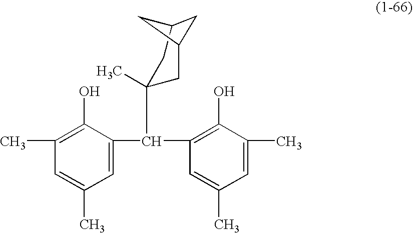

The compounds represented by Formula A-1, A-2 or A-3 can be easily synthesized by usually known methods. A preferable synthesizing scheme in the case of the compound of Formula A-1 is shown below.

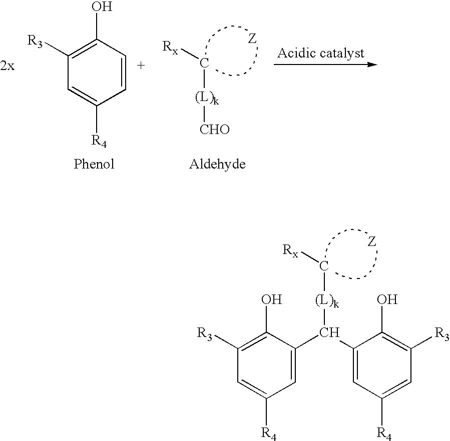

Preferably, two equivalents of phenol and one equivalent of aldehyde are dissolved or dispersed with a suitable organic solvent or without solvent and an acid in a catalyst amount is added and the reaction is performed preferable at a temperature of from −20 to 120° C. for a period from 0.5 to 60 hours. Thus the compound corresponding to Formula A-1 can be obtained with high yield. The compounds represented by Formula A-2 or A-3 are similarly obtained.

The organic solvent is preferably a hydrocarbon compound such as benzene, toluene, dichloromethane and chloroform. Toluene is preferred. The reaction without solvent is preferred from the viewpoint of the yield. As the acidic catalyst, concentrated hydrochloric acid, p-toluenesulfonic acid and phosphoric acid are preferably usable even though any inorganic and organic acid can be employed. The amount of the catalyst is preferably from 0.005 to 1.5 equivalents to the aldehyde. The reaction temperature is preferably near the room temperature of from 15 to 25° C. and the reaction time is preferably from 3 to 20 hours.

In the invention, the followings may also be employed as the silver ion reducing agent: polyphenol compounds described in U.S. Pat. Nos. 3,589,903 and 4,021,249, British Patent No. 1,486,148, Japanese Patent Publication Open to Public Inspection Nos. 51-51833, 50-36110, 50-116023, 52-84727, and Japanese Examined Patent Publication No. 51-35727; bisnaphtholes described in U.S. Pat. No. 3,672,904 such as 2,2′-dihydroxy-binaphthyl and 6,6′-dibromo-2,2′-dihydroxy-1,1′-binaphthyl; sulfonamidophenols and sulfonamidenaphthols described I U.S. Pat. No. 3,801,321 such as 4-benzenesulfonamidephenol, 2-benzenesulfonamidophenol, 2,6-dichloro-4-benzenesulfonamidophenol and 4-benznesulfonamidomaphthol.

Other than the above, the following are also usable: polyphenols described in U.S. Pat. Nos. 3,589,903 and 4,021,249, British Patent No. 1,486,148, Japanese Patent Publication Open to Public Inspection Nos. 51-51933, 5036110, 50-116023 and 52-84727, and Japanese Patent Examined Publication No. 51-35727; bisnaphthols described in U.S. Pat. No. 3,672,904 such as 2,2′-dihydroxy-1,1′-binaphthyl and 6,6′-dibromo2,2′-dihydroxy-1,1′-binaphthyl; and sulfonamidophenols and sulfonamidonaphthols described in U.S. Pat. No. 3,801,321 such as 4-benzenesulfonamidophenol, 2-benmzenesulfonamidophenol, 2,6-dichloro-4-benzenesulfonamidophenol and 4-benzenesulfonamidonaphthol.

The employing amount of each of the reducing agents including the compounds represented by Formula A-1, A-2 or A-3 is preferably from 1×10⁻² to 10 moles, particularly preferably from 1×10⁻² to 1.5 moles, per mole of silver.

The amount of the reducing agent to be employed in the thermally developable light-sensitive material according to the invention is usually 0.05 to 10 moles, preferably from 0.1 to 3 moles, per mole of the organic silver salt even though the amount is changed depending on the kind of the organic silver salt, the reducing agent or another additive. Two or more kinds of the reducing agent can be used in combination within the foregoing range of the adding amount. In the invention, it is sometimes preferred to add the reducing agent to a light-sensitive emulsion comprising light-sensitive silver halide, the organic silver salt particles and a solvent just before the coating of the light-sensitive emulsion.

Compounds represented by Formula A-4 are described below. In Formula A-4, R₄₁ is a substituted or unsubstituted alkyl group. In Formula A-4, R₄₁ is an alkyl group when R₄₂ is a substituent other than a hydrogen atom. As the alkyl group, ones each having from 1 to 30 carbon atoms are preferred. The alkyl group may have a substituted or not. Concretely, the alkyl group is preferably a methyl group, an ethyl group, a butyl group, an octyl group, an iso-propyl group, a tert-butyl group, a tert-amyl group, a cydlohexyl group and a 1-methyl-cyclohexyl group. The alkyl group is preferably a group having a large steric structure such as an iso-propyl group, an iso-nonyl group, a tert-butyl group, a tert-amyl group, a tert-octyl group, a cyclohexyl group, a 1-methyl-cyclohexyl group and an adamantyl group. Among them, a secondary and tertiary alkyl groups are preferred. The tertiary alkyl group such as the tert-butyl group, tert-octyl group and tert-amyl group are particularly preferred. When R₄₁ has a substituent, examples of the substituent include a halogen atom, an aryl group, an alkoxyl group, an amino group, an acylamino group, an alkylthio group, an arylthio group, a sulfonamido group, an acyloxyl group, an oxycarbonyl group, a carbamoyl group, a sulfamoyl group, a sulfonyl group, and a phosphoryl group.

R₄₂ is a substituted or unsubstituted alkyl group or a substituted or unsubstituted acylamino group. The alkyl group represented by R₄₂ is preferably one having from 1 to 30 carbon atoms. The examples of the alkyl groups are the same as those of R₄₁. The acylamino group may have a substituent or not. Concrete examples of the acylamino group include an acetylamino group, an alkoxyacetylamino group and aryloxyacetylamino group. R₄₂ is preferably a hydrogen atom or an unsubstituted alkyl group having from 1 to 24 carbon atoms such as a methyl group, an isopropyl group t-butyl group. R₄₁ and R₄₂ are not 2-hydroxylphenylmethyl group.

R₄₃ is a hydrogen atom or a substituted or unsubstituted alkyl group. The alkyl group represented by R₄₃ is preferably an alkyl group having from 1 to 30 carbon atoms. The detail of the alkyl group is the same as that described as to R₄₁. R₄₃ is preferably a hydrogen atom or an unsubstituted alkyl group having from 1 to 24 carbon atoms such as a methyl group, an iso-propyl group and a tert-butyl group. One of R₄₂ and R₄₃ is preferably a hydrogen atom.

R₄₄ represents a group capable of substituting on the benzene ring, for example, the same as that as to R₂ in Formula A-1. R₄₄ is preferably a substituted or unsubstituted alkyl group having from 1 to 30 carbon atoms or an oxycarbonyl group having from 2 to 30 carbon atoms; and an alkyl group having from 1 to 24 carbon atoms is more preferable. Examples of the substituent of the alkyl group include an aryl group, an amino group, an alkoxyl group, an oxycarbonyl group, an acylamino group, an acyloxyl group, an imido group and an ureido group; and the aryl group, amino group, oxycarbonyl group and alkoxyl group are preferable. These substituents of the alkyl group each may have a substituent.

Moreover, R₄₄ represents a substituent by which the compound represented by Formula A-4 is become compounds represented by the following Formula A-5. Namely, the compounds represented by Formula A-5 are more preferably among those represented by Formula A-4.

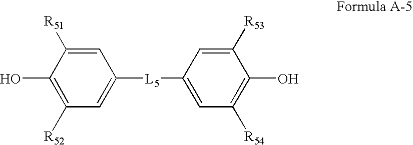

In the above formula, R₅₁, R₅₂, R₅₃ and R₅₄ are each independently a substituted or unsubstituted alkyl group having from 1 to 20 carbon atoms. The substituent of the alkyl group is preferably an aryl group, a hydroxyl group, an alkoxyl group, an aryloxyl group, an alkylthio group, an acylamino group, a sulfonamido group, a sulfonamido group, an a sulfonyl group, a phosphoryl group, an acyl group, a carbamoyl group, a carbamoyl group, an ester group and a halogen atom, even though there is no limitation on the substituent. It is preferable that at least one, preferably two or more, groups which are each sterically larger than the isopropyl group are present in R₅₁, R₅₂, R₅₃ and R₅₄. A tert-butyl group, a tert-octyl group and a tert-amyl group which are a tertiary alkyl group are particularly preferable as the group sterically larger than isopropyl group. L₅ in Formula A-5 is the same as that as to L in Formula A-1.

As examples of the compound represented by Formula A-4 or Formula A-5, Compounds of from II-1 to II-40 described in paragraphs 0032 to 0038 of Japanese Patent Publication Open to Public Inspection No. 2002-169249 and compounds of from ITS-1 to ITS-12 described if paragraph 0026 of European Patent No. 1211093 can be referred.

Examples of the compound represented by Formula 4 or Formula 5 each to be employed in the invention are shown below. However, the compounds usable in the invention are not limited thereto.

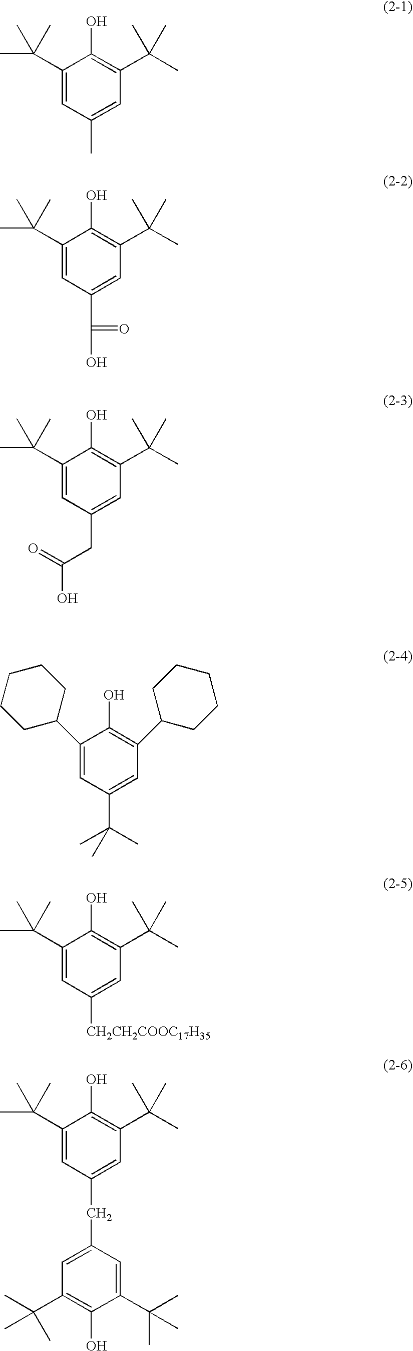

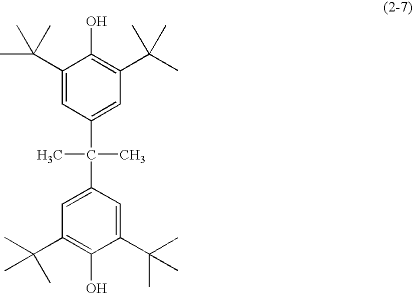

The compounds each represented by Formula A-4 or Formula A-5 may be added to the coating liquid for being contained into the light-sensitive material by an optional method such as in a form of solution, emulsified dispersion and solid fine particle dispersion in the same manner as for the compounds represented by Formula A-1.

The ratio of the adding amount in mole of the hindered phenol compound represented by Formula A-4, including the compound represented by Formula A-5, to the total amount of the o-position-bonded polyphenol compound represented by Formula A-1, A-2 or A-3, namely (Compound of Formula A-4 to A-5)/(compound of Formula A-1 to A-3), is within the range of from 0.001 to 0.2, preferably from 0.005 to 0.1, and more preferably from 0.008 to 0.05. The compound of Formula A-1 to A-5 is preferably added to the image forming layer containing the organic silver salt, but it is allowed that one is contained in the image forming layer and another is contained in a non-image forming layer adjacent to the image forming layer, and both of them are contained in the non-image forming layer. Moreover, they may be separately added to each of the layers when the image forming layer is constituted by plural layers. In the thermally developable light-sensitive material according to the invention, phenol derivatives represented by Formula A described in Japanese Patent Publication Open to Public Inspection No. 2000-267222 may be preferably employed as a development accelerating agent.

In the invention, as the compound for saving the amount of silver to obtain a predetermined silver image density, silver saving agents can be utilized, and the effects of the invention can be further enhanced by the use of the silver saving agent.

Various action mechanisms are considered to explain the functions saving the necessary amount of silver. However, preferred are compounds which enhance the covering power of silver formed through development. The covering power of silver formed though development, as described herein, refers to the optical density per unit amount of silver.

Listed as preferred examples of silver saving agents are hydrazine derivatives represented by Formula H described below, vinyl compounds represented by Formula G described below, and quaternary onium compounds represented by Formula P described below.

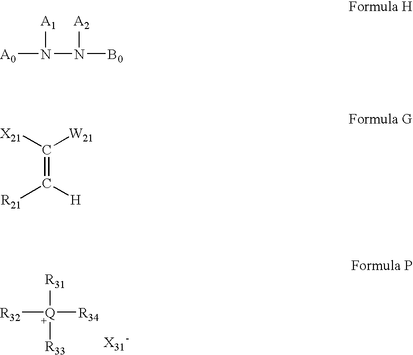

In Formula H, A₀ represents an aliphatic group, an aromatic group, a heterocyclic group, or a -G₀-D₀ group, each of which may have a substituent; B₀ represents a blocking group; and A₁ and A₂ each represents a hydrogen atom, or one represents a hydrogen atom and the other represents an acyl group, a sulfonyl group, or a oxalyl group. Herein, G₀ represents a —CO— group, a —COCO— group, a —CS— group, a —C(═NG₁D₁)— group, a —SO— group, a —SO₂— group, or a —P(O)(G₁Dₗ)— group, wherein G₁ represents a simple bonding atom or a group such as an —O— group, a —S— group, or an —N(D₁)— group, wherein D₁ represents an aliphatic group, an aromatic group, a heterocyclic group, or a hydrogen atom; when there is a plurality of D₁ in the molecule, those may be the same or different; and D₀ represents a hydrogen atom, an aliphatic group, an aromatic group, a heterocyclic group, an amino group, an alkoxy group, an aryloxy group, an alkylthio group, or an arylthio group. Listed as preferred D₀ are a hydrogen atom, an alkyl group, an alkoxy group, and an amino group.

In Formula [H], the aliphatic group represented by A₀ is preferably a straight chain, branched chain, or cyclic alkyl group having from 1 to 30 carbon atoms and more preferably from 1 to 20 carbon atoms. Listed as the alkyl groups are, for example, a methyl group, an ethyl group, a t-butyl group, an octyl group, a cyclohexyl group, and a benzyl group. The groups may be substituted with a suitable substituent such as an aryl group, an alkoxy group, an aryloxy group, an alkylthio group, an arylthio group, a sulfoxyl group, a sulfonamido group, a sulfamoyl group, an acylamino group, and an ureido group.

In Formula [H], the aromatic group represented by A₀ is preferably a single ring or fused ring aryl group. Listed as examples are a benzene ring and a naphthalene ring. Preferably listed as heterocyclic groups represented by A₀ are those containing at least one heteroatom selected from nitrogen, sulfur and oxygen atoms. Listed as examples are a pyrrolidine ring, an imidazole ring, a tetrahydrofuran ring, a morpholine ring, a pyridine ring, a pyrimidine ring, a quinoline ring, a thiazole ring, a benzothiazole ring, a thiophene ring, and a furan ring. The aromatic ring, heterocyclic group, and a -G₀-D₀ group may each have a substituent. Particularly preferred as A₀ are an aryl group and a -G₀-D₀- group.

Further, in Formula [H], A₀ preferably contains at least one of non-diffusive groups or silver halide adsorbing groups. Preferred as the non-diffusive groups are ballast groups which are commonly employed for immobilized photographic additives such as couplers. Listed as ballast groups are an alkyl group, an alkenyl group, an alkynyl group, an alkoxy group, a phenyl group, a phenoxy group, and an alkylphenoxy group, which are photographically inactive. The total number of carbon atoms of the portion of the substituent is preferably at least 8.

In Formula [H], listed as silver halide adsorption enhancing groups are thiourea, a thiourethane group, a mercapto group, a thioether group, a thione group, a heterocyclic group, a thioamido heterocyclic group, a mercapto heterocyclic group, or the adsorption group described in Japanese Patent Publication Open to Public Inspection No. 64-90439.

In Formula [H], B₀ represents a blocking group, and preferably represents -G₀-D₀ group, wherein G₀ represents a —CO— group, a —COCO— group, a —CS— group, a —C(═NG₁D₁)- group, an —SO— group, an —SO₂— group, or a —P(O)(G₁D₁) group. Listed as preferred G₀ are a —CO— group and a —COCO— group. G₁ represents a simple bonding atom or group such as an —O— atom, an —S— atom or an —N(D₁)- group, wherein D₁ represents an aliphatic group, an aromatic group, a heterocyclic group, or a hydrogen atom, and when there is a plurality of D₁ in a molecule, they may be the same or different. D₀ represents a hydrogen atom, an aliphatic group, an aromatic group, a heterocyclic group, an amino group, an alkoxy group, an aryloxy group, an alkylthio group, and an arylthio group. Listed as preferred D₀ are a hydrogen atom, an alkyl group, an alkoxy group, and an amino group. A₁ and A₂ each represents a hydrogen atom, or when one represents a hydrogen atom, the other represents an acyl group such as an acetyl group, a trifluoroacetyl group, and a benzoyl group, a sulfonyl group such as a methanesulfonyl group and a toluenesulfonyl group, or an oxalyl group such as an ethoxalyl group.

The compounds represented by Formula [H] can be easily synthesized employing methods known in the art. They can be synthesized based on, for example, U.S. Pat. Nos. 5,464,738 and 5,496,695.

Other than those, preferably usable hydrazine derivatives include Compounds H-1 through H-29 described in columns 11 through 20 of U.S. Pat. No. 5,545,505, and Compounds 1 through 12 in columns 9 through 11 of U.S. Pat. No. 5,464,738. The hydrazine derivatives can be synthesized employing methods known in the art.

In Formula G, X₂, as well as R₂₁ are illustrated utilizing a cis form, while X₂₁ and R₂₁ include trans form. This is applied to the structure illustration of specific compounds.

In Formula G, X₂₁ represents an electron attractive group, while W₂₁ represents a hydrogen atom, an alkyl group, an alkenyl group, an alkynyl group, an aryl group, a heterocyclic group, a halogen atom, an acyl group, a thioacyl group, an oxalyl group, an oxyoxalyl group, a thioxyalyl group, an oxamoyl group, an oxycarbonyl group, a thiocarbonyl group, a carbamoyl group, a thiocarbamoyl group, a sulfonyl group, a sulfinyl group, an oxysulfinyl group, a thiosulfinyl group, a sulfamoyl group, an oxysulfinyl group, a thiosulfinyl group, a sulfinamoyl group, a phosphoryl group, a nitro group, an imino group, an N-carbonylimino group, an N-sulfonylimino group, a dicyanoethylene group, an ammonium group, a sulfonium group, a phosphonium group, a pyrylium group and an immonium group.

R₂₁ represents a halogen atom, a hydroxyl group, an alkoxy group, an aryloxy group, a heterocyclic oxy group, an alkenyloxy group, an acyloxy group, an alkoxycarbonyloxy group, an aminocarbonyloxy group, a mercapto group, an alkylthio group, an arylthio group, a heterocyclic thio group, an alkenylthio group, an acylthio group, an alkoxycarbonylthio group, an aminocarbonylthio group, an organic or inorganic salt of a hydroxyl group or a mercapto group, for example, a sodium salt, a potassium salt and a silver salt, an amino group, an alkylamino group, a cyclic amino group such as a pyrrolidino group, an acylamino group, an oxycarbonylamino group, a heterocyclic group, namely a nitrogen-containing 5- or 6-membered heterocyclic ring such as a benztriazolyl group, an imidazolyl group, a triazolyl group, and a tetrazolyl group, a ureido group, and a sulfonamido group. X₂₁ and W₂₁ may be joined together to form a ring structure, while X₂₁ and R₂₁ may also be joined together in the same manner. Listed as rings which are formed by X₂₁ and W₂₁ are, for example, pyrazolone, pyrazolidinone, cyclopentanedione, β-ketolactone, β-ketolactum.

Examples of the compound usable in the invention are shown below.

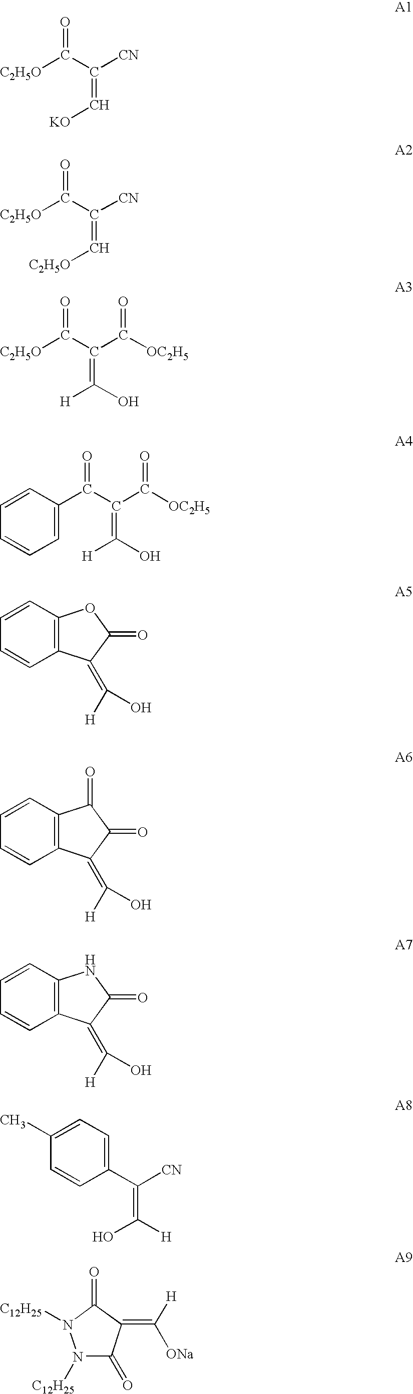

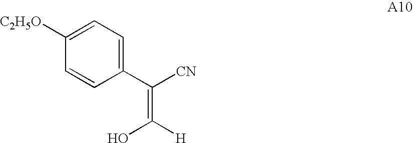

In Formula P, Q represents a nitrogen atom or a phosphorous atom; R₃₁, R₃₂, R₃₃, and R₃₄ each represent a hydrogen atom or a substituent; and X₃₁⁻ represents an anion. Incidentally, R₃₁ through R₃₄ may join together to form a ring.

Listed as substituents represented by R₃₁ through R₃₄ are an alkyl group (such as a methyl group, an ethyl group, a propyl group, a butyl group, a hexyl group, and a cyclohexyl group), an alkenyl group (such as an allyl group and a butenyl group), an alkynyl group (such as a propargyl group and a butynyl group), an aryl group (such as a phenyl group and a naphthyl group), a heterocyclic group such as a piperidinyl group, a piperazinyl group, a morpholinyl group, a pyridyl group, a furyl group, a thienyl group, a tetrahydrofuryl group, a tetrahydrothienyl group and a sulfolanyl group, and an amino group.

Listed as rings which are formed by joining R₃₁ though R₃₄ are a piperidine ring, a morpholine ring, a piperazine ring, quinuclidine ring, a pyridine ring, a pyrrole ring, an imidazole ring, a triazole ring, and a tetrazole ring.

Groups represented by R₃₁ through R₃₄ may have a substituent such as a hydroxyl group, an alkoxy group, an aryloxy group, a carboxyl group, a sulfo group, an alkyl group, and an aryl group. R₃₁, R₃₂, R₃₃, and R₃₄ each is preferably a hydrogen atom or an alkyl group.

Listed as anions represented by X₃₁⁻ are inorganic or organic anions such as a halogen ion, a sulfate ion, a nitrate ion, acetate ion, and a p-toluenesulfonate ion.

The aforesaid quaternary onium compounds can easily be synthesized employing methods known in the art. For instance, the aforesaid tetrazolium compounds can be synthesized based on the method described in Chemical Reviews Vol. 55, pages 335 through 483. The adding amount of the aforesaid silver saving agent is from 10⁻⁵ to 1 mole, preferably from 10⁻⁴ to 5×10⁻¹ moles, per mole of the organic silver salt.

In the invention, it is preferable that at least one of the silver saving agents is a silane compound.

In the invention, the silane compound to be employed as the silver saving agent is preferably alkoxysilane compounds having two or more primary- or secondary-amino groups or salts thereof. For example, such compounds are disclosed in Japanese Unexamined Patent Application Publication No. 2001-192698 (corresponding to U.S. Publication No. 2003044738A).

The compounds each having two or more primary- or secondary-amino groups include ones having two or more primary-amino groups, ones having two or more secondary-amino groups, ones having one or more primary- or secondary-amino groups respectively; and the salts of the alkoxysilane are each the adduct an inorganic or organic acid capable of forming an onium salt with the amino group and the alkoxysilane group.

The alkoxysilane compounds and the salts thereof are not limited as long as those are alkoxysilane compounds and their salts each has two or more of primary- or secondary amino group in the molecular thereof.

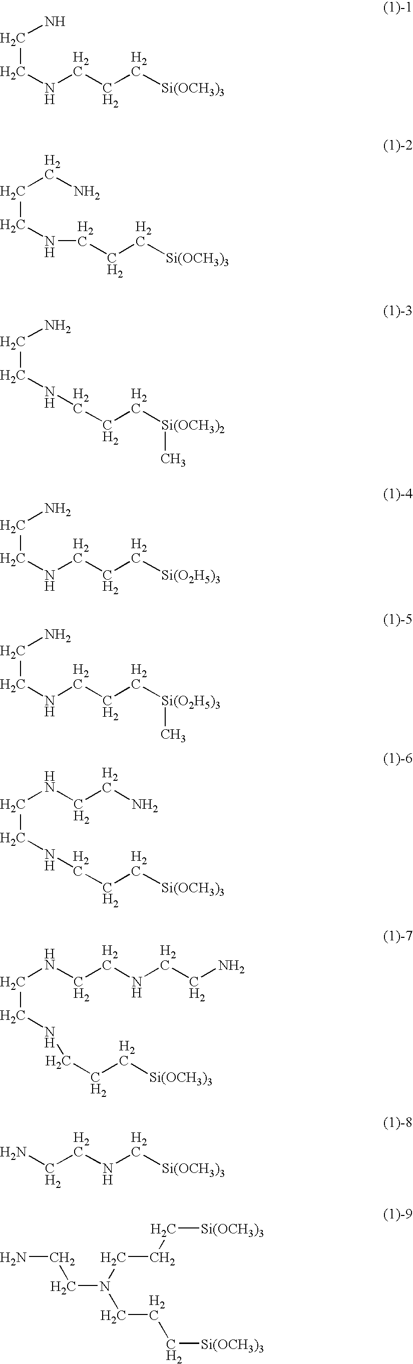

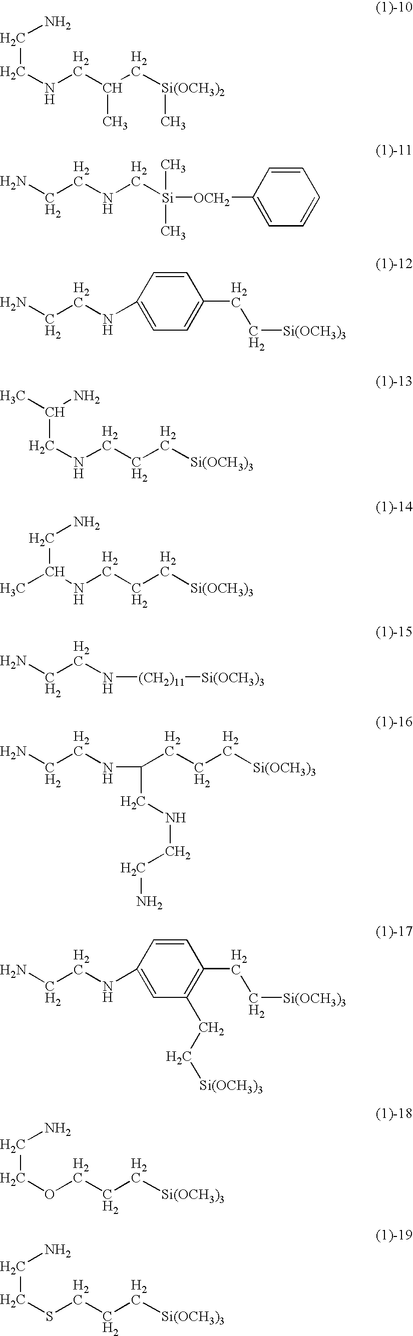

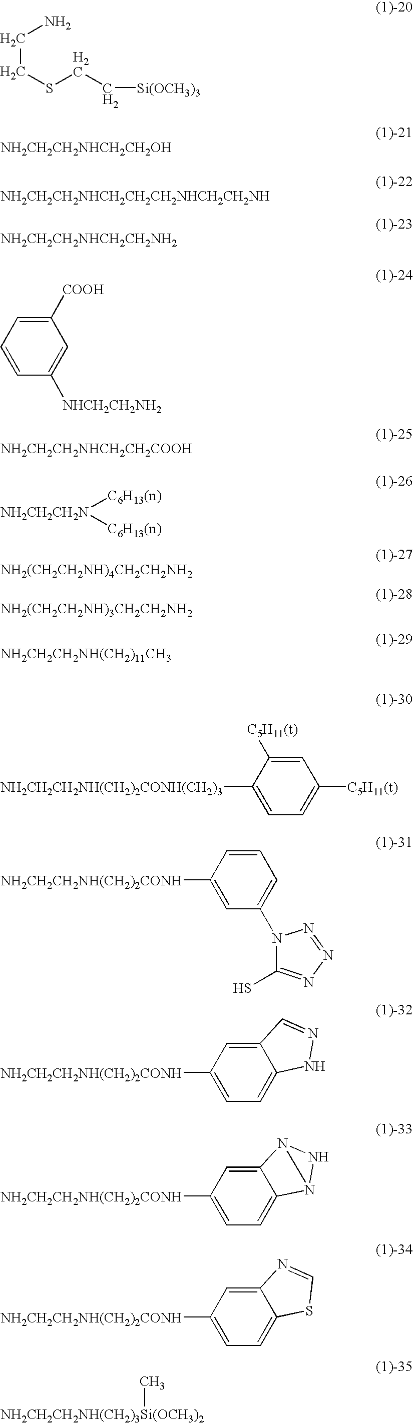

In these compounds, the alkoxyl group constituting the alkoxysilyl group is preferably an alkoxyl group formed by a saturated alkoxyl group, and a methoxyl group, an ethoxyl group and a propoxyl group are further preferable since they are excellent in the stability. The compounds each having no unsaturated group in the molecule thereof are preferable for reducing the variation of the sensitivity depending on the storing condition before the thermal development. The alkoxysilane compounds or the salts thereof may be use singly or in combination of two or more kinds.

It is preferable that the image forming layer contains a Schiff's base formed by a dehydrating condensation reaction of the alkoxysilane compound having at least one or more primary amino groups and a ketone compound.

The silver saving can be realized and lowered fogging, reduced sensitivity variation and an image without extreme high contrast can be obtained not depending on the storage condition before the thermal development. Moreover, the fluctuation of the sensitivity depending on the period of time after the preparation of coating liquid can be inhibited by the use of such the Schiff's base when a ketone type solvent is used on the occasion of the preparation of the image forming layer coating liquid since the moiety of primary-amine is previously blocked.

The ketone compounds to be used for forming the Schiff's base together with the alkoxysilane compounds is preferably ones having a boiling point of not more than 150° C., more preferably not more than 100° C., from the viewpoint of the problem of odor occurred on the occasion of the image formation by the later-mentioned image forming method, even though the ketone compounds may be used without any limitation.

As the above-described Schiff's base, the Schiff's bases formed by the dehydrating condensation reaction of alkoxysilane compound having one ore more of primary-amino group together with the ketone compound are preferable.

Among the foregoing compounds, Schiff's bases each having one or more secondary-amino groups in the molecule thereof are preferred for further silver saving. The Schiff's bases may be employed singly or in combination of two or more kinds thereof.

When the alkoxysilane compounds, their salt or the Schiff's bases are added into the image forming layer as the silver saving agent, the adding amount is usually from 0.00001 to 0.05 moles per mole of silver.

However, in some case, the image density at the unexposed area of the image formed by the later-mentioned image forming method when the adding amount of the foregoing alkoxysilane compound or the Schiff's base is slightly excessive. Consequently, it is preferable to add an isocyanate compound having two or more isocyanate groups in the molecule thereof into the image forming layer for alleviating the dependency of effect of the alkoxysilane compound or the Schiff' base on the adding amount thereof per mole of silver. As the isocyanate compound, those to be employed as the crosslinking agent can be applied.

Further, fog preventing agents and image stabilizing agents can be used to controlling the characteristics of the thermally developable light-sensitive material of the present invention.

When reducing agent such as bisphenols and sulfonamidobphenols are principally employed as the reducing agent, it is preferred to add a chemical compound which can inactivate the reducing agent by occurring an active species capable of remove the hydrogen atom from the reducing agent. A colorless photo-oxidation substance is suitable which can generate a free radical as the reactive species on the occasion of the light exposure.

Consequently, the compounds having these functions can be used without limitation, however, an organic free radical comprised of plural atoms are preferably used. As long as the compounds have the function and result in no adverse effect for the thermally developable light-sensitive material, compounds having any structural constitution can be used without limitation.

The free radical generating compound is preferably a carbon ring type or an aromatic type compounds each having an aromatic group for providing stability to the generated free radial so the that the free radical is contacted with the reducing agent for sufficient reaction period for inactivating the reducing agent.

Typical examples of such the compound include bi-imidazolyl compounds and iodonium compounds.

The adding amount of the aforesaid bi-imidazolyl compounds or the iodonium compounds is from 0.001 to 0.1 moles/m², preferably from 0.005 to 0.5 moles/m². Such the compounds are preferably near the reducing agent, even though the compounds may be contained in any of the layers of the light-sensitive material according to the invention.

In the invention, compounds capable of releasing halogen atom as the reactive species are preferably employed. Many compounds have been known as the compound capable of releasing the halogen atom as the reactive species, and enhanced effects can be obtained by employing in the combination.

Concrete examples of the compounds releasing the active halogen atom include compounds represented by the following

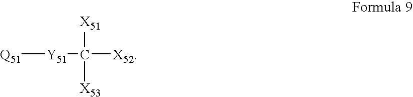

In Formula 9, Q₅₁ is an aryl group or a heterocyclic group. X₅₁, X₅₂ and X₅₃ are each a halogen atom, an acyl group, an alkoxycarbonyl group, an aryloxycarbonyl group, a sulfonyl group or an aryl group, provided that at least one of them is halogen atom. Y₅₁ is a —C(═O)— group, an —SO— group or an —SO₂— group.

The aryl group represented by Q₅₁ may be a single ring or a condensed ring, preferably a single or double ring having 6 through 30 carbon atoms such as a phenyl group and a naphthyl group, more preferably a phenyl and naphthyl group, more preferably a phenyl group.

The heterocyclic group represented by Q₅₁ 3- through 10-membered saturated or unsaturated heterocyclic group, which may be a single ring or a ring condensed with another ring.

The heterocyclic group is preferably a 5- or 6-membered unsaturated heterocyclic group which may have a condensed ring, more preferably a 5- or 6-membered aromatic heterocyclic group which may have a condensed ring, more preferably a 5- or 6-membered cyclic ring having a nitrogen-containing condensed ring, further preferably a 5- or 6-membered aromatic heterocyclic group having a condensed ring having 1 through 4 nitrogen atoms. Such the heterocyclic ring is preferably a ring of imidazole, pyrazole, pyridine, pyrimidine, pyrazine, pyridazine, triazole, triazine, indole, indazole, purine, thiadiazole, oxadiazole, quinoline, phthalazine, naphthylidine, quinoxaline, quinazoline, cinnoline, pteridine, acridine, phenathroline, phenazine, tetrazole, thiazole, indorenine and tetraazaindene, more preferably, imidazole, pyridine, pyrimidine, pyrazine, pyridazine, triazole, triazine, thiadiazole, oxadiazole, quinoline, phthalazine, naphthylidine, quinoxaline, quinazoline, cinnoline, tetrazole, thiazole, oxazole, benzimidazole, benzoxazole, benzothiazole and tetraazaindene, further preferably, imidazole, pyridine, pyrimidine, pyrazine, pyridazine, triazole, triazine, thiadiazole, quinoline, phthalazine, naphthylidine, quinoxaline, quinazoline, cinnoline, tetrazole, thiazole, benzimidazole and benzothiazole, particularly preferably pyridine, thiadiazole, quinoline and benzothiazole.

The aryl group and the heterocyclic group may have a substituent further than a —Y₅₁—C(X₅₁)(X₅₂)(X₃₅) group. Preferable substituents are an alkyl group, an alkenyl group, an aryl group, an alkoxyl group, an aryloxy group, an acyloxyl group, an acyl group, an alkoxycarbonyl group, an aryloxycarbonyl group, an acyloxy group, an acylamino group, an alkoxycarbonylamino group, an aryloxycarbonylamino group, a sufonylamino group, a sulfamoyl group, a carbamoyl group, a sulfonyl group, a ureido group, phosphoramido group, a halogen atom, a cyano group, a sulfo group, a carboxyl group, a nitro group and a heterocyclic group, more preferably an alkyl group, an aryl group, an alkoxyl group, an aryloxy group, an acyl group, an acylamino group, an alkoxycarbonylamino group, an aryloxycarbonylamino group, a sulfonylamino group, a sulfamoyl group, a carbamoyl group, a ureido group, phosphoramido group, a halogen atom, a cyano group, a nitro group and a heterocyclic group, more preferably an alkyl group, an aryl group, an alkoxyl group, an aryloxyl group, an acyl group, an acylamino group, a sulfonamido group, a sulfamoyl group, a carbamoyl group, a halogen atom, a cyano group, a nitro group and a heterocyclic group, particularly preferably an alkyl group, an aryl group and a halogen atom.

X₅₁, X₅₂ and X₅₃ are each preferably a halogen atom, a haloalkyl group, an acyl group, an alkoxycarbonyl group, an aryloxycarbonyl group, a carbamoyl group, a sulfamoyl group, a sulfonyl group and a heterocyclic group, more preferably a halogen atom a haloalkyl group, an acyl group, an alkoxycarbonyl group, an arylcarbonyl group and a sulfonyl group, further preferably a halogen atom and trihalomethyl group, and particularly preferably a halogen atom. Among the halogen atoms, a chlorine atom, a bromine atom and an iodine atom are preferable, a chlorine atom and bromine atom are more preferably, and a bromine atom is particularly preferably.

Y₅₁ is a —C(═O)— group, an —SO— group or an —SO₂— group, more preferably the —SO₂— group.

The adding amount of these compounds is preferably within the range in which the problem on print out of silver caused by formation silver halide is substantially not occurred. The amount is preferably not more than 150%, more preferably not more than 100%, of the compound not generating the reactive halogen radical.

The constitution elements of the thermally developable light-sensitive material of the present invention are explained below. In the invention, a silver salt of organic acid or hetero organic acid, particularly, a silver salt of long chain aliphatic carboxylic acid having from 10 to 30 carbon toms preferably from 15 to 25 carbon atoms and a silver salt of a nitrogen-containing heterocyclic compound are preferred as an organic silver salt as the silver ion source for forming the silver image. The organic and inorganic complexes described in Research Disclosure, hereinafter referred to as RD, Nos. 17029 and 29963 are also preferable, the ligand of which has a total stabilization constant to silver ion of from 4.0 to 10.0.

Examples of the preferable silver salt include the followings: a silver salt of organic acid such as silver salt of gallic acid, oxalic acid, behenic acid, stearic acid, arachidic acid, palmitic acid and lauric acid; a silver salt of carboxyalkylthiourea such as silver salt of 1-(3-carboxypropyl)thiourea and 1-(3-carboxyoropyl)-3,3-dimethylthiourea; a silver salt or complex of a polymerization reaction product of an aldehyde and a hydroxyl-substituted aromatic carboxylic acid such as silver salt or complex of a polymerization reaction product of an aldehyde such as formaldehyde, acetoaldehyde and butylaldehyde with a hydroxyl-substituted acid such as salysilic acid, benzoic acid and 3,5-dihydroxybenzoic acid; a silver salt or complex of thione such as silver salt or complex of 3-(2-carboxyethyl)-4-hydroxymethyl-4-thiazoline-2-thione and 3-(carboxymethyl-4-thiazoline-2-thione; a complex or salt of silver with a nitrogen acid such as imidazole, pyrazole, urazole, 1,2,4-thiazole, 1H-tetrazole, 3-amino-5-benzylthio-1,2,4-triazole and benzotriazole; a silver salt of saccharin or 5-chlorosalycilaldoxim; and a silver mercaptide. Among them, the long chain aliphatic carboxylic acids each having from 10 to 30 carbon atoms, preferably from 15 to 25 carbon atoms, silver behenate, silver arachidate and silver stearate are particularly preferred.

In the invention, mixing of two or more kinds of the organic silver salt is preferable for raising the developing ability and forming a silver image with high density and high contrast. For example, it is preferable to prepare the silver salt by mixing a silver salt solution with a mixture of two or more kinds of organic acid.

The organic silver compound can be obtained by mixing a water-soluble silver compound and a compound capable of forming a complex with silver. A normal mixing method, a reverse mixing method, a double-jet mixing method and a controlled double-jet mixing method such as those described in Japanese Patent Publication Open to Public Inspection No. 9-147643 are preferably applicable for the mixing. For example, acid an alkali metal soap of an organic such as sodium behenate and sodium arachidate is prepared by adding an alkali metal salt such as sodium hydroxide and potassium hydroxide to an organic acid, thereafter, the soap is mixed with a silver salt such as silver nitrate by the controlled double-jet method to prepare a crystal of organic silver salt. A silver halide grain may be mixed on this occasion.

The organic silver salt relating to the invention is preferably one having a planar shape even though various shaped silver salts can be used. Particularly, a planar organic silver salt particle having a aspect ratio of not less than 3 and an average acicular ratio measured in the main plane direction of not less than 1.1 and less than 10.0 is preferable for raising the filling factor of the particles in the light-sensitive layer by reducing the anisotropy of the two planes or main planes which have each the maximum area and faced approximately parallel to each other. More preferable acicular ratio is not less than 1.1 and less than 5.0.

The “planar organic silver salt particle having the aspect ratio of not less than 3” means the number of such the particles account for 50% of the whole number of the organic salt particles. It is preferable that the number of the particle having the aspect ratio of not less than 3 account for not less than 60%, more preferably not less than 70%, particularly preferably not less than 80%.

The planar particle with the aspect ratio of not less than 3 is a particle having a ratio of the diameter to the thickness of the particle so-called as aspect ratio or AR of 3, which is represented by the following equation.

AR=Particle diameter (μm)/Thickness (μm)

The aspect ratio of the planar organic silver salt is preferably from 3 to 20, more preferably from 3 to 10. When the aspect ratio is too low, the organic silver salt particles tend to be contacted with together, and when the aspect ratio is excessively high, the organic silver salt particles are easily overlapped and dispersed in an adhered state so that the scattering of light is tend to be occurred. As a result of that, the transparency of the light-sensitive material is lowered. Accordingly, the foregoing range of the aspect ratio is preferred.

The average diameter can be determined as follows. The organic silver salt particles, which have been subjected to dispersion, are diluted, are dispersed onto a grid covered with a carbon supporting layer, and imaged at a direct magnification of 5,000, employing a transmission type electron microscope Type 2000FX, manufactured by JEOL, Ltd. The resultant negative image is converted to a digital image employing a scanner. Subsequently, by employing appropriate software, the grain diameter, being a circle equivalent diameter, of at least 300 grains is determined and an average grain diameter is calculated.

The average thickness is determined employing a method utilizing a transmission electron microscope, hereinafter referred to as a TEM as described below.

First, an image forming layer, which has been applied onto a support, is adhered onto a suitable holder, employing an adhesive, and subsequently, cut in the perpendicular direction with respect to the support plane, employing a diamond knife, whereby ultra-thin slices having a thickness of 0.1 to 0.2 μm are prepared. The ultra-thin slice is supported by a copper mesh and transferred onto a hydrophilic carbon layer, employing a glow discharge. Subsequently, while cooling the resultant slice at less than or equal to 130° C. employing liquid nitrogen, a bright field image is observed at a magnification of 5,000 to 40,000, employing TEM, and images are quickly recorded employing either film, imaging plates, or a CCD camera. During the operation, it is preferable that the portion of the slice in the visual field is suitably selected so that neither tears nor distortions are imaged.

The carbon layer, which is supported by an organic layer such as extremely thin collodion or Formvar, is preferably employed. The more preferred carbon layer is prepared as follows. The carbon layer is formed on a rock salt substrate which is removed through dissolution. Alternately, the organic layer is removed employing organic solvents and ion etching whereby the carbon layer itself is obtained. The acceleration voltage applied to the TEM is preferably from 80 to 400 kV, and is more preferably from 80 to 200 kV.

It is preferable that a TEM image, recorded in a suitable medium, is decomposed into preferably at least 1,024×1,024 pixels and subsequently subjected to image processing, utilizing a computer. In order to carry out the image processing, it is preferable that an analogue image, recorded on a film strip, is converted into a digital image, employing any appropriate means such as scanner, and if desired, the resulting digital image is subjected to shading correction as well as contrast-edge enhancement. Thereafter, a histogram is prepared, and portions, which correspond to organic silver salts, are extracted through a binarization processing.

At least 300 of the thickness of the organic silver salts, extracted as above, are manually determined employing appropriate software, and an average value is then obtained.

The average value of the acicular ratio of the planar organic silver salt particles can be determined by the following method.

First, the light-sensitive layer containing the planar organic silver salt particle is swollen by a solvent capable of dissolving the binder of the light-sensitive layer and peeled from the substrate, and the particles are subjected to ultrasonic washing, centrifugal separation and decantation, such the treatments are repeated for 5 times. The foregoing processes are performed under a safelight. Then the particles are diluted by methyl ethyl ketone (MEK) so that the solid component concentration of the organic silver salt is become to 0.01% and dispersed by ultrasonic treatment. The dispersion is dropped onto a polyethylene film which is previously hydrophilized by glow discharge and dried. It is preferable that the film carrying the particles is subjected to evaporation of Pt—C layer with a thickness of 3 nm by electron beam from the direction of 30° as to the film surface in a vacuum evaporation apparatus and applied to the observation.

Other items such as electron microscopic observation techniques, as well as sample preparation techniques, may be obtained while referring to either “Igaku-Seibutsugaku Denshikenbikyo Kansatsu Gihoh (Medical-Biological Electron Microscopic Observation Techniques”, edited by Nippon Denshikembikyo Gakkai Kanto Shibu (Maruzen) or “Denshikembikyo Seibutsu Shiryo Sakuseihoh (Preparation Methods of Electron Microscopic Biological Samples”, edited by Nippon Denshikenbikyo Gakkai Kanto Shibu (Maruzen).

The secondary electron image of thus prepared sample is observed by a field emission scanning electron microscope, hereinafter referred to as FE-SEM, with an acceleration voltage of from 2 kV to 4 kV and a magnification of from 5,000 to 20,000 and the image is stored in a suitable recording medium.

For the foregoing treatment, the use of an apparatus capable of A/D converting the image information from the electron microscope and directly recording onto a memory as digital information is convenience. An analogue image recorded on a medium such as Polaroid Film is also can be used by converting to a digital image by an apparatus such as a scanner and subjected to shading compensation and contrast-edge enhancement according to necessity.

It is preferable that a TEM image, recorded in a suitable medium, is decomposed into preferably at least 1,024×1,024 pixels and subsequently subjected to image processing, utilizing a computer.

The procedure of the foregoing image treatment is as follows. First, a histogram is prepared and the portion corresponding to the organic silver salt particle having the aspect ratio of not less than 3 is extracted by binarization treatment. The coagulated particles are cut by a suitable algorithm or manual processing and the outline of the each particle is extracted. Subsequently, the maximum length (MX LNG) of each of the particles is measured with respect to at least 1,000 particles and the acicular ratio of each particle is calculated by the following equation. The maximum length of the particle is defined by the maximum length of the line connecting two points in the particle. The minimum width of the particle is defined by the value when the distance of two parallel lines each circumscribing the particle is become smallest.

Acicular ratio=(MX LNG)/(WIDTH)

Thereafter, the average value of the acicular ratio is calculated with respect to all the measured particles. When the determination is carried out according to the foregoing procedure, it is preferable that the compensation on the length per one pixel or scale compensation and the compensation on the two dimensional distortion of the determination system are satisfactorily performed in advance. Uniform Latex Particles sold by U.S. Dow Chemicals is suitable as the standard sample. Polystyrene particles having a particle diameter of from 0.1 to 0.3 μm and a variation coefficient of particle diameter of less than 10% is preferable. In concrete, a lot of polystyrene particle with a particle diameter of 0.212 μm and a standard deviation of 0.0029 μm is available.

“Gazoushori Ouyou Gijutsu (Applied Technology of Image Treatment)” edited by H. Tanaka, Kogyo Chosa Kai, can be referred regarding the details of the image treatment technology.

It is effective for preparing the organic silver salt particle having the foregoing shape that the mixing condition on the occasion of the formation of the organic acid alkali metal soap and/or addition of silver nitrate to the soap and the ratio of the silver nitrate to be reacted with the soap are suitably kept even though there is no limitation on the method for the preparation method.

It is preferable that the planar organic silver salt particle relating to the invention is preliminarily dispersed together with a binder and a surfactant according to necessity and then crushed and dispersed by a media dispersing machine or a high pressure homogenizer. A usual stirrer such as an anchor type and a propeller type, a high speed rotation centrifugal radiation type stirring machine such as a dissolver and a high speed shearing type stirring machine such as a homomixer may be applied for the preliminary dispersion.

As the media dispersion machine, a rotation mill such as a ball mill, a planet ball mill and a vibration ball mill, and a media stirring mill such as a beads mill and an attriter, and a basket mill are usable. As the high pressure homogenizer, various types such as one in which the liquid is hit to a wall or a plug, one in which the liquid is separated into plural streams and the streams are hit with together at a high speed and one in which the liquid is passed through a narrow orifice can be applied.

Examples of preferable ceramics for the ceramics beads to be used on the occasion of the media dispersion include Al₂O₃, BaTiO₃, MgO, ZrO, BeO, Cr₂O₃, SiO₂, SiO₂—Al₂O₃, Cr₂O₃—MgO, MgO—CaO, MgO—C, MgO—Al₂O₃ (spinel), SiC, TiO₂, K₂O, Na₂O, BaO, PbO, B₂O₃, SrTiO₃ (strontium titanate), BeAl₂O₄, Y₃Al₅O₁₂, ZrO₂-Y₂O₃ (cubic crystal zirconia), 3BeO—Al₂O₃—6SiO₂ (synthesized emerald), C (synthesized diamond), SiO₂—nH₂O, silicon nitride, yttrium-stabilized zirconia and zirconia-strengthen zirconia. Yttrium-stabilized zirconia and zirconia-strengthen alumina, hereinafter such the ceramics containing zirconia is simply referred to as zirconia, are particularly preferred since the formation of impurity caused by friction of beads or dispersing machine on the occasion of the dispersion is small.

In apparatus to be used for dispersing the planar organic silver salt particles, ceramics such as zirconia, alumina and silicon nitride, and diamond are preferably used for the material to be contacted with the organic silver salt particle. Among them, zirconia is particularly preferred.

It is preferable to add the binder in an amount of from 0.1% to 10% in weight of the organic silver salt on the occasion of the dispersion. The liquid temperature is preferably lower than 45° C. through the period of the preliminary dispersion and the regular dispersion. The regular dispersion is preferably performed under a condition of from 29.42 MPa to 98.0 MPa, and the treatment is preferably repeated twice when the high pressure homogenizer is used for dispersion. When the media dispersion machine is used, a circumstance speed of from 6 m/sec. to 13 m/sec. is preferable.

In a preferable embodiment of the thermally developable light-sensitive material according to the invention, a light-sensitive emulsion is coated, which contains the organic silver salt particles characterized in that the ratio of the projection area of the organic silver salt particles each having a projection area of less than 0.025 μm² to the sum of the projection area of the whole organic silver salt particles is not less than 70% and the ratio of the projection area of the particles each having a projection area of not less than 0.2 μm² to the sum of the projection area of the whole organic silver salt particles is not more than 10%, and light-sensitive silver halide. The projection area of the organic silver salt particle can be observed by electron microscopic observation of the cross section of the light-sensitive material in the vertical direction to the substrate of the light-sensitive material. In such the case, a uniformly dispersed state of the organic silver salt particles, in which the coagulation of the particle inhibited, can be obtained in the light-sensitive emulsion.

Preferable conditions for preparing such the light-sensitive emulsion are, for example, to suitably keep the mixing condition for forming the organic acid alkali metal soap and/or that for adding silver nitrate to the soap, to make the ratio of that soap to silver nitrate to be reacted with the soap, to use the media dispersing machine or the high pressure homogenizer for dispersing the organic silver particles, to make using amount or concentration of the binder to be from 0.1 to 10% by weight of the organic silver salt, to keep the temperature at a temperature of not more than 45% through the period of from drying to the regular dispersion and to use the dissolver for coating liquid preparation for stirring at a circumstance speed of not less than 2.0 m/sec.

The projection area of the organic silver salt particles each having the specified projection area and the ratio thereof to sum of the projection area of the whole organic silver salt particles can be extracted by the method using a transmission electron microscope (TEM) such as that described in the method for measuring the thickness of the particle.

The image of the coagulated particles is treated as one particle and the area of the each particle is calculated. The areas of at least 1,000, preferably 2,000, particles are measured and the particles are classified into the following three groups; A: less than 0.025 μm², B: not less than 0.025 μm² and less than 0.2, and C: not less than 0.2 μm². In the light-sensitive material according to the invention, it is preferable that the sum of the area of the particles classified into Group A is not less than 70% of the total area of the whole measured particles and the sum of the area of the particles classified into Group C is not more than 10% of the total area of the whole measured particles.

When the measurement is performed according to the foregoing procedure, it is preferable to previously perform the compensation of the length per pixel (scale compensation) and the compensation of two-dimensional distortion using the standard sample by the method such as that applied for calculating the average value of the acicular ratio.

The afore-mentioned “Gazoushori Ouyou Gijutsu (Applied Technology of Image Treatment)” edited by H. Tanaka, Kogyo Chosa Kai, can be also referred regarding the details of the image treatment technology. There is no limitation on the image treatment program and the apparatus as long as the above-mentioned operation can be carried out. For example, Luzex-III can be cited as described above.

The organic silver salt particles are preferably monodispersed particles, and the preferable monodispersion degree is from 1 to 30%. A high density image can be obtained when the particles have such the monodispersion degree. The monodispersion degree is defined by the following equation.

Monodispersion degree={(Standard deviation of particle diameter)/(Average particle diameter)}×100

The average circle equivalent diameter of the foregoing organic silver salt particles is preferably from 0.01 to 3.0 μm, more preferably from 0.02 to 0.2 μm. The circle equivalent diameter is the diameter of a circle having the same area as that of the individual particle image observed by the electron microscope.

In the invention, the total amount of silver halide grains and the organic silver salt is preferably from 0.3 g to 1.5 g per square meter for preventing formation of haze of the light-sensitive material. A preferable image for the medical diagnosis can be obtained in the above-mentioned range. When the amount is less than 0.3 g per square meter, the image density is lowered sometimes. When the amount exceeds 1.5 g per square meter, the fog is raised or the sensitivity is lowered on the occasion of printing to a PS plate sometimes.

Light-sensitive silver halide grains, hereinafter simply referred to as silver halide grains, will be described which are relating to the invention, hereinafter simply may be referred to as the light-sensitive material of the invention. The light-sensitive silver halide grains, as described in the invention, refer to silver halide crystalline grains which can originally absorb light as an inherent quality of silver halide crystals, can absorb visible light or infrared radiation through artificial physicochemical methods and are treatment-produced so that physicochemical changes occur in the interior of the silver halide crystal and/or on the crystal surface, when the crystals absorb any radiation in the wavelength ranging from ultraviolet to infrared radiation.

Silver halide grains employed in the invention can be prepared in the form of silver halide grain emulsions, employing methods described in P. Glafkides, “Chimie et Physique Photographique” (published by Paul Montel Co., 1967), G. F. Duffin, “Photographic Emulsion Chemistry” (published by The Focal Press, 1955), and V. L. Zelikman et al., “Making and Coating Photographic Emulsion”, published by The Focal Press, 1964). Namely, any of an acidic method, a neutral method, or an ammonia method may be employed. Further, employed as methods to allow water-soluble silver salts to react with water-soluble halides may be any of a single-jet precipitation method, a double-jet precipitation method, or combinations thereof. However, of these methods, a so-called controlled double-jet precipitation method is preferably employed in which silver halide grains are prepared while controlling formation conditions. Halogen compositions are not particularly limited. Any of silver chloride, silver chlorobromide, silver chloroiodobromide, silver bromide, silver iodobromide, or silver iodide may be employed.

Grain formation is commonly divided into two stages, that is, the formation of silver halide seed grains being nuclei and the growth of grains. Either method may be employed in which two stages are continually carried out, or in which the formation of nuclei or seed grains and the growth of gains are carried out separately. The controlled double-jet precipitation method, in which grains are formed while controlling the pAg and pH which are grain forming conditions, is preferred, since it is possible to control grain shape as well as grain size. For example, when the method, in which nucleus formation and grain growth are separately carried out, is employed, initially, nuclei being seed grains are formed by uniformly and quickly mixing water-soluble silver salts with water-soluble halides in an aqueous gelatin solution. Subsequently, under the controlled pAg and pH, silver halide grains are prepared through a grain growing process which grows the grains while supplying water-soluble silver salts as well as water-soluble halides. After grain formation, in a desalting process, unnecessary salts are removed, employing desalting methods known in the photographic art, such as a noodle method, a flocculating method, an ultrafiltration method, and an electrophoresis method, whereby it is possible to prepare the desired silver halide emulsion.

In the invention, silver halide grains are preferably monodispersed. The monodispersion, as described herein, means that the variation coefficient, obtained by the Formula described below, is less than 30 percent. The variation coefficient is preferably less than 20 percent, and is more preferably less than 15 percent.

Variation coefficient of grain diameter in percent=standard deviation of the grain diameter/average of the grain diameter×100

Cited as shapes of silver halide grains may be cubic, octahedral and tetradecahedral grains, planar grains, spherical grains, rod-shaped grains, and rough elliptical-shaped grains. Of these, cubic, octahedral, tetradecahedral, and planar silver halide grains are particularly preferred.

When the planar silver halide grains are employed, their average aspect ratio is preferably from 1.5 to 100, and is more preferably from 2 to 50. These are described in U.S. Pat. Nos. 5,264,337, 5,314,798, and 5,320,958, and it is possible to easily prepare the target planar grains. Further, it is possible to preferably employ silver halide grains having rounded corners.

The crystal habit of the external surface of silver halide grains is not particularly limited. However, when spectral sensitizing dyes, which exhibit crystal habit (surface) selectiveness are employed, it is preferable that silver halide grains are employed which have the crystal habit matching their selectiveness in a relatively high ratio. For example, when sensitizing dyes, which are selectively adsorbed onto a crystal plane having a Miller index of [100], it is preferable that the ratio of the [100] plane on the external surface of silver halide grains is high. The ratio is preferably at least 50 percent, is more preferably at least 70 percent, and is most preferably at least 80 percent. Incidentally, it is possible to obtain the ratio of the plane having a Miller index of [100], based on T. Tani, J. Imaging Sci., 29, 165 (1985), utilizing adsorption dependence of sensitizing dye in [111] plane as well as [100] plane.

The silver halide grains, employed in the invention, are preferably prepared employing low molecular weight gelatin, having an average molecular weight of less than or equal to 50,000 during formation of the grains.

In the invention, the low molecular weight gelatin refers to gelatin having an average molecular weight of less than or equal to 50,000. The molecular weight is preferably from 20,000 to 40,000, and is more preferably from 5, 000 to 25,000. It is possible to measure the molecular weight of gelatin employing gel filtration chromatography. It is possible to prepare the low molecular weight gelatin in such a manner that gelatin decomposition enzymes are added to an aqueous solution of gelatin having an average molecular weight of approximately 1000,000 so as to decompose the gelatin; the gelatin solution undergoes hydrolysis by the addition of acid or alkali; gelatin undergoes thermal decomposition while heated under normal atmospheric pressure or increased pressure; gelatin undergoes decomposition through ultrasonic application, or any of these methods may be employed in combination.

The concentration of dispersion media during the formation of nuclei is preferably less than or equal to 5 percent by weight. It is more effective to carry out the formation at a low concentration of 0.05 to 3.0 percent by weight.

During formation of the silver halide grains employed in the invention, it is preferable to use polyethylene oxides represented by the Formula described below.

Formula:

YO(CH₂CH₂O)ₘ(CH(CH₃)CH₂O)ₚ(CH₂CH₂O)ₙY

wherein Y represents a hydrogen atom, an —SO₃M group, or a —CO—B—COOM group; M represents a hydrogen atom, an alkali metal atom, an ammonium group, or an ammonium group substituted with an alkyl group having less than or equal to 5 carbon atoms; B represents a chained or cyclic group which forms organic dibasic acid; m and n each represents 0 through 50; and p represents 1 through 100.

When silver halide light-sensitive photographic materials are produced, polyethylene oxides, represented by the above Formula, have been preferably employed as an anti-foaming agent against marked foaming which occurs while stirring and transporting emulsion raw materials in a process in which an aqueous gelatin solution is prepared, in the process in which water-soluble halides as well as water-soluble silver salts are added to the gelatin solution, and in a process in which the resultant emulsion is applied onto support. Techniques to employ polyethylene oxides as an anti-foaming agent are disclosed in, for example, Japanese Patent Publication Open to Public Inspection No. 44-9497. The polyethylene oxides represented by the above Formula works as an anti-foaming agent during nuclei formation.

The content ratio of polyethylene oxides, represented by the above Formula, is preferably less than or equal to 1 percent by weight with respect to silver, and is more preferably from 0.01 to 0.10 percent by weight.

It is preferred that polyethylene oxides, represented by the above Formula, are present during nuclei formation. It is preferable that they are previously added to the dispersion media prior to nuclei formation. However, they may also be added during nuclei formation, or they may be employed by adding them to an aqueous silver salt solution or an aqueous halide solution which is employed during nuclei formation. However, they are preferably employed by adding them to an aqueous halide solution, or to both aqueous solutions in an amount of 0.01 to 2.00 percent by weight. Further, it is preferable that they are present during at least 50 percent of the time of the nuclei formation process, and it is more preferable that they are present during at east 70 percent of the time of the same. The polyethylene oxides, represented by the above Formula, may be added in the form of powder or they may be dissolved in a solvent such as methanol and then added.

Incidentally, temperature during nuclei formation is commonly from 5 to 60° C., and is preferably from 15 to 50° C. It is preferable that the temperature is controlled within the range even when a constant temperature, a temperature increasing pattern, for example, a case in which temperature at the initiation of nuclei formation is 25° C., subsequently, temperature is gradually increased during nuclei formation and the temperature at the completion of nuclei formation is 40° C., or a reverse sequence may be employed.

The concentration of an aqueous silver salt solution and an aqueous halide solution, employed for nuclei formation, is preferably less than or equal to 3.5 M, and is more preferably in a lower range of 0.01 to 2.50 M. The silver ion addition rate during nuclei formation is preferably from 1.5×10⁻³ to 3.0×10⁻¹ mol/minute, and is more preferably from 3.0×10⁻³ to 8.0×10⁻² mol/minute.

The pH during nuclei formation can be set in the range of 1.7 to 10.0. However, since the pH on the alkali side broadens the particle size distribution of the formed nuclei, the preferred pH is from 2 to 6. Further, the pBr during nuclei formation is usually from about 0.05 to about 3.00, is preferably from 1.0 to 2.5, and is more preferably from 1.5 to 2.0.

The silver halide grains of the invention may be added to a light-sensitive layer employing any appropriate method. When added, it is preferable that silver halide grains are arranged so as to be adjacent to reducible silver sources being organic silver salts.

From the viewpoint of production control, it is preferable that silver halide of the invention is previously prepared and is added to a solution which is employed to prepare the organic sliver salt grains, since in that manner, the process to prepare silver halide and the process to prepare the organic silver salt grains are separately handled. On the other hand, as described in British Patent No. 1,447,454, during preparation of the organic silver salt grains, halogen components such as halide ions are mixed with the organic silver salt forming components and by pouring a silver ion solution into the resulting mixture, it is possible to prepare silver halide at almost the same time as the formation of the organic silver salt grains.

Further, it is possible to prepare silver halide grains through conversion of the organic silver salts while allowing halogen containing compounds to act on the organic silver salts. Namely, it is possible to convert some of the organic silver salts to light-sensitive silver halide upon allowing silver halide forming components to act on a previously prepared the organic silver salt solution or dispersion, or a sheet material comprising aliphatic carboxylic acid silver salts.

Silver halide grain forming components include inorganic halides, onium halides, halogenated hydrocarbons, N-halogenated compounds, and other halogen-containing compounds. Specific examples are as follows, which are detailed in U.S. Pat. Nos. 4,009,039, 3,457,075, and 4,003,749; British Patent No. 1,498,956; and Japanese Patent Publication Open to Public Inspection Nos. 53-27027 and 53-25420, include, for example, metal halides, inorganic halides such as ammonium halide, onium halides such as trimethylphenylammonium bromide, cetylethyldimethylammonium bromide, trimethylbenzylammonium bromide, halogenated hydrocarbons such as iodoform, bromoform, carbon tetrachloride, and 2-bromo-2-methylpropane, N-halogenated compounds such as N-bromosuccinic acid imide, N-bromophthalimide, and N-bromoacetamide, and other components such as triphenylmethyl chloride, triphenylmethyl bromide, 2-bromoacetic acid, 2-bromoethanol, and dichiorobenzophenone. As described above, it is possible to prepare silver halide by converting some or all the silver in the organic silver salts into silver halide upon allowing the organic silver salt to react with halogen ions. Further, silver halide grains, which are produced upon converting some of the organic acid silver salts employing separately prepared silver halide may be employed in combination.

These silver halide grains, together with separately prepared silver halide grains, as well as silver halide grains, which are prepared by converting organic silver salts, are employed in an amount of from 0.001 to 0.700 moles per mole of the organic silver salt and more preferably in an amount of from 0.03 to 0.50 moles.

Silver halide grains, employed in the invention, preferably contain ions of transition metals which belong to Groups 6 through 11 of the Periodic Table. Preferably employed as the metals are W, Fe, Co, Ni, Cu, Ru, Rh, Pd, Re, Os, Ir, Pt, and Au. One kind of metal or at least two of the same kind or different kinds of metal complexes may be employed in combination. These metal ions may be incorporated in silver halide in the form of salts without any special treatment, but may be incorporated in silver halide in the form of metal complexes or complex ions. The content ratio is preferably in the range of from 1×10⁻⁹ to 1×10⁻² moles per mole of silver, and is more preferably in the range of from 1×10⁻⁸ to 1×10⁻⁴. In the invention, transition metal complexes or complex ions represented by the Formula, described below, are preferred.

[ML₆]^{m} Formula

wherein M represents a transition metal selected from the elements of Groups VI through XI in the Periodic Table; L represents a ligand; and m represents 0, 1-, 2-, 3-, or 4-. Listed as specific examples of ligands represented by L each of a halogen ion such as a fluoride ion, a chloride ion, a bromide ion, or an iodide ion, a cyanide, a cyanato, a thiocyanatato, a selenocyanato, a tellurocyanato, an azido, and an aqua ligand, and nitrosyl and thionitrosyl. Of these, aqua, nitrosyl, and thionitrosyl are preferred. When the aqua ligand is present, one or two ligands are preferably occupied by the aqua ligand. L may be the same or different.

It is preferable that compounds, which provide ions of these metals or complex ions, are added during formation of silver halide grains so as to be incorporated in the silver halide grains. The compounds may be added at any stage of silver halide grain preparation, namely nuclei formation, growth, physical ripening or prior to or after chemical ripening. However, they are preferably added at the stage of nuclei formation, growth, and physical ripening, are more preferably added at the stage of nuclei formation and growth, and are most preferably added at the stage of nuclei formation. They may be added over several times upon dividing them into several portions. Further, they may be uniformly incorporated in the interior of silver halide grains. Still further, as described in Japanese Patent Publication Open to Public Inspection Nos. 63-29603, 2-306236, 3-167545, 4-76534, 6-110146, and 5-273683, they may be incorporated so as to result in a desired distribution in the interior of the grains.

These metal compounds may be added after dissolving them in water or suitable organic solvents, for example, alcohols, ethers, glycols, ketones, esters, and amides. Further, addition methods include, for example, a method in which either an aqueous solution of metal compound powder or an aqueous solution prepared by dissolving metal compounds together with NaCl and KCl is added to a water-soluble halide solution, a method in which silver halide grains are formed by a silver salt solution, and a halide solution together with a the compound solution a third aqueous solution employing a triple-jet precipitation method, a method in which, during grain formation, an aqueous metal compound solution in a necessary amount is charged into a reaction vessel, or a method in which, during preparation of silver halide, separate silver halide grains which have been doped with metal ions or complex ions are added and dissolved. Specifically, a method is preferred in which either an aqueous solution of metal compound powder or an aqueous solution prepared by dissolving metal compounds together with NaCl and KCl is added to a water-soluble halide solution. When added onto the grain surface, an aqueous metal compound solution in a necessary amount may be added to a reaction vessel immediately after grain formation, during or after physical ripening, or during chemical ripening.

The separately prepared light-sensitive silver halide particles are subjected to desalting employing desalting methods known in the photographic art, such as a noodle method, a flocculation method, an ultrafiltration method, and an electrophoresis method, while they may be employed without desalting.

The light-sensitive silver halide of the invention may undergo chemical sensitization. For instance, it is possible to create chemical sensitization centers, being chemical sensitization nuclei, utilizing compounds which release chalcogen such as sulfur as well as noble metal compounds which contains noble metals ions, such as gold ions, while employing methods described in, for example, Japanese Patent Application Nos. 2000-057004 and 2000-061942. It is particularly preferable that the silver halide is chemically sensitized employing the chalcogen and the noble metal compound in combination.

In the invention, it is preferable that the silver halide grains are chemically sensitized by a compound containing the following chalcogen atom.

The chalcogen-containing compound effective as the organic sensitizer is preferably a compound having a group capable of adsorbing to silver halide and a moiety having a labile chalcogen atom.

Employed as the organic sensitizers may be those having various structures, as disclosed in Japanese Patent Publication Open to Public Inspection Nos. 60-150046, 4-109240, and 11-218874. Of these, the organic sensitizer is preferably at least one of compounds having a structure in which the chalcogen atom bonds to a carbon atom, or to a phosphorus atom, via a double bond.

The employed amount of chalcogen compounds as an organic sensitizer varies depending on the types of employed chalcogen compounds, silver halide grains, and reaction environments during performing chemical sensitization, but is preferably from 10⁻⁸ to 10⁻² moles per mole of silver halide, and is more preferably from 10⁻⁷ to 10⁻³ moles. The chemical sensitization environments in the invention are not particularly limited. However, it is preferable that in the presence of compounds which diminish chalcogenized silver or silver nuclei, or decrease their size, especially in the presence of oxidizing agents capable of oxidizing silver nuclei, chalcogen sensitization is performed employing organic sensitizers, containing chalcogen atoms. The sensitization conditions are that the pAg is preferably from 6 to 11, but is more preferably from 7 to 10, and the pH is preferably from 4 to 10, but is more preferably from 5 to 8. Further, the sensitization is preferably carried out at a temperature of lass than or equal to 30° C.

Accordingly, in the thermally developable light-sensitive material of the invention, it is preferable to employ a light-sensitive emulsion prepared in such a manner that light-sensitive silver halide undergoes chemical sensitization at a temperature of less than or equal to 30° C. in the presence of oxidizing agents capable of oxidizing silver nuclei on the grains; and that the resultant silver halide is mixed with the organic silver salt; and further that the resultant mixture is dispersed, followed by dehydration and drying.

Further, it is preferable that chemical sensitization, employing the organic sensitizers, be carried out in the presence of either spectral sensitizing dyes or compounds containing heteroatoms, which exhibit the adsorption onto silver halide grains. By carrying out chemical sensitization in the presence of compounds which exhibit adsorption onto silver halide grains, it is possible to minimize the dispersion of chemical sensitization center nuclei, whereby it is possible to achieve higher sensitivity as well as lower fogging. Though spectral sensitizing dyes to be used in the invention will be described below, the compounds comprising heteroatoms, which exhibit adsorption onto silver halide grains, as descried herein, refer to, as preferable examples, nitrogen containing heterocyclic compounds described in Japanese Patent Publication Open to Public Inspection No. 3-24537. Listed as heterocycles in nitrogen-containing heterocyclic compounds may be a pyrazole ring, a pyrimidine ring, a 1,2,4-triazine ring, a 1,2,3-triazole ring, a 1,3,4-thiazole ring, a 1,2,3-thiazole ring, a 1,2,4-thiadiazole ring, a 1,2,5-thiadiazole ring, 1,2,3,4-tetrazole ring, a pyridazine ring, and a 1,2,3-triazine ring, and a ring which is formed by combining 2 or 3 of the rings such as a triazolotriazole ring, a diazaindene ring, a triazaindene ring, and a pentaazaindenes ring. It is also possible to employ heterocyclic rings such as a phthalazine ring, a benzimidazole ring, an indazole ring and a benzthiazole ring, which are formed by condensing a single heterocyclic ring and an aromatic ring.

Of these, preferred is an azaindene ring. Further, preferred are azaindene compounds having a hydroxyl group, as a substituent, which include compounds such as hydroxytriazaindene, tetrahydroxyazaindene, and hydroxypentaazaindene.

The heterocyclic ring may have substituents other than a hydroxyl group. As substituents, the heterocyclic ring may have, for example, an alkyl group, a substituted alkyl group, an alkylthio group, an amino group, a hydroxyamino group, an alkylamino group, a dialkylamino group, an arylamino group, a carboxyl group, an alkoxycarbonyl group, a halogen atom, and a cyano group.

The added amount of these heterocyclic compounds varies widely depending on the size and composition of silver halide grains, and other conditions. However, the amount is in the range of from about 10⁻⁶ to 1 moles per mole of silver halide, and is preferably in the range of from 10⁻⁴ to 10⁻¹ moles.

The light-sensitive silver halide relating to the invention may undergo noble metal sensitization utilizing compounds which release noble metal ions such as gold ions. For example, employed as gold sensitizers may be chloroaurates and organic gold compounds.

Further, other than the sensitization methods, it is possible to employ a reduction sensitization method. Employed as specific compounds for the reduction sensitization may be ascorbic acid, thiourea dioxide, stannous chloride, hydrazine derivatives, boron compounds, silane compounds, and polyamine compounds. Further, it is possible to perform reduction sensitization by ripening an emulsion while maintaining a pH higher than or equal to 7 or a pAg less than or equal to 8.3.

Silver halide which undergoes the chemical sensitization, according to the invention, includes one which has been formed in the presence of organic silver salts, another which has been formed in the absence of organic silver salts, or still another which has been formed by mixing those above.

It is preferable that light-sensitive silver halide in the invention is adsorbed by spectral sensitizing dyes so as to result in spectral sensitization. Employed as spectral sensitizing dyes may be cyanine dyes, merocyanine dyes, complex cyanine dyes, complex merocyanine dyes, homopolar cyanine dyes, styryl dyes, hemicyanine dyes, oxonol dyes, and hemioxonol dyes. For example, employed may be sensitizing dyes described in Japanese Patent Publication Open to Public Inspection Nos. 63-159841, 60-140335, 63-231437, 63-259651, 63-304242, and 63-15245, and U.S. Pat. Nos. 4,639,414, 4,740,455, 4,741,966, 4,751,175, and 4,835,096. Useful sensitizing dyes, employed in the invention, are described in, for example, Research Disclosure, Item 17645, Section IV-A (page 23, December 1978) and Item 18431, Section X (page 437, August 1978) and publications further cited therein. It is specifically preferable that those sensitizing dyes are used which exhibit spectral sensitivity suitable for spectral characteristics of light sources of various types of laser imagers, as well as of scanners. For example, preferably employed are compounds described in Japanese Patent Publication Open to Public Inspection Nos. 9-34078, 9-54409, and 9-80679.

Useful cyanine dyes include cyanine dyes having basic nuclei such as a thiazoline nucleus, an oxazoline nucleus, a pyrroline nucleus, a pyridine nucleus, an oxazole nucleus, a thiazole nucleus, a selenazole nucleus, and an imidazole nucleus. Useful merocyanine dyes, which are preferred, comprise, in addition to the basic nuclei, acidic nuclei such as a thiohydantoin nucleus, a rhodanine nucleus, an oxazolizinedione nucleus, a thiazolinedione nucleus, a barbituric acid nucleus, a thiazolinone nucleus, a marononitryl nucleus, and a pyrazolone nucleus.

In the invention, it is possible to employ sensitizing dyes which exhibit spectral sensitivity, specifically in the infrared region. Listed as preferably employed infrared spectral sensitizing dyes are infrared spectral sensitizing dyes disclosed in U.S. Pat. Nos. 4,536,473, 4,515,888, and 4,959,294.

Specifically preferred dyes as the infrared spectral sensitizing dyes are long chain polymethine dyes which are characterized in that a sulfinyl group is substituted onto the benzene ring of a benzazole ring.

It is possible to easily synthesize the infrared sensitizing dyes, employing the method described in F. M. Harmer, “The Chemistry of Heterocyclic Compounds, Volume 18, The Cyanine Dyes and Related Compounds (A. Weissberger ed., published by Interscience, New York, 1964).

The infrared sensitizing dyes may be added at any time after preparing the silver halide. For example, the dyes may be added to solvents, or the dyes, in a so-called solid dispersion state in which the dyes are dispersed into minute particles, may be added to a light-sensitive emulsion comprising silver halide grains or silver halide grains/organic silver salts. Further, in the same manner as the heteroatoms containing compounds which exhibit adsorption onto silver halide grains, the dyes are adsorbed onto silver halide grains prior to chemical sensitization, and subsequently, undergo chemical sensitization, whereby it is possible to minimize the dispersion of chemical sensitization center nuclei so at to enhance sensitivity, as well as to decrease fogging.

In the invention, the spectral sensitizing dyes may be employed individually or in combination. Combinations of sensitizing dyes are frequently employed when specifically aiming for supersensitization.

An emulsion comprising light-sensitive silver halide as well as the organic silver salts, which are employed in the thermally developable light-sensitive material of the invention, may comprise sensitizing dyes together with compounds which are dyes having no spectral sensitization or have substantially no absorption of visible light and exhibit supersensitization, whereby the silver halide grains may be supersenstized.

Useful combinations of sensitizing dyes and dyes exhibiting supersensitization, as well as materials exhibiting supersensitization, are described in Research Disclosure Item 17643 (published December 1978), page 23, Section J of IV; Japanese Patent Publication Nos. 9-25500 and 43-4933; and Japanese Patent Publication Open to Public Inspection Nos. 59-19032, 59-192242, and 5-431432. Preferred compounds as supersensitizers are hetero-aromatic mercapto compounds or mercapto derivatives represented by the following formula.

Ar—SM

wherein M represents a hydrogen atom or an alkali metal atom, and Ar represents an aromatic ring or a condensed aromatic ring having at least one of a nitrogen, sulfur, oxygen, selenium, or tellurium atom. The hetero-aromatic rings or the aromatic condensed rings are preferably benzimidazole, naphthoimidazole, benzimidazole, naphthothiazole, benzoxazole, naphthoxazole, benzselenazole, benztellurazole, imidazole, oxazole, pyrazole, triazole, triazine, pyrimidine, pyridazine, pyrazine, pyridine, purine, quinoline, or quinazoline. However, other hetero-aromatic rings are not excluded.

Incidentally, in the present invention, mercapto derivative compound, which generate above-described mercapto compounds, substantially when they are incorporated into the organic acid silver salts or a silver halide grain emulsion, are preferably included which substantially prepare the mercapto compounds. Specifically, listed as preferred examples are the mercapto derivatives described below.

Ar—S—S—Ar

wherein Ar is the same as the mercapto compounds defined above.

The hetero-aromatic rings or the aromatic condensed rings may have a substituent selected from the group consisting of, for example, a halogen atom such as a chlorine atom, a bromine atom, and an iodine atom, a hydroxyl group, an amino group, a carboxyl group, an alkyl group such as an alkyl group having at least one carbon atom and preferably having from 1 to 4 carbon atoms, and an alkoxy group such as an alkoxy group having at least one carbon atom and preferably having from 1 to 4 carbon atoms.

Other than the supersensitizers, employed in the invention as supersensitizers may be compounds represented by Formula 1, shown below, which is disclosed in Japanese Patent Publication Open to Public Inspection No. 2001-330918 and macrocyclic compounds.

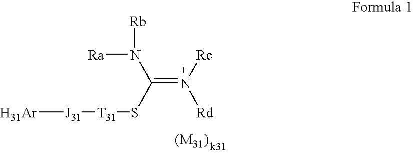

wherein H₃₁Ar represents either an aromatic hydrocarbon group or an aromatic heterocyclic ring group; T₃₁ represents a divalent linking group comprised of an aliphatic hydrocarbon group or a simple linking bond; J₃₁ represents a divalent linking group containing at least one of an oxygen atom, a sulfur atom, or a nitrogen atom or a simple linking bond; Ra, Rb, Rc, and Rd each represents a hydrogen atom, an acyl group, an aliphatic hydrocarbon group, an aryl group, or a heterocyclic ring group, or Ra and Rb, Rc and Rd, Ra and Rc, or Rb and Rc can be joined together to form a nitrogen-containing heterocyclic ring group; M₃₁ represents an ion necessary to offset the charge in the molecule; and k₃₁ represents an ion necessary to offset the charge in the molecule.

In Formula 1, examples of the divalent linking group represented by T₃₁ include straight chain, branched chain or cyclic alkylene groups, preferably those having from 1 to 20 carbon atoms, more preferably from 1 to 16 carbon atoms, further preferably from 1 to 12 carbon atoms; alkenylene groups preferably those having from 2 to 20 carbon atoms, more preferably from 2 to 16 carbon atoms, further preferably from 2 to 12 carbon atoms; and alkynylene groups, preferably those having from 2 to 20 carbon atoms, more preferably from 2 to 16 carbon atoms, further preferably from 2 to 12 carbon atoms.

The foregoing groups each may have a substituent.

Examples of the divalent linking group including one or more oxygen atoms or nitrogen atoms are as follows. These may be applied in combination.

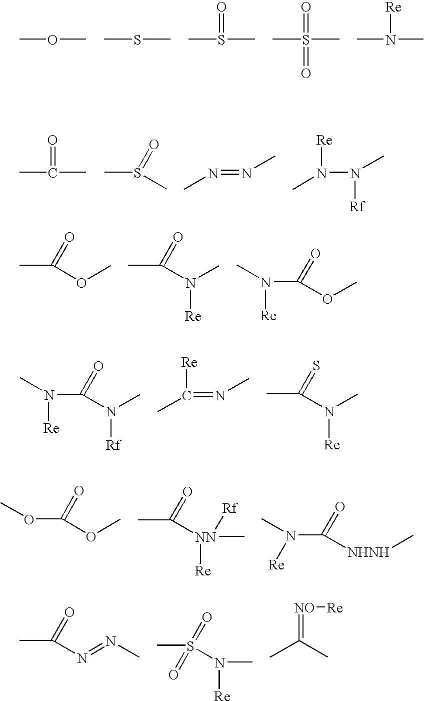

Herein, Re and Rf each represents the same as those defined for the aforesaid Ra through Rd.

H₃₁Ar is an aromatic hydrocarbon group or an aromatic heterocyclic group. The aromatic hydrocarbon group represented by H₃₁Ar is preferably a group having from 6 to 30 carbon atoms, and is more preferably a single ring or fused ring aryl group having from 6 to 20 carbon atoms. For example, a phenyl group and a naphthyl group are listed, and among them, the phenyl group is particularly preferred. The aromatic heterocyclic group represented by H₃₁Ar is a 5- to 10-membered unsaturated heterocyclic ring having at least one of N, O, or S. The heterocyclic ring in the group may be either a single ring or a fused ring. Preferred as heterocyclic rings in such heterocyclic groups are 5- or 6-membered aromatic heterocyclic rings and their benzo-fused rings. Of these, more preferred are 5- or 6-membered aromatic heterocyclic or 5 or 6-membered aromatic heterocyclic rings containing a nitrogen atom and benzo-fused rings thereof. Of these, further more preferred are 5- or 6-membered aromatic heterocyclic rings containing one or two nitrogen atoms and benzo-fused rings thereof.

Aromatic hydrocarbon groups as well as aromatic heterocyclic groups, represented by H₃₁Ar, may have a substituent. Listed as the substituents may be, for example, the same groups as listed as the substituents for T₃₁ and the preferred range is also the same. These substituents may be substituted. Further, when there are at least two substituents, they may be the same or different. The groups represented by H₃₁Ar are preferably aromatic heterocyclic groups.

Listed as aliphatic hydrocarbon groups, aryl groups, and heterocyclic groups, represented by Ra, Rb, Rc, and Rd, may be the same groups listed as examples of aromatic hydrocarbon groups, aryl groups, and heterocyclic groups in aforesaid T₃₁, and the preferred range is also the same as above. Listed as acyl groups represented by Ra, Rb, Rc, and Rd are aliphatic or aromatic groups having from 1 to 12 carbon atoms. Specifically listed are an acetyl group, a benzoyl group, a formyl group, and a pivaloyl group. Listed as nitrogen-containing heterocyclic groups which are formed by combining Ra and Rb, Rc and Rd, Ra and Rc, or Rb and Rd are 3- to 10-membered unsaturated heterocyclic rings, for example, cyclic groups such as a piperidine ring, a piperazine ring, an acridine ring, a pyrrole ring, and a morpholine ring.

Listed as specific examples of acid anions, represented by M₃₁, which are ions necessary to offset the charge in the molecule are, for example, halogen ions, for example, chloride ions, bromide ions, and iodide ions, p-toluenesulfonate ions, perchlorate ions, boron tetrafluoride ions, sulfate ions, methyl sulfate ions, ethyl sulfate ions, methanesulfonate ions, and trifluoromethanesulfonate ions.

The macrocyclic compound containing hetero atoms is a 9 or more member macrocyclic compound including at least one of a nitrogen atom, an oxygen atom, a sulfur atom and a selenium atom. Typical one of such the compounds is crown ether which is synthesized in 1967 by C. J. Pedersen. Many compounds have been synthesized because they show unique property as reported by him. Such the compounds are described in detail in C. J. Pedersen, “Journal of American Chemical Society” vol. 86 (2495), 7017-7036 (1967); G. W. Gokel, S. H. Korzeniowski, “Macrocyclic Polyether Synthesis”, Springer-Verlag, (1982); Oda, Shono, and Tabuse, “Crown Ether no Kagaku (Chemistry of Crown Ether)”, Kagaku Dojin (1978); Tabuse et al., “Host-Guest”, Kyoritsu Shuppan (1979); and Sasaki and Koga, “Yuuki Gousei Kagaku (Organic synthesizing Chemistry)”, vol. 45(6), 571-582. As concrete examples of such the macrocyclic compound containing a hetero atom, those described in Japanese Patent Publication Open to Public Inspection No. 2000-34734, paragraph 0030 to 0037 can be referred.

The supersensitizer is preferably used in the emulsion layer containing the organic silver salt and the silver halide grains in am amount of from 0.001 to 1.0 mole, particularly from 0.01 to 0.5 moles, per mole of silver.

Suitable binders for the thermally developable light-sensitive material of the invention are to be transparent or translucent and commonly colorless, and include natural polymers, synthetic resin polymers and copolymers, as well as media to form film. The binders include, for example, gelatin, gum Arabic, poly(vinyl alcohol), hydroxyethyl cellulose, cellulose acetate, cellulose acetate butyrate, poly(vinyl pyrrolidone), casein, starch, a compound composed of a polymer or copolymer containing an ethylenic unsaturated monomer, as a constituting unit, such as vinyl chloride, vinyl acetate, vinyl alcohol, maleic acid, acrylic acid, acrylate, vinylidene chloride, acrylonitrile, methacrylic acid, methacrylate, styrene, butadiene, ethylene, vinyl butyral, vinyl acetal and vinyl ether; polyurethane resin, various kinds of rubber type resin. Moreover, phenol resin, epoxy resin, polyurethane hardenable resin, urea resin, melamine resin, alkyd resin, formaldehyde resin, silicone resin, epoxy-polyamide resin and polyester resin are usable. Details of such the resins are described in “Plastic Handbook”, Asakura Shoten. Typical examples of the resin include poly(vinyl chloride), copoly(styrene-maleic anhydride, copoly(styrene-acrylonitrile), copoly(styrene-butadiene), poly(vinyl acetals such as poly(vinyl formal) and poly(vinyl butyral), polyesters, polyurethanes, phenoxy resin, poly(vinylidene chloride) polyepoxides, polycarbonates, poly(vinyl acetate), cellulose esters and polyamides. The binders may be hydrophilic or hydrophobic.

Preferable binders for the light-sensitive layer of the thermally developable light-sensitive material of the present invention are poly(vinyl acetal), and a particularly preferable binder is poly(vinyl butyral), which will be detailed hereunder. Polymers such as cellulose esters, especially polymers such as triacetyl cellulose, cellulose acetate butyrate, which exhibit higher softening temperature, are preferable for an overcoating layer as well as an undercoating layer, specifically for a light-insensitive layer such as a protective layer and a backing layer. Incidentally, if desired, the binders may be employed in combination of at least two types. As the binder, one in which at least one or more polar groups selected from a —COOM group, an —OSO₃M group, an —OSO₃M group, a —P═O(OM)₂ group an —O—P═O(OM)₂ group, in which M is a hydrogen atom or an alkali metal base, an —N(R)₂ group, an —N⁺(R)₃ group, in which R is a hydrocarbon group, an epoxy group, an —SH group and a —CN group are introduced by copolymerization or addition reaction. As the polar group, the —SO₃M group and the —OSO₃M group are particularly preferable. The amount of the polar group is from 10⁻⁸ to 10⁻¹ moles/g, more preferably from 10⁻⁶ to 10⁻² moles/g.

The binders are employed in the range of a proportion in which the binders function effectively. Skilled persons in the art can easily determine the effective range. For example, preferred as the index for maintaining aliphatic carboxylic acid silver salts in a light-sensitive layer is the proportion range of binders to aliphatic carboxylic acid silver salts of 15:1 to 1:2 and most preferably of 8:1 to 1:1. Namely, the binder amount in the light-sensitive layer is preferably from 1.5 to 6 g/m², and is more preferably from 1.7 to 5 g/m². When the binder amount is less than 1.5 g/m², density of the unexposed portion markedly increases, whereby it occasionally becomes impossible to use the resultant material.

The glass transition point Tg of the binder to be employed in the invention is preferably from 70° C. to 105° C. The glass transition point Tg can be determined by a differential scanning calorimeter. The glass transition point is determined by the cross point of the base line and the gradient of the endothermic peak.

In the invention, the glass transition temperature Tg is determined employing the method, described in Brandlap, et al., “Polymer Handbook”, pages from III-139 through III-179, 1966 (published by Wily and Son Co.). The Tg of the binder is obtained based on the following formula when the binder comprises copolymer resins.

Tg of the copolymer (in ° C.)=v₁Tg₁+v₂Tg₂+ . . . +vₙTgₙ wherein v₁, v₂, . . . vₙ each represents the mass ratio of the monomer in the copolymer, and Tg₁, Tg₂, . . . Tgₙ each represents Tg (in ° C.) of the homopolymer which is prepared employing each monomer in the copolymer.

The accuracy of Tg, based on the formula calculation, is ±5° C.

Use of the binder having a Tg of from 70 to 105° C. is preferred since sufficient maximum density can be obtained on the occasion of the image formation.

In the invention, the binder is one having a Tg of from 70 to 105° C. and an average molecular weight of from 1,000 to 1,000,000, preferably 10,000 to 500,000, and a polymerization degree of approximately from 50 to 1,000.

The foregoing polymer and copolymer each containing the ethylenic unsaturated monomer as the constituting unit are described in detail below. Examples of the ethylenic unsaturated monomer capable of being the constituting unit of the polymers include alkyl acrylates, aryl acrylates, alkyl methacrylates, aryl methacrylates, alkyl cyanoacrylates, and aryl cyanoacrylates, in which the alkyl group or aryl group may be substituted or not. Specific alkyl groups and aryl groups include a methyl group, an ethyl group, an n-propyl group, an isopropyl group, an n-butyl group, an isobutyl group, a sec-butyl group, a tert-butyl group, an amyl group, a hexyl group, a cyclohexyl group, a benzyl group, a chlorobenzyl group, an octyl group, a stearyl group, a sulfopropyl group, an N-ethyl-phenylaminoethyl group, a 2-(3-phenylpropyloxy)ethyl group, a dimethylaminophenoxyethyl group, a furfuryl group, a tetrahydrofurfuryl group, a phenyl group, a cresyl group, a naphthyl group, a 2-hydroxyethyl group, a 4-hydroxybutyl group, a triethylene glycol group, a dipropylene glycol group, a 2-methoxyethyl group, a 3-methoxybutyl group, a 2-actoxyethyl group, a 2-acetacttoxyethyl group, a 2-methoxyethyl group, a 2-iso-proxyethyl group, a 2-butoxyethyl group, a 2-(2-methoxyethoxy)ethyl group, a 2-(2-ethoxyethoxy)ethyl group, a 2-(2-bitoxyethoxy)ethyl group, a 2-diphenylphsophorylethyl group, an ω-methoxypolyethylene glycol (the number of addition mol n=6), an ally group and dimethylaminoethylmethyl chlorides.

In addition, employed may be the monomers described below. Examples of the monomer include vinyl esters such as vinyl acetate, vinyl propionate, vinyl butyrate, vinyl isobutyrate, vinyl corporate, vinyl chloroacetate, vinyl methoxyacetate, vinyl phenyl acetate, vinyl benzoate, and vinyl salicylate; N-substituted acrylamides, N-substituted methacrylamides and acrylamide and methacrylamide: N-substituents include a methyl group, an ethyl group, a propyl group, a butyl group, a tert-butyl group, a cyclohexyl group, a benzyl group, a hydroxymethyl group, a methoxyethyl group, a dimethylaminoethyl group, a phenyl group, a dimethyl group, a diethyl group, a β-cyanoethyl group, an N-(2-acetacetoxyethyl) group, a diacetone group; olefins such as dicyclopentadiene, ethylene, propylene, 1-butene, 1-pentane, vinyl chloride, vinylidene chloride, isoprene, chloroprene, butadiene, and 2,3-dimethylbutadiene; styrenes such as methylstyrene, dimethylstyrene, trimethylstyrene, ethylstyrene, isopropylstyrene, tert-butylstyrene, chloromethylstryene, methoxystyrene, acetoxystyrene, chlorostyrene, dichlorostyrene, bromostyrene, and vinyl methyl benzoate; vinyl ethers such as methyl vinyl ether, butyl vinyl ether, hexyl vinyl ether, methoxyethyl vinyl ether, and dimethylaminoethyl vinyl ether; N-substituted maleimides including, for example a methyl group, an ethyl group, a propyl group, a butyl group, a tert-butyl group, a cyclohexyl group, a benzyl group, an n-dodecyl group, a phenyl group, a 2-methylphenyl group, a 2,6-diethylphenyl group, or a 2-chlorophenyl group as the N-substituents; and others including butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methyl vinyl ketone, phenyl vinyl ketone, methoxyethyl vinyl ketone, glycidyl acrylate, glycidyl methacrylate, N-vinyl oxazolidone, N-vinyl pyrrolidone, acrylonitrile, metacrylonitrile, methylene malononitrile, vinylidene chloride.

Among them, particularly preferred examples are alkyl methacrylates, aryl methacrylate and styrenes. Of such Poly(vinyl acetal) having an acetoacetal structure is preferred among the polymers having the acetal group. As examples of such the poly(vinyl acetal) are those described in U.S. Pat. Nos. 2,358,836, 3,003,879 and 2,828,204, British Patent No. 771,155.

Particularly preferred as polymers having an acetal group are the compounds represented by Formula V described below.

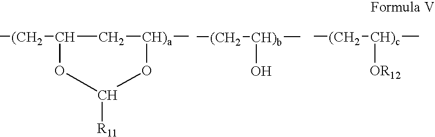

wherein R₁₁ represents a substituted or unsubstituted alkyl group, and a substituted or unsubstituted aryl group, however, groups other than the aryl group are preferred; R₁₂ represents a substituted or unsubstituted alkyl group, a substituted or unsubstituted aryl group, a —COR₁₃ group or a —CONHR₁₃ group, wherein R₁₃ represents the same as defined above for R₁₁.

Unsubstituted alkyl groups represented by R₁₁, R₁₂, and R₁₃ preferably have from 1 to 20 carbon atoms and more preferably have from 1 to 6 carbon atoms. The alkyl groups may have a straight or branched chain, but preferably have a straight chain. Listed as such unsubstituted alkyl groups are, for example, a methyl group, an ethyl group, an n-propyl group, an isopropyl group, an n-butyl group, an isobutyl group, a t-butyl group, an n-amyl group, a t-amyl group, an n-hexyl group, a cyclohexyl group, an n-heptyl group, an n-octyl group, a t-octyl group, a 2-ethylhexyl group, an n-nonyl group, an n-decyl group, an n-dodecyl group, and an n-octadecyl group. Of these, particularly preferred is a methyl group or a propyl group.

Unsubstituted aryl groups preferably have from 6 to 20 carbon atoms and include, for example, a phenyl group and a naphthyl group. Listed as groups which can be substituted for the alkyl groups as well as the aryl groups are an alkyl group such as a methyl group, an n-propyl group, a t-amyl group, a t-octyl group, an n-nonyl group, and a dodecyl group; an aryl group such as a phenyl group; a nitro group; a hydroxyl group; a cyano group; a sulfo group; an alkoxy group such as a methoxy group; an aryloxy group such as a phenoxy group; an acyloxy group such as an acetoxy group; an acylamino group such as an acetylamino group; a sulfonamido group such as methanesulfonamido group; a sulfamoyl group such as a methylsulfamoyl group; a halogen atom such as a fluorine atom, a chlorine atom, and a bromine atom; a carboxyl group; a carbamoyl group such as a methylcarbamoyl group; an alkoxycarbonyl group such as a methoxycarbonyl group; and a sulfonyl group such as a methylsulfonyl group. When at least two of the substituents are employed, they may be the same or different. The number of total carbons of the substituted alkyl group is preferably from 1 to 20, while the number of total carbons of the substituted aryl group is preferably from 6 to 20.

R₁₂ is preferably a —COR₁₃ group wherein R₁₃ represents an alkyl group or an aryl group, or a —CONHR₁₃ group wherein R₅₃ represents an aryl group. “a”, “b”, and “c” each represents the value in which the weight of repeated units is shown utilizing mol percent; “a” is in the range of 40 to 86 mol percent; “b” is in the range of from 0 to 30 mole percent; “c” is in the range of 0 to 60 mole percent, so that a+b+c=100 is satisfied. Most preferably, “a” is in the range of 50 to 86 mole percent, “b” is in the range of 5 to 25 mole percent, and “c” is in the range of 0 to 40 mol percent. The repeated units having each composition ratio of “a”, “b”, and “c” may be the same or different.

Polymers represented by the aforesaid Formula (V) of the present invention can be synthesized employing common synthetic methods described in “Sakusan Binihru Jushi (Vinyl Acetate Resins)”, edited by Ichiroh Sakurada (Kohbunshi Kagaku Kankoh Kai, 1962).

Employed as polyurethane resins usable in the present invention may be those, known in the art, having a structure of polyester polyurethane, polyether polyurethane, polyether polyester polyurethane, polycarbonate polyurethane, polyester polycarbonate polyurethane, or polycaprolactone polyurethane.

It is preferable that the molecular terminal of the polyurethane molecule has at least one OH group and at least two OH groups in total. The OH group crosslinks with polyisocyanate as a hardening agent so as to form a 3-dimensinal net structure. Therefore, the more OH groups which are incorporated in the molecule, the more preferred. It is particularly preferable that the OH group is positioned at the terminal of the molecule since thereby the reactivity with the hardening agent is enhanced. The polyurethane preferably has at least three OH groups at the terminal of the molecules, and more preferably has at least four OH groups. When polyurethane is employed, the polyurethane preferably has a glass transition temperature of 70 to 105° C., a breakage elongation of 100 to 2,000 percent, and a breakage stress of 0.5 to 100 M/mm².

The polymers may be employed singly or blended together with 2 or more kinds thereof. The polymers mentioned above are used as the principal binder in the image forming layer according to the invention. The “principal binder” means that the polymer accounts for 50% or more by weight of the whole binder of the image forming layer. Accordingly, another binder may be blended within the range of less than 50% by weight.

Poly(vinyl acetate), polyacryl resin and urethane resin are preferably used as such the polymer even though there is no limitation on the resin as long as the resin is miscible with the binder according to the invention.

In the invention, an organic gelation agent may be contained in the image forming layer. The organic gelation agent is a compound such as polyvalent alcohols, which provides a yield point and bereaves or reduces the fluidity of an organic liquid system when the compound is added to the organic liquid.

In the invention, it is preferable embodiment that 50% by weight or more of the whole binder contained in the coating liquid for the image forming layer is aqueous polymer latex.

When the image forming layer contains the polymer latex, it is preferred that 50% by weight or more, preferably 70% or more, of the whole binder in the image forming layer is the polymer latex.

The “polymer latex” relating to the invention is one comprising a water-soluble dispersion medium and fine particle of water-insoluble hydrophobic polymer dispersed in the medium. The dispersed state may be any of one in which the polymer is emulsified in the dispersion medium, one prepared by emulsion polymerization, one in which the polymer is dispersed in micelle state and one in which the polymer molecular has a hydrophilic moiety and the molecular chain itself is dispersed in a molecular state.

The average diameter of the dispersed particles is preferably from 1 to 50,000 nm, more preferably from 5 to 1,000 nm. There is no limitation on the distribution of the particle diameter and a wide diameter distribution and monodispersed distribution are also allowed.

The polymer latex relating to the invention, usual uniform structure polymer latex and latex so-called as core/shell type latex are usable. In the later case, occasionally preferable results are shown when the transition point of the core is different from that of the shell. The minimum film forming temperature, MFT, is preferably from −30° C. to 90° C., more preferably from about 0° C. to about 90° C. A film formation aid may be added for controlling the minimum film forming temperature. The film formation aid usable in the invention is also called as plasticizer which is organic compounds, usually an organic solvent, capable of lowering the minimum film forming temperature of the polymer latex. Examples of such the compound are described in “Gousei Latex no Kagaku (Chemistry of Synthesized Latex)” edited by Souichi Muroi, Koubunshi Kankou-Kai, 1970.

The kinds of the polymer to be employed in the polymer latex are acryl resins, vinyl acetate resins, polyester resins, polyurethane resins, rubber type resins, vinyl chloride resins, vinylidene chloride resins, polyolefin resins and copolymers of them. Straight chain polymers and branched chain polymers are also usable. The polymer may be either a polymer of the same monomer so-called as homopolymer or a copolymer formed by polymerization of two or more kinds of monomer. The copolymer may be either a random copolymer or a block copolymer. The molecular weight of the polymer is usually from 5,000 to 100,000, preferably from 10,000 to 100,000. When the molecular weight is too small, the mechanical strength of the light-sensitive layer is become insufficient. The polymer having the molecular weight is too large is not preferable since the film forming property is degraded.

The equilibrium moisture content at a temperature of 25° C. and latex and a relative humidity of 60% of the latex is preferably from 0.01 to 2%, preferably from 0.01 to 1%, by weight. As to the definition and the measuring method of the equilibrium moisture content, for example, “Koubunshi Kougaku Kouza 14, Koubunshi Zairyou Shiken Hou (Polymer Engineering Course 14, Polymer Material Test Method)” edited by Koubunshi Gakkai, CHijin Shokan, can be referred.

Concrete examples of the polymer latex include latex of methyl methacrylate/ethyl acrylate/methacrylic acid copolymer, latex of methyl methacrylate/2-ethylhexyl methacrylate/styrene/acrylic acid copolymer, latex of styrene/butadiene/acrylic acid copolymer, styrene/butadiene/divinylbenzene/methacrylic acid copolymer, latex of methyl methacrylate/vinyl chloride/acrylic acid copolymer, and latex of vinylidene chloride/ethyl acrylate/acrylonitrile/methacrylic acid copolymer.

These polymers may be employed singly or in a bended form of 2 or more kinds. It is preferable that the polymer of the latex contains carboxylic component such as acrylate or methacrylate in an amount of from about 0.1 to about 10% by weight.

Moreover, hydrophilic polymer such as gelatin, poly(vinyl alcohol), methyl cellulose, hydroxypropyl cellulose, carboxymethyl cellulose and hydroxypropylmethyl cellulose may be added in an amount of not more than 50% by weight according to necessity. The adding amount of such the hydrophilic polymer is preferably not more than 30% by weight of the whole amount of the binders in the image forming layer.

The organic silver salt and aqueous latex may be added in any order or simultaneously in the course of preparation of the image forming layer coating liquid according to the invention; it is preferred to add the polymer latex after the addition of the organic silver salt.

Furthermore, it is preferable that the organic silver salt and further the reducing agent are mixed previous to the addition of the polymer latex. In the invention, the coating liquid is preferably stood for the later-mentioned period at a temperature of from 30° C. to 60° C. after the mixing of the organic silver salt and the polymer latex since the status of the coated surface is degraded when the standing temperature is too low and the fogging is raised when the standing temperature is too high. It is preferred that the coating liquid is stood at a temperature of from 35° C. to 60° C., particularly from 35° C. to 55° C. The temperature can be held by thermally insulating the preparation tank of the coating liquid.

The coating the image forming layer coating liquid according to the invention is preferably performed by employing the coating liquid previously stood after mixing of the organic silver salt and the polymer latex for a period of from 30 minutes to 24 hours, more preferably from 60 minutes to 12 hours, particularly preferably from 120 minutes to 10 hours.

The “after mixing” means after that the organic silver salt and the aqueous polymer latex are added and uniformly dispersed.

In the invention, it is preferable to utilizing a crosslinking agent to the binder since the adhesion of the layer to the support is improved and the uneven development is inhibited. Further, the addition of the crosslinking agent is effective for inhibiting the occurrence of fog during the storage and formation of print-out silver after the development.

As the crosslinking agent, various crosslinking agents usually employed in the light-sensitive material such as aldehyde type, epoxy type, ethyleneimine type, vinylsulfon type, sulfonate type, acryloyl type, carbodiimide type and silane type crosslinking agent are usable, which are described in, for example, Japanese Patent Publication Open to Public Inspection No. 50-96216.

Isocyanate type and iso-thiocyanate type crosslinking agents each represented by the following Formula 2 are described below.

Formula 2

X₂═C═N—L—(N═C═X₂)ᵥ

Wherein v is 1 or 2; L is a v+1 valent linking group which is an alkylene group, an alkenylene group, an aryl group or an alkylaryl group; and X₂ is an oxygen or a sulfur atom.

In the compounds represented by the above Formula 2, the aryl ring of the aryl group may have a substituent. Examples of preferable substituent include a halogen atom such as a bromine atom and a chlorine atom; a hydroxyl group, a carboxyl group, an alkyl group; and an alkoxyl group.

The foregoing isocyanate crosslinking agent is isocyanate compounds each have at least two isocyanate groups and adducts thereof. Concrete examples of the isocyanate compound include aliphatic isocyanates, benzenediisocyanates, naphthalenediisocyanates, biphenylisocyanates, diphenylmethanediisocyanates, triphenylmethanediisocyanates, triisocyanates, tetraisocyanates, addacts of the above-described isocyanate compounds and addacts of these isocyanate compounds with di-valent or tri-valent polyalcohols.

Concretely isocyanate compounds described on page 10 to 12 of Japanese Patent Open to Public Inspection can be applied.

The adduct of the isocyanate and the polyalcohol has particular high ability to improve the adhesiveness between the layers and prevent the peeling of the layer, divergence of the image position and occurrence of foams. The isocyanate compound may be contained in any portion of the light-sensitive material. The compound may be optionally contained in any layer provided on the light-sensitive layer side of the support such as the support, light-sensitive layer, surface protective layer, interlayer and anti-halation layer. When the support is paper, the compound may be contained in the sizing composition thereof. The composition may be contained one or more of the foregoing layers.

Compounds having the thioisocyanate structure corresponding to that of the foregoing isocyanates are useful as the thioisocyante crosslinking agent to be employed in the invention.

The amount of the crosslinking agent is usually from 0.001 to 2 moles, preferably from 0.005 to 0.5 moles, per mole of silver.

In the invention, the isocyanate compounds and the thioisocyanate compound to be contained is preferable ones each capable of functioning as the crosslinking agent as above-described. However, compounds each having only one functional group, namely v in Formula is 0, are also show good results.

Examples of silane compound capable of being employed include the compounds represented by Formulas 1 through 3 described in Japanese Patent Publication Open to Public Inspection No. 2001-264930.

Compounds, which can be used as a crosslinking agent, may be those having at least one epoxy group. The number of epoxy groups and corresponding molecular weight are not limited. It is preferable that the epoxy group be incorporated in the molecule as a glycidyl group via an ether bond or an imino bond. Further, the epoxy compound may be a monomer, an oligomer, or a polymer. The number of epoxy groups in the molecule is commonly from about 1 to about 10, and is preferably from 2 to 4. When the epoxy compound is a polymer, it may be either a homopolymer or a copolymer, and its number average molecular weight Mn is most preferably in the range of about 2,000 to about 20,000.

Acid anhydride compounds to be used in the invention are those each having at least one acid anhydride group represented by the following formula.

—CO—O—CO—

There is no limitation on the number of the acid anhydride group, the molecular weight as long as they each have one acid anhydride group.

The foregoing epoxy compounds and the acid anhydride compounds may be used singly or in combination of two or more kinds thereof. The amount of such the compound is preferably from 1×10⁻⁶ to 1×10⁻² moles/m², more preferably from 1×10⁻⁵ to 1×10⁻³ moles/m².

In the invention, the epoxy compounds and the acid anhydride compounds can be added into optional layers such as one or more of the light-sensitive layer, surface protective layer, interlayer, anti-halation layer and subbing layer provided on the light-sensitive layer side of the support.

Next, the fog inhibitor preferably employed in the invention is described below. The fog inhibitors preferably employed in the invention include compounds represented by the following Formula A-6, A-7 or A-8.

X¹—SO₂—S—M¹ Formula A-6

X¹—SO₂—S—Y¹ Formula A-7

X¹—SO—S—Y¹ Formula A-8

In the above formulas, X¹ and Y₁ are each a substituted or unsubstituted alkyl group, an aryl group or a heterocyclic group; and M¹ is a metal atom or an organic cation.

The aliphatic hydrocarbon group represented by X₁ or Y₁ is a straight chain, a branched chain or cyclic alkyl group preferably those each having from 1 to 20, more preferably from 1 to 16, further preferably from 1 to 12, carbon atoms; an alkenyl group preferably those each having from 2 to 20, more preferably from 2 to 16, further preferably from 2 to 12, carbon atoms; or an alkynyl group preferably those each having from 2 to 20, more preferably from 2 to 16, further preferably from 2 to 12, carbon atoms, each of which may have a substituent. The substituent of the aliphatic hydrocarbon group is preferably an alkyl group, an alkoxyl group and a heterocyclic group, more preferably an aryl group and a heterocyclic group. The aliphatic hydrocarbon group represented by X¹ or Y¹ is preferably an alkyl group, more preferably a chain alkyl group.

The aryl group represented by X¹ or Y¹ is preferably single ring or condensed ring aryl groups each having from 6 to 30, more preferably from 6 to 21, carbon atoms such as a phenyl group and a naphthyl group, particularly a phenyl group. The aryl groups represented by X¹ or Y¹ each may have a substituent. Concrete examples of the aryl groups represented by X¹ or Y¹ include a phenyl group, a 4-methylphenyl group, a naphthyl group, a benzoylamino group, a phenylsulfonylamino and a phenylureido group.

The heterocyclic represented by X¹ or Y¹ is 3- through 10-membered saturated or unsaturated heterocyclic groups each containing at least on of N, O or S atom; they may be a single ring or a ring condensed with another ring. The heterocyclic ring is preferably a 5- or 6-membered heterocyclic group, more preferably a 5- or 6-membered heterocyclic group containing a nitrogen atom, and further preferably a 5- or 6-membered heterocyclic group containing 1 or 2 nitrogen atoms. Concrete examples of the heterocyclic group included an imidazolyl group, a thiazolyl group, an oxazolyl group, a 1,2,4-triazolyl group, a 1,3,4-oxadiazolyl group, a pyridyl group, a quinolyl group, a tetrazolyl group, a benzimidazolyl group, a bebzoxazolyl group, a benzothiazolyl group, a benzotriazolyl group and a triazinyl group.

As the metal atom or the organic cation represented by M an alkali metal ion such as a sodium ion and a potassium ion: and an organic ion such as ammonium ion and a guanidine ion are preferred.

Concrete examples of the compound represented by Formula A-6, A-7 or A-8 include Exemplified Compounds a through j described in paragraph 0012 of Japanese Patent Publication Open to Public Inspection No. 8-314059, thiosulfonates A through K described in paragraph 0028 of Japanese Patent Publication Open to Public Inspection No. 7-09797, and Exemplified Compounds 1 through 44 described on page 14 of Japanese Patent Publication Open to Public Inspection No. 55-140833. The concrete examples of the compound relating to the invention are shown below but the compound usable in the invention is not limited thereto.

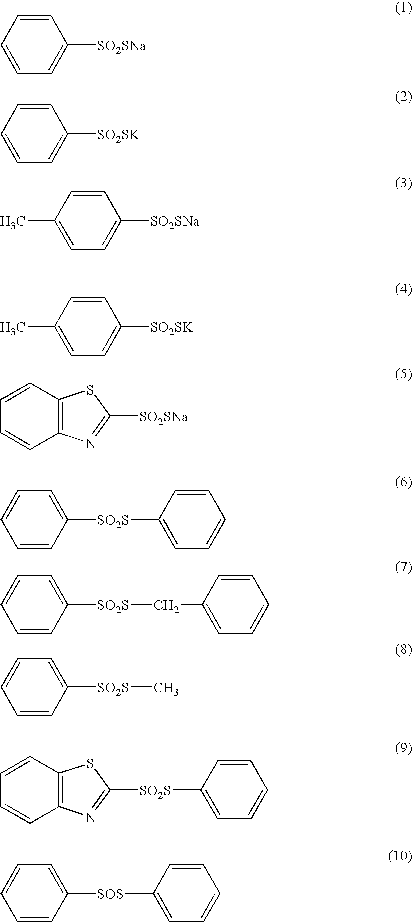

Compounds represented by the following Formula A-9 are described below.

Z₇-P₇-L₇-(C═Q₇)-W₇ Formula A-9

wherein, P₇ is an oxygen atom, a sulfur atom or an —NH group; Q₇ is an oxygen atom or a sulfur atom: W₇ is an —OH group, an —OM group, an —SH group or an —SM group, in which M is a counter ion, or an —NH₂ group; L₇ is an alkylene group; and Z₇ is an alkyl group, an aryl group or a heterocyclic group.

Preferable examples of the substituent represented by —(C=Q₇)-W₇ are a carboxyl group, a carboxylic acid salt, a thiocarboxyl group, thiocarboxlic acid salt, and a carbamoyl group. When W₇ is a —OM group or an —SM group, the counter ions each represented by M are, for example, an inorganic or organic ammonium ion such as an ammonium ion, a triethylammonium ion and a pyridinium ion; an alkali metal ion such as a sodium ion and a potassium ion; an alkali-earth metal ion such as a calcium ion and a magnesium ion; and another metal ion such as an aluminum ion, a barium ion and a zinc ion. Ionic polymers or other organic compounds each having a reverse polarity charge and metal complex ions such as hydroxopentaquaaluminum(III) ion and tris(2,2′-bipyridine)iron(II) ion, each can be the counter ion. The substituent may be form an intramolecular salt together with another substituent in the molecule. The counter ion is preferably the sodium ion, potassium ion, ammonium ion, triethylammonium ion and pyridinium ion, more preferably the sodium ion, potassium ion and ammonium ion.

The length of the alkylene group represented by L₇ is preferably 1 through 4 atom length, more preferably 1 or 2 atom length. The alkylene group represented by L7 further may have a substituent. Preferable examples of such the substituent include a —CH₂— group, a —CH₂CH₂— group, a —CH(CH₃)— group and a —CH(CH₂CH₃)CH₂— group. The —CH₂— group is more preferable.

The alkyl group represented by Z₇ is a straight chain, branched chain or cyclic chain alkyl group and a combination thereof, each of them preferably has from 1 to 40, more preferably from 1 to 30, further preferably from 1 to 25, carbon atoms. Examples of such the alkyl group include a methyl group, an ethyl group, an allyl group, a propyl group, an iso-propyl group, a butyl group, a sec-butyl group, an iso-butyl group, a tert-butyl group, a pentyl group, a sec-pentyl group, a sec-pentyl group, an iso-pentyl group, a tert-pentyl group, a hexyl group, a cyclohexyl group, an octyl group, a tert-octyl group, a decyl group, an undecyl group, a dodecyl group, a tridecyl group, a pentadecyl group, a nonadecyl group, an icosyl group, docosyl group, a 2-hexyldecyl group, a 20ethylhexyl group, a 6-methyl-1-(3-methylhexyl)nonyl group and a benzyl group.

The alkyl group represented by Z₇ may have a substituent; the substituent may be any known groups. For instance, a halogen atom such as a fluorine atom, a chlorine atom, a bromine atom and an iodine atom; an alkyl group, an alkenyl group, an alkynyl group, an aryl group, a heterocyclic group including an N-substituted nitrogen-containing heterocyclic group such as a morpholino group; an alkoxycarbonyl group, an aryloxycarbonyl group, a carbamoyl group, an imino group, an N-substituted imino group, a thiocarbonyl group, a carbazoyl group, a cyano group, a thiocarbamoyl group, an alkoxyl group, an aryloxyl group, a heteroxyl group, an acyloxyl group, an alkoxycarbonyloxy group, an aryloxycarbonyloxy group, a sulfonyloxy group, an acylamido group, a sulfonamido group, a ureido group, a thioureido group, an imido group, an alkoxycarbonylamino group, an aryloxycarbonylamino group, a sulfamoyl group, a semicarbazido group, a thiosemicarbazido group, an alkylsulfonylureido group, an arylsulfonylureido group, a nitro group, an alkylsulfonyl group, an arylsulfonyl group, a sulfamoyl group, a phosphoamido group or a group having a phosphate structure, a silyl group, a carboxyl group and its salt, a phosphoric group, a hydroxyl group, and a quaternary ammonium group.

Examples of alkyl group having the substituent represented by Z₇ include an aryloxyalkyl group, an akoxyalkyl group, a polyalkyleneoxyalkyl group such as a hydroxyethoxyethyl group, an ethoxyethyl group and an ethoxyethoxyethyl group, and an alkylthioalkyl group such as an ethylthioethyl group.

The alkyl group represented by Z₇ is single ring or condensed ring aryl group each preferably having from 6 to 20 carbon atoms, more preferably from 6 to 16 carbon atoms, further preferably from 6 to 10 carbon atoms; a phenyl group and a naphthyl group are preferred. The aryl group represented by Z₇ may have a substituent; the substituent may be any groups as long as that shows no bad influence on the photographic property. For instance, the foregoing substituent of the alkyl group may be applied. The preferable substituting site on the aryl group is 2-position; and it is preferable that the substituent is one capable of forming a complex with a silver ion together with P₇, Q₇ or W₇. Preferable examples of preferable substituent and the substituting site include a 2-carboxyl group, a 2-thiocarboxyl group and 2-dithiocarboxyl group.

The heterocyclic group represented by Z₇ is preferably a 5- through 7-membered single or condensed ring group containing one ore more hetero atoms selected from a nitrogen atom, an oxygen atom and a sulfur atom. Preferable examples of the heterocyclic ring include a pyridine ring, a quinoline ring, an iso-quinoline ring, a pyrimidine ring, a pyrazine ring, a pyridazine ring, a phthalazine ring, a triazine ring, a furan ring, thiophene ring, a pyrrole ring, an oxazole ring, a benzoxazole ring, a thiazole ring, a benzothiazole ring, an imidazole ring, a benzimidazole ring, a thiadiazole ring and a triazole ring, more preferably a pyridine ring, a quinoline ring, a pyrimidine ring, a thiadiazole ring and a benzothiazole ring, particularly preferable a pyridine ring, a quinoline ring and a pyrimidine ring. The heterocyclic group represented by Z₇ may have a substituent which may be the same as those listed as the substituent of the alkyl group.

Z₇ is preferably a phenyl group, a naphthyl group, a quinolyl group, a pyridyl group, a pyrimidyl group and a polyethyleneoxy group, each may have a substituent, more preferably a phenyl group and a substituted phenyl group, particularly preferably a 2-alkylphenyl group, a 2,4-dialkylphenyl group, a 2-carbamoylphenyl group and a 2-thiocarboxyphenyl group. As the substituent of Z₇, ballast groups know in the field of photographic material, groups absorbing to silver, and groups providing water-solubility may be applicable. The substituents may be linked with together to form a bis-, tris- or tetrakis-form or polymerized to for a polymer.

The compounds represented by Formula A-9 can be employed by dissolving in water or a suitable organic solvent, for instance, alcohols such as methanol, ethanol, propanol and a fluorized alcohol; ketones such as acetone and methyl ethyl ketone; dimethylformamide; dimethylsulfo oxide; and methyl cellosolve. The compound can be used as an emulsified dispersion which can be prepared by dissolving the compound into oil such as dibutyl phthalate, tricresyl phosphate, glyceryl triacetate and diethyl phthalate and an assistance solvent such as ethyl acetate and cyclohexanone and subjected to mechanical dispersion according to well known methods. The compounds are also employed in a form of solid particles prepared by the method known as the solid dispersion method in which the powder of the compounds represented by Formula A-9 is dispersed in a medium such as water by a ball mill, a colloid mill or an ultrasonic dispersing machine.

The compounds represented by Formula A-9 are preferably added to the image forming layer or the layer adjacent to the image forming layer even though the compound may be added to any layer provided on the image forming layer side of the substrate. The adding amount of the compounds represented by Formula A-9 is preferably from 0.01 to 10 millimoles, preferably from 0.1 to 5 millimoles, further preferably from 0.2 to 2 millimoles, per square meter.

Concrete examples of the compound represented by Formula A-9 include Compounds I-1 through I-6 described in paragraph 0063 and Compounds C-1 through C-3 described in paragraph 0066 of Japanese Patent Publication Open to Public Inspection No. 2001-13627, and Compounds III-1 through III-108 described in paragraph 0027 of Japanese Patent Publication Open to Public Inspection No. 2002-90937. The preferable examples of the compound represented by Formula A9 are shown below. However the compound usable in the invention is not limited by the followings.

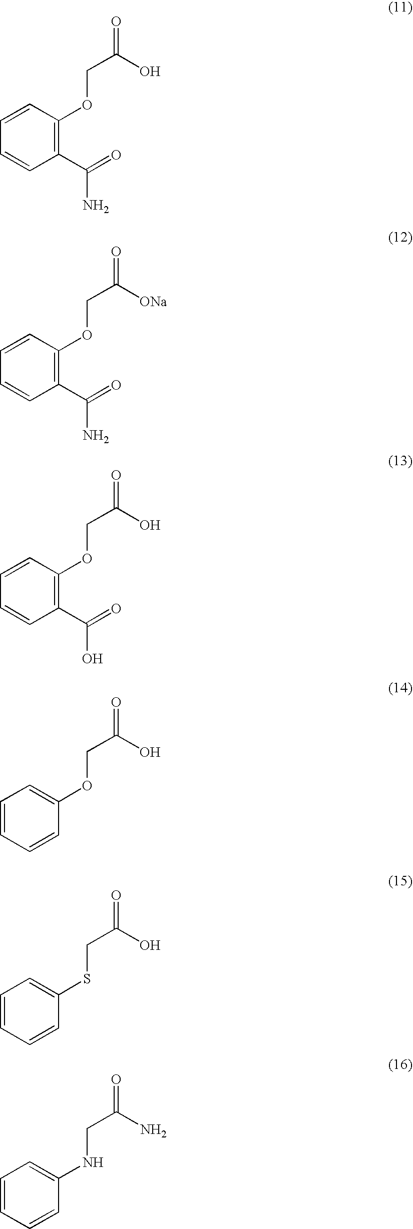

It is preferable that a compound with no reducing ability is employed in combination when the reducing agent employed in the invention is one having an aromatic —OH group, particularly bisphenol compounds. Examples of the group capable of forming a hydrogen bond with the hydroxyl group or the amino group include a phosphoryl group, a sulfoxide group, a sulfonyl, group, a carbonyl group, an amido group, an ester group, a urethane group, an ureido group, a tertiary amino group and a nitrogen-containing aromatic group. Of these, a phosphoryl group, a sulfoxide group, an amido group, a urethane group and a ureido group are preferred, provided that the amino group, urethane group and ureido group each have no ═N—H group and is blocked as ═N—R wherein R is a substituent other than a hydrogen atom.

In the invention, compounds represented by the following Formula A-10 are particularly preferred as the hydrogen bond formable compound.

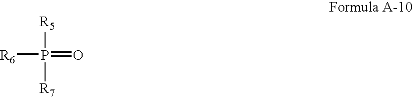

In Formula A-10, R₅, R₆ and R₇ are each independently an alkyl group, an aryl group, an aralkyl group, an alkoxyl group, an aryloxyl group, an amino group or a heterocyclic group, each of them may be unsubstituted or substituted. When the groups represented by R₅, R₆ or R₇ each have a substituent, the substituent is, for instance, a halogen atom, an alkyl group, an aryl group, an alkoxyl group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group and phosphoryl group. The alkyl group and the aryl group such as a methyl group, an ethyl group, an iso-propyl group, t-butyl group, a t-octyl group, a phenyl group, a 4-alkoxylphenyl group and a 4-acyloxyphenyl group are preferable as the substituent.

As the alkyl group represented by R₅, R₆ or R₇, substituted or unsubstituted alkyl groups each having from 1 to 20 carbon atoms and constituted by a straight chain, branched chain or cyclic chain or a combination of them are preferred. Concrete examples of such the alkyl group include a methyl group, an ethyl group, a butyl group, an octyl group, a dodecyl group, an iso-propyl group, a t-butyl group, a t-amyl group, a t-octyl group, a cyclohexyl group, a an 1-methylcyclohexyl group, a benzyl group, a phenetyl group and a 2-phenoxypropyl group. As the aralkyl group, one having from 7 to 27 is preferable and examples thereof include a benzyl group, a phenetyl group and a phenoxypropyl group.

As the aryl group, a single- and multi-ring substituted and unsubstituted aryl groups are preferred; examples thereof include a phenyl group, a cresyl group, a xylyl group, a naphthyl group, a 4-t-butylphenyl group, a 4-anisidyl group and a 3,5-dichlorophenyl group. As the alkoxyl group, substituted or unsubstituted alkoxyl groups each having from 1 to 20 carbon atoms and constituted by a straight chain, branched chain or cyclic chain or a combination of them are preferred. Examples of such the alkoxyl group include a methoxy group, an ethoxyl group, a butoxyl group, an octyloxyl group, a 2-ethylhexyloxy group, a 3,5,6-trimethylexyl group, a dodecyl group, a cyclohexyloxy group, a 4-methylcyclohexyloxy group and a benzyloxy group. As the aryloxy group, aryloxy groups each having from 6 to 20 carbon atoms are preferred. Examples of the aryloxy group include a phenoxy group, a cresyloxy group, an iso-propylphenoxy group, a 4-t-butylohenoxy group, a naphthoxy group and a biphenyloxy group.

As the amino group, amino groups having from 0 to 20 carbon atoms are preferred. Examples of such the group include a dimethylamino group, a dioctylamino group, an N-methyl-N-hexylamino group, a dihexylamino group, a diphenylamino group and an N-methyl-N-phenylamino group.

The heterocyclic group is saturated and unsaturated 3- through 10-membered heterocyclic groups each containing at least one of a nitrogen, an oxygen and a sulfur atoms. The heterocyclic groups may be a single ring or a condensed ring formed with another ring. Concrete examples of the heterocyclic ring of the heterocyclic group include a ring of pyrrolidine, piperidine, piperazine, morpholine, thiophene, furan, pyrrole, imidazole, pyrazole, pyridine, pyrimidine, pyrazine, pyridazine, triazole, triazine, indole, indazole, purine, thiadiazole, oxadiazole, quinoline, phthalazine, naphthilidine, quinoxaline, quinazoline, cinnoline, pteridine, acridine, phenanthroline, phenazine, tetrazole, thiazole, oxazole, benzimidazole, benzoxazole, benzothiazole, benzoselenazole, indolenine and tetraazaindene.

R₅ and R₆, R₆ and R₇, or R₅, R₆ and R₇ each may form a single ring or multi-ring hydrocarbon group which may be substituted. R₅ through R₇ are each preferably an alkyl group, an aryl group, an alkoxyl group or an aryloxyl group. From the viewpoint of the effects of the invention, it is preferable that at least one of R₅ through R₇ is an alkyl group or an aryl group, and more preferably at least two of R₅ through R₇ are each an alkyl group or an aryl group. It is preferable that the R₅ through R₇ are the same groups since the compound can be obtained with lowered cost.

Concrete examples of the compound represented by Formula A-10 include Compounds II-1 through II-40 described on paragraphs 0061 to 0064 of Japanese Patent publication Open to Public Inspection No. 2002-90937. The concrete examples are shown below. However the compound usable in the invention is not limited by these compounds.

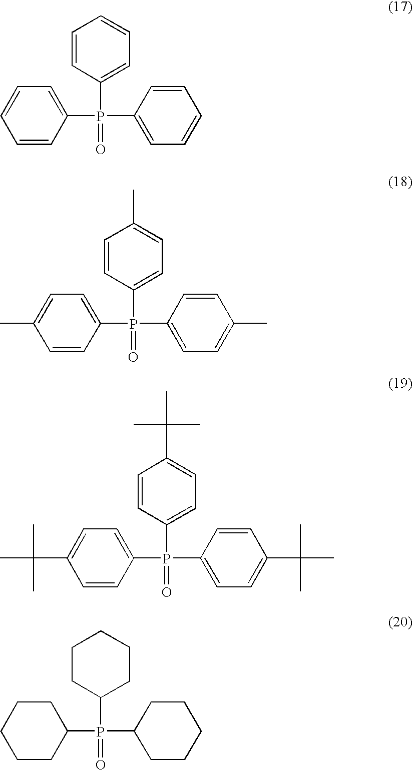

The compounds represented by Formula A-10 can be employed in the light-sensitive material by adding to the coating liquid in a form of solution, emulsified dispersion or solid fine particle dispersion. The compound represented by Formula A-10 forms a complex with a compound having a phenolic hydroxyl group or an amino group in the solution and the complex can be separated in a crystal state in some conditions of the combination of compound of Formula A-10 and the reducing agent. It is particularly preferred to use the powder of the separated complex in the form of the dispersion of solid fine particles for obtaining stable properties. A method for forming the complex can be preferably applied, in which the powder of reducing agent and the powder of the compound of Formula A-10 are mixed and dispersed by a dispersing machine such as a sand mill using a suitable dispersing agent to form the complex on the occasion of the dispersion. The compound represented by Formula A-10 is preferably employed in an amount of from 1 to 200 mole-percent, more preferably from 10 to 150 mole-percent, further preferably from 30 to 100 mole percent of the reducing agent.

In the invention, vinylsulfons represented by Formula A-11 and/or a β-halosulfons represented by Formula A-12 can be preferably employed for improving the stability of fogging.

(CH₂═CH—SO₂)ₙ₁₁—L₁₁ Formula A-11

(X₁₁CH₂—CH₂—SO₂)ₙ₁₁—L₁₁ Formula A-12

In the above formulas, X₁₁ is a halogen atom such as a chlorine atom and a bromine atom; nil is an integer of 1, 2. 3 or 4 and L₁₁ is an organic bonding group. The organic bonding group is, for instance, an alkyl group, an alkenyl group, an aryl group or a group constituted by an alkyl group and an aryl group such as an alkaryl group, an aralkyl group and an arylalkyl group which are known in the field of the art. Other examples of the bonding group are shown in the aforesaid patent publications regarding the silver halide photography.

The aryl ring may has a substituent selected from the group consisting of a halogen atom such as a chlorine atom and a bromine atom, a hydroxyl group, an amino group, a carboxyl group, an alkyl group and an alkoxyl group. When the term of “group” is used here for describe a substituent, the “group” also means the substituent including one further having a substituent. For instance, an “alkyl group” includes an ether group such as a CH₃—CH₂—CH₂—O—CH₂—, a haloalkyl group, a nitroalkyl group, a carboxyalkyl group, a hydroxyalkyl group and sulfoalkyl group. On the other hand, the term of “alkyl” means only hydrocarbon group. A substituent reactive with an active component such as a very strong electron attractive group or an oxidizing group is of course excluded as not inactive or not innocuous substrate.

The vinylsulfons and divinylsulfons are disclosed in, for example, U.S. Pat. Nos. 2,994,611, 3,061,436, 3,132,945, 3,490,911, 3,527,807, 3,593,644, 3,642,486, 3,642,908, 3,839,042, 3,841,872, 3,957,882, 4,088,495, 4,108,848, 4,137,082 and 4,142,897. Such the compounds are also described in Belgium Patent No. 819,015 and U.S. Pat. No. 4,173,481. Further more, Compounds VS-1 through VS-7 and Compounds HS-1 through HS-5 described in paragraph 0013 of Japanese Patent Publication Open to Public Inspection No. 6208192 can be referred. Specific examples of the aforesaid vinylsulfon compounds and β-halosulfon compounds preferably used as the fog inhibitor in the invention are shown below, however the invention is not limited thereto.

CH₂═CH—SO₂—CH(OH)—CH₂—SO₂—CH═CH₂ (21)

CH₂═CH—SO₂—CH₂—CH₂—O—CH═CH—SO₂—CH═CH₂ (22)

CH₂═CH—SO₂—CH═CH—SO₂—CH═CH₂ (23)

CH₂═CH—SO₂—CH₂—O—CH₂—SO₂—CH═CH₂ (24)

Cl—CH₂—CH₂—SO₂—CH₂—SO₂—CH₂—CH₂—Cl (25)

Br—CH₂—CH₂—SO₂—CH₂—SO₂—CH₂—CH₂—Br (26)

Cl—CH₂—CH₂—SO₂—CH₂—O—CH₂—SO₂—CH₂—CH₂—Cl (27)

The above listed fog inhibitors are generally employed at least 0.001 moles per mole of silver. The range of adding amount the compound is usually from 0.01 to 5 moles, preferably from 0.02 to 0.6 moles, per mole of silver.

Other than the aforesaid compounds, compounds known as the fog inhibitor may be added in the thermally developable light-sensitive material according to the invention. Such the compound may be one capable of forming the reactive species the same as that formed by the foregoing compounds or one showing the fog inhibiting effect by the different mechanism. For instance, compounds described in the following publications are referred: U.S. Pat. Nos. 3,589,903, 4,546,075, 4,452,885, 3,874,946 and 4,756,999, and Japanese Patent Publication Open to Public Inspection Nos. 59-57234, 9-288328 and 9-90550. As the other fog inhibitor, those described in U.S. Pat. No. 5,028,523 and European Patent Nos. 600,587, 605,981 and 631,176 are referred.

A toning agent for controlling the tone of the silver image is preferably contained in a dispersed state usually in the organic binder matrix since the photographic image is formed in the thermally developable light-sensitive material by the thermal development.

Examples of the tone controlling agent suitably employed in the invention are disclosed in RD 17029 and U.S. Pat. Nos. 4,123,282, 3,994,732, 3,846,136 and 4,021,249. The examples include the followings.

Imides such as succinimide, phthalimide, naphthalimide, N-hydroxy-1,8-naphthalimide; mercaptanes such as 3-mercapto-1,2,4-triazole; phthalazinone derivatives and metal salts thereof such as phthalazinone, 4-(1-naphthyl)phthalazinone, 6-chlorophthaldinone, 5,7-dimethyloxyphthalazinone and 2,3-dihydro-1,4-phthalazinedione; combinations if phthalazine and phthalic acids such as phthalic acid, 4-methylphthalic acid, 4-nitrophthalic acid and tetrachlorophthalic acid; combinations of phthalazine, maleic anhydride and at least one of phthalic acid, 2,3-naphthalenedicarboxylic acid, o-phenylene acid derivatives and anhydride thereof such as phthalic acid, 4-methylphthalic acid and tetrachlorophthalic acid anhydride are referred. Among them, the combinations of phthalzinone or phthalazine and phthalic acids or phthalic acid anhydrides are particularly preferable as the tone controlling agent.

Fluorine type surfactants represented by Formula A-13 are employed in the invention for improving the film conveying suitability and the suitability for environment or accumulation in living body.

{Rf-(L₁)ₙ₁-}ₚ-(Y)ₘ₁-(A)_{q} Formula A-13

In the formula, Rf is a substituent containing a fluorine atom; L₁ is a di-valent linking group containing no fluorine atom; Y is a di-, tri-, or tetra-valent linking group; A is an anionic group or a group of the salt of the anion; n1 and m1 are each an integer of 0 or 1; p is an integer of from 1 to 3; and q is an integer of from 1 to 3. Provided that n1 and m1 are not simultaneously 0 when q is 0.

In Formula A-13, Rf is a substituent containing a fluorine atom. Examples of the substituent include a fluorine-substituted alkyl group having from 1 to 20 carbon atoms, such as a methyl group, an ethyl group, a butyl group, an octyl group, dodecyl group and an octadecyl group, substituted by fluorine atom respectively; and a fluorine-substituted alkenyl group, such as a propenyl group, a butenyl group, a nonenyl group and a dodecenyl group, substituted by fluorine atom respectively.

L₁ is a di-valent linking group having no fluorine atom. Examples of the di-valent liking group having no fluorine atom include an alkylene group such as a methylene group, an ethylene group and a butylene group; an alkyleneoxy group such as a methyleneoxy group, an ethyleneoxy group and propyleneoxy group; an oxyalkylene group such as an oxymethylene group, an oxyethylene group and an oxybutylene group; an oxyalkyleneoxy group such as an oxymethyleneoxy group, an oxyethyleneoxy group and an oxyethyleneoxyethylenoxy group; a phenylene group; an oxyphenylene group; a phenyloxy group; and an oxyphenyloxy group; and combinations of these groups.

A is an anion group or its salt group, for instance, a carboxyl group or its salt group such as a sodium salt, a potassium salt and a lithium salt; a sulfonic acid or its salt group such as a sodium salt, a potassium salt and a lithium salt; and a phosphoric acid and its salt group such as a sodium salt and a potassium salt.

Y is 3-4-valent linking group having no fluorine atom, for example, of tri- or tetra-valent atom groups having no fluorine atom, which has a carbon atom or nitrogen atom as the central atom. “n1” is an integer of 0 or 1, and 1 is preferred.

The fluorine-containing surfactant represented by Formula A-13 can be obtained by introducing an anion group A by sulfate esterization to a compound (partially having the group represented by Rf) formed by a addition reaction or a condensation polymerization reaction of a fluorinated alkyl compound having from 1 to 25 carbon atoms such as a compound having a trifluoromethyl group, a pentafluoroethyl group, a perfluorobutyl group, perfluorooctyl group and a perfluoroocatdecyl group, and an alkenyl compound such as a compound having a perfluorohexenyl group and a perfluorononenyl group, with a tri- through hexa-vlent alkanol compound having no fluorine atom, an aromatic compound or a heterocyclic compound each having three or four hydroxyl groups and no fluorine atom.

Examples of the aforesaid tri- through hexa-valen alkanol compound include glycerol, pentaerythritol, 2-methyl-2-hydroxymethyl-1,3-propanediol, 2,4-dihydroxymethylpentene, 1,2,6-hexanetriol, 1,1,1-tris(hydroxymethyl)propane, 2,2-bis(butanol)-3-aliphatic triol, tetramethylolmethane, D-solbitol and D-mannitol.

Examples of the aforesaid aromatic compound and heterocyclic compound having three or four hydroxyl groups include 1,3,5-trihydroxybebzebe and 2,4,6-trihydroxypridine.

Preferable concrete compounds of the fluorinated surfactant represented by Formula A-13 are shown below.

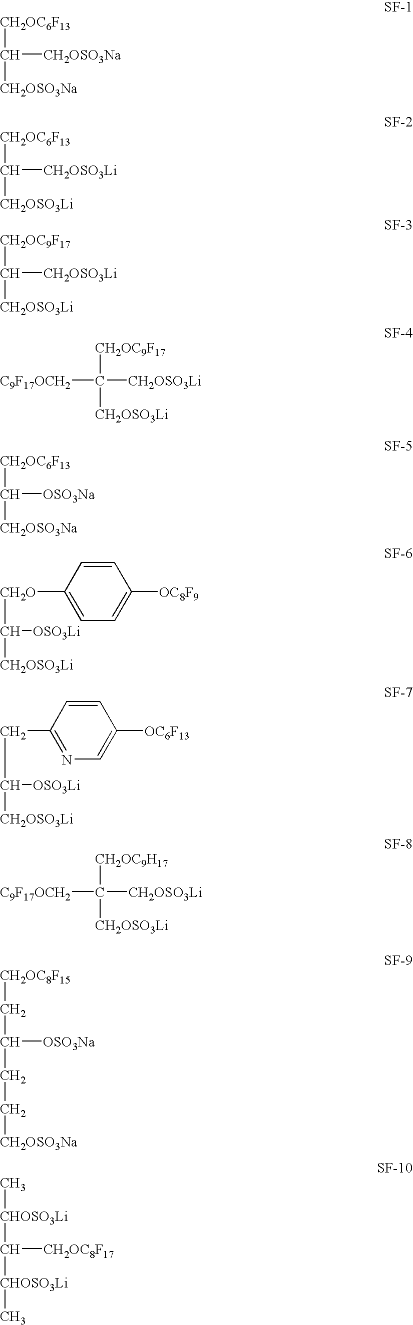

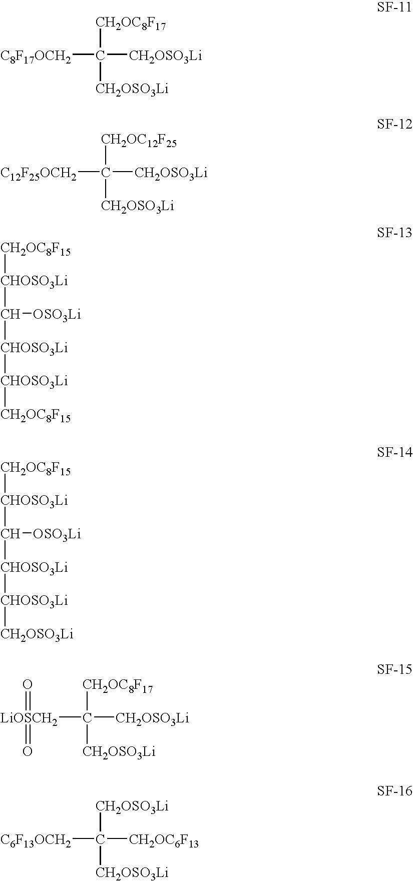

The fluorinated surfactant represented by Formula A-13 can be added to the coating liquid by a usually known adding method. Namely, the surfactant can be added in a form dissolved in an alcohol such as methanol and ethanol, a ketone such as methyl ethyl ketone and acetone or a polar solvent such as dimethylsulfoxide and dimethylformamide. Moreover, the surfactant can be added in a form of dispersion of fine particles having a diameter of not more than 1 μm in water of an organic solvent by a dispersing means such as a sand mill, a jet mill, an ultrasonic dispersing machine and a homogenizer. The dispersing can be carried out according to various known dispersing methods. The fluorinated surfactant represented by Formula A-13 is preferably added to the outermost protective layer.

The adding amount of the fluorinated surfactant represented by Formula A-13 is preferably from 1×10⁻⁸ to 1×10⁻¹ moles, particularly preferably from 1×10⁻⁵ to 1×10⁻² moles, per square meter. When the amount is less than the foregoing, suitable static electrification property cannot be obtained, and when the amount exceeds the foregoing amount, the moisture dependency of the light-sensitive material is increased and the storage ability under high moisture is degraded.

In the thermally developable light-sensitive material according to the invention, it is preferable that he ratio of Lb/Le is from 1.5 to 10 when the average diameter of the matting agent contained in the outermost layer of the image forming layer is Le in μm and the average diameter of the matting agent contained μm the outermost layer of the back coat layer. The unevenness of the thermally developed image density can be improved by making the ration within the above-mentioned range.

In the invention, it is preferable that organic or inorganic powder is added as the matting agent to the surface layer of the image forming layer side and that of the opposite side when a non-light sensitive layer is provided on the opposite side to control the roughness of the surface according to the object of the invention. As the powder employed in the invention, powder having a Moh's hardness of not less than 5 is preferred. Known inorganic and organic powder can be optionally employed. Examples of the inorganic powder include powder of titanium oxide, barium sulfate, boron nitride, SnO₂, SiO₂, Cr₂O₃, α-Al₂O₃, α-Fe₂O₃, α-FeOOH, cellium oxide, corundum, artificial diamond, garnet, mica, silica rock, silicon nitride and silicon carbide. Examples of the organic power include powder of poly(methyl acrylate), polystyrene, and Teflon. Of these, the inorganic powder such as SiO₂, titanium oxide, barium sulfate, α-Al₂O₃, α-Fe₂O₃, α-FeOOH, Cr₂O₃ and mica is preferable. SiO₂ and α-Al₂O₃ are more preferable and SiO₂ is particularly preferred.

In the invention, the powder is preferably subjected to a surface treatment by a Si compound and/or an Al compound. The surface condition of the outermost layer can be improved by the use of such the surface treated powder. As to the content of the Si and/or Al, the content of Si is preferably from 0.1 to 10%, more preferably from 0.1 to 5%, particularly preferably from 0.1 to 2%, by weight and that of Al is preferably from 0.1 to 1%, more preferably from 0.1 to 5%, particularly preferably from 0.1 to 2%, by weight. The weight ratio of Si to Al is preferably Si<Al. The surface treatment can be carried out by the method described in Japanese Patent Publication Open to Public Inspection No. 2-83219. In the invention, the average diameter of the powder is defined by the average diameter in the case of spherical particle powder, by the average length of the major axis in the case of acicular particle powder and by the average length of the longest diagonal line of the planar face in the case of planar particle powder, which are easily determined by measuring by an electron microscope.

The average particle diameter of the organic or inorganic powder is preferably from 0.5 to 10 μm, more preferably from 1.0 to 8.0 μm.

The average particle diameter of the organic or inorganic powder to be contained in the outermost layer of the light-sensitive layer side is usually from 0.5 to 8.0 μm, preferably from 1.0 to 6.0 μm, more preferably from 2.0 to 5.0 μm. The adding amount is usually from 1.0 to 20%, preferably from 2.0 to 15%, more preferably from 3.0 to 10%, by weight of the amount of the binder, including the amount of the hardening agent, employed in the outermost layer. The average diameter of the organic or inorganic powder to be contained in the outermost layer on the side opposite to the light-sensitive layer is usually from 2.0 to 15.0 μm, preferably from 3.0 to 12.0 μm, more preferably from 4.0 to 10.0 μm. The adding amount is usually from 0.2 to 10%, preferably from 0.4 to 7%, more preferably from 0.6 to 5%, by weight of the amount of the binder employed in the outermost layer.

The variation coefficient of the particle size distribution is preferably not more than 50%, more preferably not more than 40%, and particularly preferably not more than 30%.

The variation coefficient of the particle size distribution is defined by the following equation.

{(Standard deviation of particle diameter)/(Average particle diameter)}×100

The organic or inorganic powder may be added by coating the coating liquid in which the powder is previously dispersed or by spraying the powder onto the coated liquid layer before drying the layer. When plural kinds of the powder are added, both of the above methods may be applied.

Listed as materials of the support employed in the thermally developable light-sensitive material according to the invention are various kinds of polymers, glass, wool fabric, cotton fabric, paper, and metal such as aluminum. From the viewpoint of handling as information recording materials, flexible materials, which can be employed as a sheet or can be wound in a roll, are suitable. Accordingly, preferred as supports in the thermally developable light-sensitive material of the invention are plastic films such as cellulose acetate film, polyester film, poly(ethylene terephthalate) film, poly(ethylene naphthalate) film, polyamide film, polyimide film, cellulose triacetate film or polycarbonate film. Of these, in the present invention, biaxially stretched poly(ethylene terephthalate) film is particularly preferred. The thickness of the supports is commonly from about 50 to about 300 μm, and is preferably from 70 to 180 μm.

In the invention, in order to minimize static-charge buildup, electrically conductive compounds such as metal oxides and/or electrically conductive polymers may be incorporated in composition layers. These compounds may be incorporated in any layer, but are preferably incorporated in a subbing layer, a backing layer, and an interlayer between the light-sensitive layer and the subbing layer. In the invention, preferably employed are electrically conductive compounds described in columns 14 through 20 of U.S. Pat. No. 5,244,773.

In the invention, it is preferable to contain the electroconductive metal oxide in the outermost protective layer of the backing side. It is found that the effects of the invention, particularly the conveying suitability on the occasion of the thermal development, can be enhanced by such the method. The electroconductive metal oxide is a crystalline metal oxide particle and one containing an oxygen defect; and one containing a small amount of hetero atom being a donor to the metal oxide are particularly preferred since such the metal oxide are commonly show high electro conductivity. The later is specifically preferred because it does not cause fogging of the silver halide emulsion. Preferable examples of the metal oxide include ZnO, TiO₂, SnO₂, Al₂O₃, In₂O₃, SiO₂, MgO, BaO, MoO₃, V₂O₅, and composite oxides thereof; and ZnO, TiO₂ and SnO₂ are particularly preferred. As the examples of metal oxide containing the hetero atom, addition of Al or In to ZnO, Sb, Nb, P or a halogen element to SnO₂, and Nb or Ta to TiO₂ are effective. The adding amount of such the hetero atoms is preferably from 0.01 to 30 mole-percent, and particularly preferably from 0.1 to 10 mole-percent. A silicon compound may be added on the occasion of the preparation of the fine particle of the metal oxide for improving the dispersibility and transparency of the metal oxide powder. The metal oxide mini particle has electro conductivity, and the volume resistively is not more than 10⁷ Ωcm, particularly not more than 10⁵ Ωcm. Such the metal oxides are described in Japanese Patent Publication Open to Public Inspection Nos. 56-143431, 56-120519 and 58-62647. Moreover, the electro conductive materials described in Japanese Patent Examined Publication No. 59-6235 may be employed, which is prepared by affixing the aforesaid metal oxide to a crystalline metal oxide particle or fiber-shaped substance such as titanium oxide.

The size of the applicable particle is preferably not more than 1 μm. When the size is not more than 0.5 μm, the particle can be easily used since it has high stability after dispersion is high. The use of the electro conductive particle having the size of not more than 0.3 μm for minimizing the light scattering is preferred since the transparent light-sensitive material can be produced. When the electro conductive metal oxide has acicular or fiber shape, a length of not more than 30 μm and a diameter of not more than 1 μm are preferable and a length of not more than 10 μm and a diameter of not more than 0.3 μm are particularly preferred. As the TiO₂, SNS-10M, SN-10OP, SN-100D and FSS-10M soled by Ishihara Sangyo Co., Ltd., are usable.

The thermally developable light-sensitive material according to the invention comprises a support and at least one light-sensitive image forming layer provided on the support. It is preferable to provide at least one light insensitive layer over the image forming layer even though the image forming layer may be only formed on the support. For instance, a protective layer is preferably provided on the image forming layer for protecting the image forming layer. A backing layer is provided on the opposite surface of the support to prevent surface sticking occurred between the sheets or in the roll of the thermally developable light-sensitive material. As the binder to be used in the protective layer and the backing layer, a polymer having a glass transition point higher than that of the image forming layer and high resistively to scratch and deformation such as cellulose acetate and cellulose acetate-butyrate is selected from the aforesaid binders.

It is allowed for controlling the gradation to provide two or more image forming layers on one side of the support or one or more image forming layers on the both sides of the support.

In the thermally developable light-sensitive material of the present invention, in order to control the light amount as well as the wavelength distribution of light which transmits the light-sensitive layer, it is preferable that a filter layer is formed on the light-sensitive layer side or on the opposite side, or dyes or pigments are incorporated in the light-sensitive layer.

Employed as dyes may be compounds, known in the art, which absorb various wavelength regions according to the spectral sensitivity of light-sensitive materials.

For example, when the thermally developable light-sensitive material of the invention is used as an image recording material utilizing infrared radiation, it is preferable to employ squarylium dyes having a thiopyrylium nucleus, hereinafter referred to as thiopyriliumsquarylium dyes, and squarylium dyes having a pyrylium nucleus, hereinafter referred to as pyryliumsquarylium dyes, as described in Japanese Patent Publication Open to Public Inspection No. 2001-83655, and thiopyryliumcroconium dyes or pyryliumcroconium dyes which are analogous to the squarylium dyes.

Incidentally, the compounds having a squarylium nucleus, as described herein, refers to ones having 1-cyclobutene-2-hydroxy-4-one in their molecular structure. Herein, the hydroxyl group may be dissociated. Hereinafter, all of these dyes are referred to as squarylium dyes. Further, preferably employed as the dyes are compounds described in Japanese Patent Publication Open to Public Inspection No. 8-201959.

It is preferable to prepare the thermally developable light-sensitive material of the invention as follows. Materials of each constitution layer as above are dissolved or dispersed in solvents to prepare coating compositions. Resultant coating compositions are subjected to simultaneous multilayer coating and subsequently, the resultant coating is subjected to a thermal treatment. “Simultaneous multilayer coating”, as described herein, refers to the following. The coating composition of each constitution layer, for example, a light-sensitive layer and a protective layer is prepared. When the resultant coating compositions are applied onto a support, the coating compositions are not applied onto a support in such a manner that they are individually applied and subsequently dried, and the operation is repeated, but are simultaneously applied onto a support and subsequently dried. Namely, before the residual amount of the total solvents of the lower layer reaches 70 percent by weight, the upper layer is applied.

Simultaneous multilayer coating methods, which are applied to each constitution layer, are not particularly limited. For example, are employed methods, known in the art, such as a bar coater method, a curtain coating method, a dipping method, an air knife method, a hopper coating method, and an extrusion method. Of these, more preferred is the pre-weighing type coating system called as an extrusion coating method. The extrusion coating method is suitable for accurate coating as well as organic solvent coating because volatilization on a slide surface, which occurs in a slide coating system, does not occur. Coating methods have been described for coating layers on the light-sensitive layer side. However, the backing layer and the subbing layer are applied onto a support in the same manner as above. As to the simultaneous coating of the thermally developable light-sensitive material, there is detailed description in Japanese Patent Publication Open to Public Inspection No. 2000-15173.

Incidentally, in the present invention, it is preferable that the silver coverage is suitably determined depending on the use purpose of thermally developable light-sensitive materials. When employed for preparing medical images, the silver coverage is preferably from 0.3 to 1.5 g/m², and is more preferably from 0.5 to 1.5 g/m². The silver coverage, derived from silver halide, is preferably from 2 to 18 percent with respect to the total silver weight, and is more preferably from 5 to 15 percent.

Further, in the present invention, the number of coated silver halide grains, having a grain diameter, being a sphere equivalent grain diameter, of at least 0.01 μm, is preferably from 1×10¹⁴ to 1×10¹⁸ grains/m², and is more preferably from 1×10¹⁵ to 1×10¹⁷ grains/m².

Further, the coated weight of the organic silver salt of the invention is from 10⁻¹⁷ to 10⁻¹⁵ g per silver halide grain having a diameter, being a sphere equivalent grain diameter) of at least 0.01 μm, and is more preferably from 10⁻¹⁶ to 10⁻¹⁴ g.

When coating is carried out under conditions within the range, from the viewpoint of maximum optical silver image density per definite silver coverage, namely covering power as well as silver image tone, desired results are obtained.

In the invention, it is preferable that the thermally developable light-sensitive material contains a solvent in an amount of from 5 to 1,000 mg per square meter, and is more preferably to control so that the amount of the solvent is with in the range of from 100 to 500 mg per square meter. The thermally developable light-sensitive material having high sensitivity, low fog and high maximum density can be obtained by such controlling.

Examples of the solvent include ketones such as acetone, methyl ethyl ketone and isophorone; alcohols such as methanol, ethanol, t-propanol, cyclohexanol and benzyl alcohol; glycols such as ethylene glycol, diethylene glycol, triethylene glycol, propylene glycol and hexylene glycol; ether alcohols such as ethylene glycol monomethyl ether and diethylene glycol monoethyl ether; ethers such as i-propyl ether; esters such as ethyl acetate and butyl acetate; chloride compounds such as methylene chloride and dichlorobenzene; and hydrocarbon compounds. Other than the above, water, formamide, dimethylformamide, toluidine, tetrahydrofuran and acetic acid are usable. These solvent may be used singly or in combination of some kinds thereof.

The content of the solvent in the thermally developable light-sensitive material can be controlled by changing the temperature condition in the drying process after the coating process. The content of the solvent can be measured by gas chromatography under a condition suitable for detecting the contained solvent.

When the thermally developable light-sensitive material according to the invention is stored, it is preferable that the light-sensitive material is closed in a package to prevent the changing of density and occurrence of fogging during the storing period. The space ratio in the package is preferably from 0.01 to 10%, and more preferably from 0.02 to 5%. Nitrogen gas is preferably enclosed in the package so that the partial pressure of the nitrogen is not less than 80%, more preferably not less than 90%.

For the thermally developable light-sensitive material, laser light is usually employed on the occasion of the image recording. When the thermally developable material of the invention is exposed, it is preferable to employ an optimal light source for the spectral sensitivity provided to the light-sensitive material. For example, when the light-sensitive material is sensitive to infrared radiation, it is possible to use any radiation source which emits radiation in the infrared region. However, infrared semiconductor lasers, at 780 nm and 820 nm, are preferably employed due to their high power, as well as ability to make light-sensitive materials transparent.

In the invention, it is preferable that exposure is carried out utilizing laser scanning. Employed as the exposure methods are various ones. For example, listed as a firstly preferable method is the method utilizing a laser scanning exposure apparatus in which the angle between the scanning surface of a light-sensitive material and the scanning laser beam does not substantially become vertical.

“Does not substantially become vertical”, as described herein, means that during laser scanning, the nearest vertical angle is preferably from 55 to 88 degrees, is more preferably from 60 to 86 degrees, and is most preferably from 70 to 82 degrees.

When the laser beam scans light-sensitive materials, the beam spot diameter on the exposed surface of the light-sensitive material is preferably at most 200 μm, and is more preferably at most 100 mm, and is more preferably at most 100 μm. It is preferable to decrease the spot diameter due to the fact that it is possible to decrease the deviated angle from the verticality of laser beam incident angle. Incidentally, the lower limit of the laser beam spot diameter is 10 μm. By performing the laser beam scanning exposure, it is possible to minimize degradation of image quality according to reflection light such as generation of unevenness analogous to interference fringes.

Further, as the second method, exposure in the present invention is also preferably carried out employing a laser scanning exposure apparatus which generates a scanning laser beam in a longitudinal multiple scanning, which minimizes degradation of image quality such as generation of unevenness analogous to interference fringes, compared to the scanning laser beam in a longitudinal single mode.

The longitudinal multiple scanning is achieved utilizing methods in which return light due to integrated wave is employed, or high frequency superposition is applied. The longitudinal multiple scanning, as described herein, means that the wavelength of radiation employed for exposure is not single. The wavelength distribution of the radiation is commonly at least 5 nm, and is preferably at least 10 nm. The upper limit of the wavelength of the radiation is not particularly limited, but is commonly about 60 nm.

Further, as the third embodiment, it is also preferable to form the image using two or more laser light beams.

The image recording method applying plural laser light beams is the technique used in the writing means in a laser printer of a digital copying machine by which plural lines of the image are written by once scanning for satisfying the requirements of high resolution and high speed. Such the technique is disclosed in Japanese Patent Publication Open to Public Inspection No. 60-166916. In this method, laser light beams emitted from light source units are modulated and applied for scanning and focused on a photoreceptor through a fθ lens. It is a laser scanning apparatus principally the same as a laser imager.

The focusing of the laser light beams on the photoreceptor in the image writing means of the laser printer and the digital copying machine is controlled so that one of the beams is focused at the position shifted for one line from the position of another beam to suit the use that the plural lines are written by once scanning. In concrete, the two light beams are neared with together by a space of several tens micrometers in the subscanning direction, and the pitch of the two light beams in the subscanning direction is 63.5 μm at the printing density of 400 dpi and 42.3 μm at the printing density of 600 dpi, in which dpi is the number of dot per inch or 2.54 cm. In the invention, it is preferable that the two or more laser beams are each focused at a angle different from each other to form the image. On this occasion, it is preferable that the relation of 0.9×E≦Eₙ×N≦1.1×E is satisfied in which E is the exposure energy at the exposing surface when the writing is performed by ordinary on laser beam with wavelength of λ in nm, and N beams to be applied to the exposure are each the same in the wavelength λ in nm and in the exposure energy Eₙ. By such the setting, the reflection of each of the laser light beams to the image forming layer is reduced since the exposure energy of the laser beam is lowered and occurrence of the interference fringes can be inhibited even though the energy at the exposure surface is maintained.

In the above-mentioned, the wavelength of each of the plural laser light beams is the same, however, the beams each different in the wavelength may be used. In such the case the wavelength is preferably set within the range of (λ−30)<λ₁, λ₂, . . . λₙ≦(λ+30).

Incidentally, in the first, second and third embodiments as noted above, it is possible to suitably select any of the following lasers, which are generally well known, while matching the use. The lasers include solid lasers such as a ruby laser, a YAG laser, and a glass laser; gas lasers such as a HeNe laser, an Ar ion laser, a Kr ion laser, a CO₂ laser a CO laser, a HeCd laser, an N₂ laser, and an excimer laser; semiconductor lasers such as an InGaP laser, an AlGaAs laser, a GaASP laser, an InGaAs laser, an InAsP laser, a CdSnP₂ laser, and a GaSb laser; chemical lasers; and dye lasers. Of these, from the viewpoint of maintenance as well as the size of light sources, it is preferable to employ any of the semiconductor lasers having a wavelength of 600 to 1,200 nm. Incidentally, the beam spot diameter of lasers employed in laser imagers, as well as laser image setters, is commonly in the range of 5 to 75 μm in terms of a short axis diameter and in the range of 5 to 100 μm in terms of a long axis diameter. Further, it is possible to set a laser beam scanning rate at the optimal value for each light-sensitive material depending on the inherent sensitivity of the thermally developable light-sensitive material at laser transmitting wavelength and the laser power.

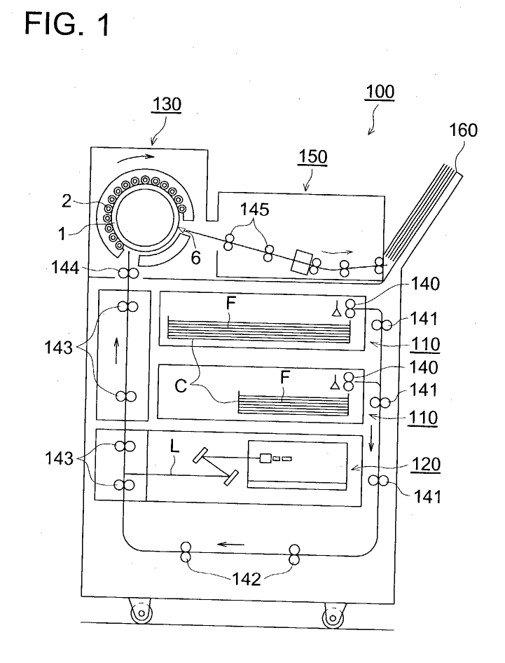

The thermal development apparatus is constituted by a film supplying means such as a film tray, a laser image recording means, a thermally developing means by which heat is uniformly and stably applied to the whole surface of the thermally developable light-sensitive material, and a conveying means by which the light-sensitive material is conveyed from the film supplying means through the laser image recording process and the thermally developing process to form the image and output from the apparatus. Concrete example of such the embodiment is shown in FIG. 1.

The development apparatus 100 has a supplying device 110 for conveying the sheet of thermally developable light-sensitive material one by one, hereinafter referred to as a thermographic element of a film, Exposing device 120 for exposing the supplied film F, a developing device 130 for developing the film F, cooling zone 150 and a stacker 160. The apparatus 100 further has a pair of conveying roller 140 for supplying the film F from the supplying device, a pair of conveying roller 144 for conveying the film F to the developing device, and plural conveying roller pairs 141, 142, 143 and 145 for smoothly conveying the film F between each processing portions. The developing device is constituted by a heating drum 1 and a plurality of counter roller 2 which are arranged on the circumference of the heating drum so as to almost contacted with the heating drum as the means for heating the film F and a separation claw 6 for separating the developed film F from the heating drum 1 and conveying to the cooling zone.

The conveying speed of the thermally developable light-sensitive material is preferably from 10 to 200 mm per second.

In the invention, development conditions vary depending on employed devices and apparatuses, or means. Typically, an imagewise exposed thermally developable light-sensitive material is heated at optimal high temperature. It is possible to develop a latent image formed by exposure by heating the material at intermediate temperature, for example, from about 80 to about 200° C., preferably from about 100° C. to about 200° C., more preferably from 110 to 140° C., for a sufficient period, commonly from about 1 second to about 2 minutes, preferably 5 to 20 seconds.

When heating temperature is less than 80° C., it is difficult to obtain sufficient image density within a relatively short period. On the other hand, at more than 200° C., binders melt so as to be transferred to rollers, and adverse effects result not only for images but also for transportability as well as processing devices. Upon heating the material, silver images are formed through an oxidation-reduction reaction between the organic silver salts, which function as an oxidizing agent, and the reducing agents. The reaction proceeds without any supply of processing solutions such as water from the exterior.

Heating may be carried out employing typical heating means such as hot plates, irons, hot rollers and heat generators employing carbon and white titanium. When the protective layer-provided thermally developable light-sensitive material of the present invention is heated, from the viewpoint of uniform heating, heating efficiency, and workability, it is preferable that heating is carried out while the surface of the side provided with the protective layer comes into contact with a heating means, and thermal development is carried out during the transport of the material while the surface comes into contact with the heating rollers.

### EXAMPLES

The invention is described in detail below referring examples but the embodiment of the invention is not limited to the examples.

### Example 1

<Preparation of Subbed Photographic Support>

Both sides of a PET film having a thickness of 175 μm, which is blue tinted by a blue dye so as to have an optical density of 0.17 measured by Densitometer PDA-65, manufactured by Konica Corp., and biaxially stretched and fixed, were subjected to a corona discharge treatment of 8 W/m² per minute. The following subbing layer coating liquid a-1 was coated on one side of the film so that the dried layer thickness was 0.8 μm and dried for forming a subbing layer A-1. A subbing layer coating liquid b-1 was coated on the opposite side of the film so that the dried layer thickness was 0.8 μm and dried for forming a subbing layer B-1.

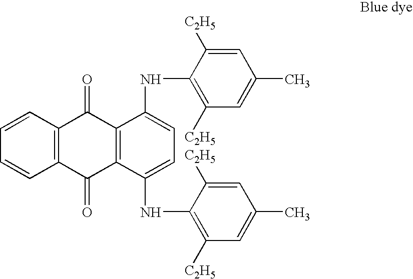

<Subbing coating liquid a-1>

| | | |
|---|---|---|
| Latex of copolymer of butyl acrylate (30 weight-%)/t- | 270 | g |
| butyl acrylate (20 weight-%)/styrene (25 weight-%)/2- | | |
| hydroxyethyl acrylate (25 weight-%), solid component | | |
| content of 30% | | |
| C-1 | 0.6 | g |
| Hexamethylne-1,6-bis(ethyleneurea) | 0.3 | g |
| Water to make | 1 | l |

<Subbing coating liquid b-1>

| | | |
|---|---|---|
| Latex of copolymer of butyl acrylate (40 weight- | 270 | g |
| %)/ethylene (20 weight-%)/cresyl acrylate (40 weight-%), | | |
| solid component content of 30% | | |
| C-1 | 0.6 | g |
| Hexamethylne-1,6-bis(ethyleneurea) | 0.8 | g |
| Water to make | 1 | l |

Thereafter, 8 W/m² per minute of corona discharge were applied onto both of the subbing layers A-1 and B-1 and then the following upper subbing layer coating liquid a-2 was coated on the subbing layer A-1 so that the dried thickness was 0.1 μm to form an upper subbing layer A-2, and the following upper subbing layer coating liquid b-2 was coated on the upper subbing layer B-1 so that the dried thickness was 0.4 μm to form an upper subbing layer B-2 having an antistatic function.

<Upper subbing layer coating liquid a-2>

| | | |
|---|---|---|
| Gelatin in an amount for making the coating amount of | 0.4 | g/m² |
| C-1 | 0.2 | g |
| C-2 | 0.2 | g |
| C-3 | 0.1 | g |
| Silica particle, average diameter: 3 μm | 0.1 | g |
| Water to male | 1 | l |

<Upper subbing layer coating liquid b-2>

| | | |
|---|---|---|
| Sb doped SnO₂ SNS10M (Ishihara Sangyo Co., Ltd.) | 60 | g |
| Latex of C-4, solid component content: 20% | 80 | g |
| Ammonium sulfate | 0.5 | g |
| C-5 | 12 | g |
| Polyethylene glycol, weight average molecular weight: 600 | 6 | g |
| Water to make | 1 | l |

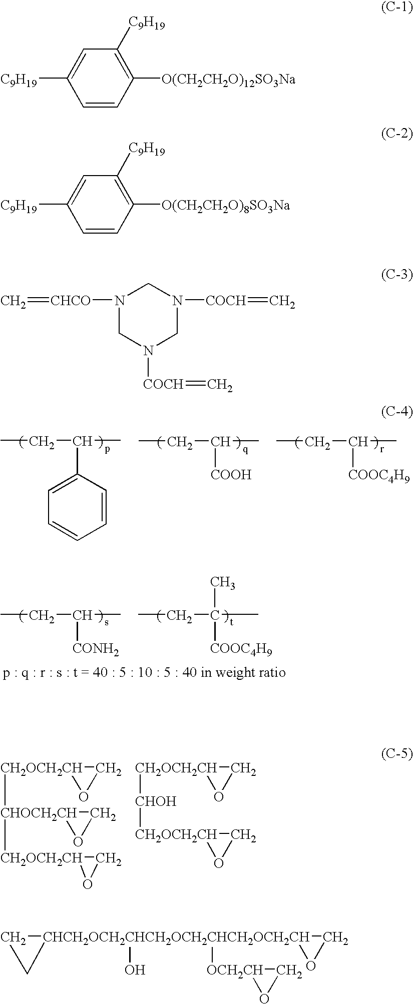

Mixture of the above three chemicals

<Preparation of Back Coat Layer Coating Liquid>

While stirring, added to 830 g of methyl ethyl ketone (MEK) were 84.2 g of cellulose acetate butyrate CAB381-20 of Eastman Chemical Co., and 4.5 g of a polyester resin Vitel PE2200B of Bostic Co.), and dissolved. Subsequently, 0.30 g of Infrared Dye 1 was added to the resultant solution and further, 4.5 g of a fluorinated surfactant Surfron KH40 of Asahi Glass Co., dissolved in 43.2 g of methanol and 2.3 g of a fluorinated surfactant Megafag F120K of Dainippon Ink Co., were added. Subsequently, the resultant mixture was well stirred until added compounds were completely dissolved. Finally, 75 g of silica Siloid 64×6000 of W. R. Grace Co., which was dispersed in methyl ethyl ketone at a concentration of 1 percent by weight, employing a dissolver type homogenizer, was added while stirring, whereby a coating liquid of back coating layer was prepared.

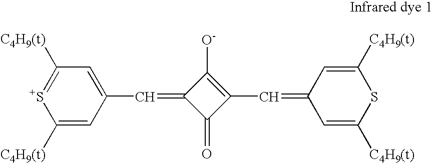

<Preparation of back coat protective layer (surface
protective layer) coating liquid>

| | | |
|---|---|---|
| Cellulose acetate butyrate, 10% methyl ketone solution | 15 | g |
| Monodispersed silica with a monodispersity of 15%, | 0.03 | g |
| average particle size: 8 μm (surface treated by 1% by | | |
| weight of whole silica of aluminum) | | |
| C₈F₁₇(CH₂CH₂O)₁₂C₈F₁₇ | 0.05 | g |
| Fluorinated surfactant SF-3 | 0.01 | g |
| Stearic acid | 0.1 | g |
| Oleyl oleate | 0.1 | g |
| α-alumina, Moh's hardness: 9 | 0.1 | g |

<Preparation of Light-Sensitive Silver Halide Emulsion A>

| (A1) | | |
|---|---|---|
| Phenylcarbamoyl gelatin | 88.3 | g |
| Compound A, 10% methanol solution | 10 | ml |
| Potassium bromide | 0.32 | g |
| Water to make | 5429 | ml |
| (B1) | | |
| 0.67 mole/l silver nitrate aqueous solution | 2635 | ml |
| (C1) | | |
| Potassium bromide | 51.55 | g |
| Potassium iodide | 1.47 | g |
| Water to make | 660 | ml |
| (D1) | | |
| Potassium bromide | 154.9 | g |
| Potassium iodide | 4.41 | g |
| Iridium chloride, 1% solution | 0.93 | ml |
| Water to make | 1982 | ml |
| (E1) | | |
| 0.4 mole/l potassium bromide aqueous solution | | |
| an amount necessary to maintain the following silver | | |
| electrode potential | | |
| (F1) | | |
| Potassium hydroxide | 0.71 | g |
| Water to make | 20 | ml |
| (G1) | | |
| Acetic acid, 56% solution | 18.0 | ml |
| (H1) | | |
| Sodium carbonate anhydrate | 1.72 | g |
| Water to make | 151 | ml |

Compound A: HO(CH₂CH₂O)ₙ(CH(CH₃)CH₂O)₁₇(CH₂CH₂O)ₘH
(m + N = 5 through 7)

Upon employing a mixing stirrer shown in Japanese Patent Publication Nos. 58-58288 and 58-58289, ¼ portion of (B1) and whole (C1) were added to (A1) over 4 minutes 45 seconds, employing a double-jet precipitation method while adjusting the temperature to 20° C. and the pAg to 8.09, whereby nuclei were formed. After one minute, whole (F1) was added. During the addition, the pAg was appropriately adjusted employing Solution (E1). After 6 minutes, ¾ portion of Solution (B1) and whole (D1) were added over 14 minutes 15 seconds employing a double-jet precipitation method while adjusting the temperature to 20° C. and the pAg to 8.09. After stirring for 5 minutes, the mixture was cooled to 40° C., and whole (G1) was added, whereby a silver halide emulsion was flocculated. Subsequently, while leaving 2000 ml of the flocculated portion, the supernatant was removed, and 10 l of water was added. After stirring, the silver halide emulsion was again flocculated. While leaving 1,500 ml of the flocculated portion, the supernatant was removed. Further, 10 L of water was added. After stirring, the silver halide emulsion was flocculated. While leaving 1,500 ml of the flocculated portion, the supernatant was removed. Subsequently, (H1) was added and the resultant mixture was heated to 60° C., and then stirred for an additional 120 minutes. Finally, the pH was adjusted to 5.8 and water was added so that the weight was adjusted to 1,161 g per mol of silver, whereby Emulsion A was prepared.

The prepared emulsion was comprised of monodispersed cubic silver iodobromide grains having an average grain size of 25 nm, a grain size variation coefficient of 12 percent and a [100] plane ratio of 92 percent.

<Preparation of Light-Sensitive Silver Halide Emulsion B>

Light-Sensitive Silver Halide Emulsion B was prepared in the same manner as in Light-Sensitive Silver Halide Emulsion A except that the temperature on the occasion of the double-jet addition of the solutions was changed to 40° C. The prepared emulsion was comprised of monodispersed cubic silver iodobromide grains having an average grain size of 50 nm, a grain size variation coefficient of 12 percent and a [100] plane ratio of 92 percent.

<Preparation of Powdered organic Silver Salt A>

Dissolved in 4,720 ml of pure water were 130.8 g of behenic acid, 67.7 g of arachidic acid, 43.6 g of stearic acid, and 2.3 g of palmitic acid at 80° C. Subsequently, 540.2 ml of a 1.5 moles/l aqueous sodium hydroxide solution was added, and further, 6.9 ml of concentrated nitric acid was added. Thereafter, the resultant mixture was cooled to 55° C., whereby an aliphatic acid sodium salt solution was prepared. While heating the aliphatic acid sodium salt solution at 55° C., 45.3 g of the aforesaid Light-Sensitive Silver Halide Emulsion B as well as 450 ml of pure water was added and stirred for 5 minutes.

Subsequently, 468.4 ml of one mole silver nitrate solution was added over two minutes and stirred for 10 minutes, whereby an aliphatic carboxylic acid silver salt dispersion was prepared. Thereafter, the resultant aliphatic carboxylic acid silver salt dispersion was transferred to a water washing machine, and deionized water was added. After stirring, the resultant dispersion was set aside, whereby a flocculated aliphatic carboxylic acid silver salt was allowed to float and was separated, and the lower portion, containing water-soluble salts, were removed. Thereafter, washing was repeated employing deionized water until electric conductivity of the resultant effluent reached 2 μS/cm. After centrifugal dehydration, the resultant cake-shaped aliphatic carboxylic acid silver salt was dried employing an gas flow type dryer Flush Jet Dryer, manufactured by Seishin Kikaku Co., Ltd., while setting the drying conditions such as nitrogen gas as well as heating flow temperature at the inlet of the dryer, until its water content ratio reached 0.1 percent, whereby Powdered Organic Silver Salt A was prepared.

The water content ratio of the organic silver salt composition was determined employing an infrared moisture meter.

<Preparation of Preliminary Dispersion A>

As the binder of image forming layer, 14.57 g of polyvinyl butyral containing 0.2 millimoles/g of —SO₃K group having a Tg of 75° C. was dissolved in 1457 g of methyl ethyl ketone. While stirring, employing Dissolver DISPERMAT Type CA-40M, manufactured by VMA-Getzmann Co., 500 g of Powdered Organic Silver Salt A was gradually added and sufficiently mixed, whereby Preliminary Dispersion A was prepared.

<Preparation of Light-Sensitive Emulsion Dispersion 1>

Preliminary Dispersion A was charged into a media type homogenizer DISPERMAT Type SL-C12EX, manufactured by VMA-Getzmann Co., filled with 0.5 mm diameter zirconia beads so as to occupy 80 percent of the interior volume so that the retention time in the mill reached 1.5 minutes and was dispersed at a peripheral rate of the mill of 8 m/s, whereby Light-Sensitive Emulsion Dispersion 1 was prepared.

<Preparation of Stabilizer Solution>

Stabilizer Solution was prepared by dissolving 1.0 g of Stabilizer 1 and 0.31 g of potassium acetate in 4.97 g of methanol.

<Preparation of Infrared Sensitizing Dye A Solution>

Infrared Sensitizing Dye A Solution was prepared by dissolving 19.2 mg of Infrared Sensitizing Dye 1, 1.488 g of 2-chloro-benzoic acid, 2.779 g of Stabilizer 2, and 365 mg of 5-methyl-2-mercaptobenzimidazole in 31.3 ml of MEK in a light-shielded room.

<Preparation of Additive Solution “a”>

Additive Solution “a” was prepared by dissolving the reducing agent according to the kind and the amount described in Tables 1 through 3, a compound represented by Formula A-4 according to the kind and the amount described in Tables 1 through 3, 1.54 g of 4-methylphthalic acid, and 0.48 g of the aforesaid Infrared Dye 1 in 110 g of MEK.

<Preparation of Additive Solution “b”>

Additive Solution “b” was prepared by dissolving 1.56 g of Antifoggant 2 and 3.43 g of phthalazine in 40.9 g of MEK.

<Preparation of Additive Solution “c”>

Additive Solution “c” was prepared by dissolving 0.5 g of Vinyl Compound Al in 39.5 g of MEK.

<Preparation of Additive Solution “d”>

Additive Solution “d” was prepared by dissolving 1 g of Supersensitizer 1 in 9 g of MEK.

<Preparation of Additive Solution “e”>

Additive Solution “e” was prepared by dissolving 1.0 g of Compound described in Tables 1 through 3 in 9.0 g of MEK. The numbers of compound e correspond to the numbers of the exemplified compounds described above.

<Preparation of Additive Solution “f”>

Additive Solution “f” was prepared by dissolving 1.0 g of Antifoggant containing vinylsulfon, Compound 21, in 9.0 g of MEK.

<Preparation of Additive Solution “g”>

Additive Solution “g” was prepared by dissolving 1.0 g of Compound represented by Formula A-10, Compound 19, in 9.0 g of MEK.

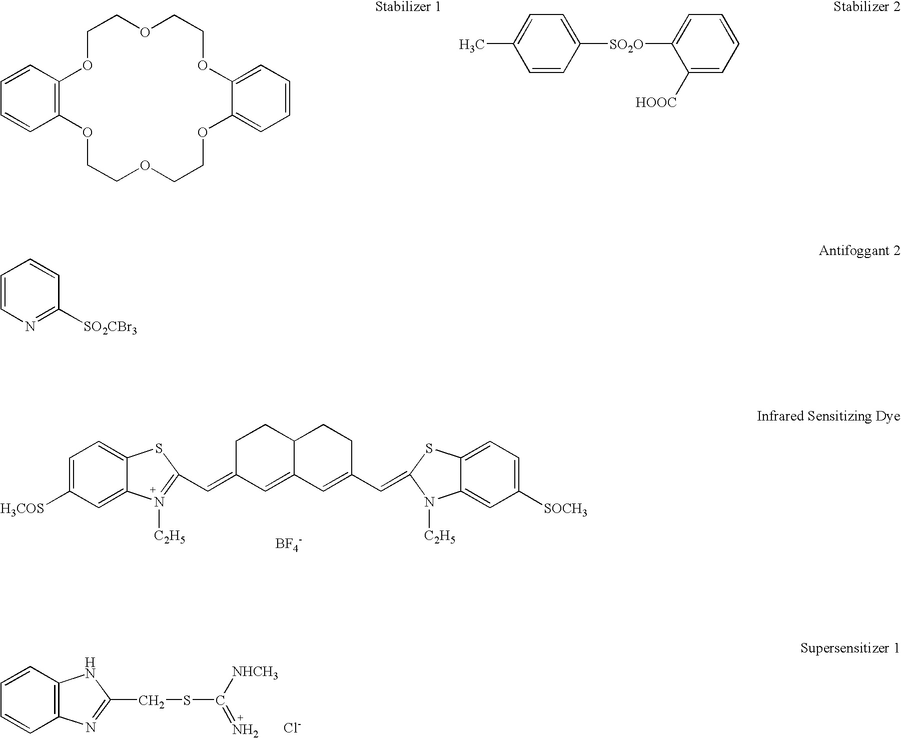

<Preparation of Image Forming Layer Coating Liquid>

While stirring under inactive atmosphere containing 97% nitrogen, 50 g of the aforesaid Light-Sensitive Emulsion Dispersion 1 and 15.11 g of MEK were mixed and the resultant mixture was kept at 21° C. Subsequently, 1,000 μl of 0.5% solution of Chemical Sensitizer S-5 was added and, after 2 minutes, 390 μl of Antifoggant 1 being a 10 percent methanol solution was added and stirred for one hour. Further, 494 μl of calcium bromide being a 10 percent methanol solution was added and stirred for 10 minutes and then Gold Sensitizer Au-5 in an amount corresponding to 1/20 moles of the foregoing organic chemical sensitizer. Subsequently, 167 ml of Stabilizer Solution was added and stirred for 10 minutes and then 1.32 g of forgoing Infrared Sensitizing Dye Solution A was added and stirred for 1 hour. Thereafter the resulting mixture was cooled to 13° C. and stirred for an additional 30 minutes. While marinating at 13° C., 6.4 g of Additive Solution “d”, 0.5 g of Additive Solution “e”, 0.5 g of Additive Solution “f”, 0.8 g of Additive Solution “g” and 13,31 g of the binder employed in Preliminary Dispersion A were added and stirred for 30 minutes. Thereafter, 1.084 g of tetrachlorophthalic acid being a 9.4 weight percent MEK solution was added and stirred for 15 minutes. Further, while stirring, 12.43 g of Additive Solution “a”, 1.6 ml of Desmodur N300/aliphatic isocyanate, manufactured by Mobay Chemical Co. being a 10 percent MEK solution, and 4.27 g of Additive Solution “b” and 4.0 g of Additive Solution “c” were successively added, whereby an image forming layer coating liquid was prepared.

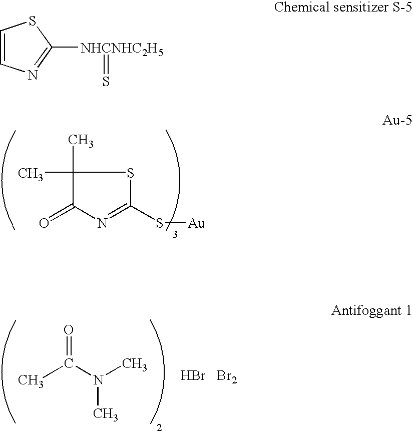

<Preparation of Lower protective Layer (Lower Surface
Protective layer) of Image Forming Layer>

| | | |
|---|---|---|
| Acetone | 5 | g |
| Methyl ethyl ketone | 21 | g |
| Cellulose acetate butyrate | 2.3 | g |
| Methanol | 7 | g |
| Phthalazine | 0.25 | g |
| Monodispersed silica with a monodispersity of 15%, | 0.140 | g |
| average particle size: 3 μm (surface treated by 1% by | | |
| weight of whole silica of aluminum) | | |
| CH₂═CHSO₂CH₂CH₂OCH₂CH₂SO₂CH═CH₂ | 0.035 | g |
| C₁₂F₂₅(CH₂CH₂O)₁₀C₁₂F₂₅ | 0.01 | g |
| Fluorinated surfactant SF-3 | 0.01 | g |
| Stearic acid | 0.1 | g |
| Butyl stearate | 0.1 | g |
| α-alumina, Moh's hardness: 9 | 0.1 | g |

<Preparation upper protective layer (upper surface protective
layer) of image forming layer>

| | | |
|---|---|---|
| Acetone | 5 | g |
| Methyl ethyl ketone | 21 | g |
| Cellulose acetate butyrate | 2.3 | g |
| Methanol | 7 | g |
| Phthalazine | 0.25 | g |
| Monodispersed silica with a monodispersity of 15%, | 0.140 | g |
| average particle size: 3 μm (surface treated by 1% by | | |
| weight of whole silica of aluminum) | | |
| CH₂═CHSO₂CH₂CH₂OCH₂CH₂SO₂CH═CH₂ | 0.035 | g |
| C₁₂F₂₅(CH₂CH₂O)₁₀C₁₂F₂₅ | 0.01 | g |
| Fluorinated surfactant SF-3 | 0.01 | g |
| Stearic acid | 0.1 | g |
| Butyl stearate | 0.1 | g |
| α-alumina, Moh's hardness: 9 | 0.1 | g |

<Preparation of Thermal Developable Light-Sensitive Material>

The back coat layer coating liquid and the back coat protective layer coating liquid were simultaneously coated on Upper Subbing Layer B-2 so that the dried thickness of each of the layers was 3.5 μm by extrusion coater with a coating speed of 50 m/min. The drying was carried out at 100° C. for 5 minutes using air having a dew point of 10° C.

Light-Sensitive Materials Nos. 1 through 15 shown in Tables 1 to 3 were prepared by simultaneously coating each of the above image forming layer coating liquids and the image forming layer protective layer coating liquid onto Upper Subbing layer A-2 by an extrusion coater with a coating speed of 50 m/minute. The coating was carried out so that the coating weight of silver of the image forming layer was 1,2 g/m² and the dried thickness of the image forming layer protective layer was 2.5 μm including the upper protective layer of 1.3 μm and the lower protective layer of 1.2 μm, and the drying was carried out at a drying temperature of 75° C. for 10 minutes employing air having a dew point of 10° C.

<Exposing and Developing Treatment>

Thus prepared Thermally Developable Light-Sensitive Material Nos. 1 to 15 were each cut into a size of (14×2.54) cm×(17×2.54) cm and treated by the following procedure employing the thermal developing apparatus shown in FIG. 1.

The thermally developable light-sensitive material was taken out from the film tray and conveyed to the exposing portion. And then the light-sensitive material was exposed to light generated by the laser light source by scanning.

Scanning exposure was given onto the image forming layer side surface of each sample prepared as above, employing an exposure device in which a semiconductor laser, which was subjected to longitudinal multiple scanning mode of a wavelength of 810 nm, employing high frequency superimposition, was employed as a laser beam source. The laser light beam was prepared by synthesizing of two beams each having the maximum output of 35 mW so the maximum out put was became to 70 mW. The angle of the laser light beam with the surface of the thermally developable light-sensitive material to be exposed was 75° C. Thereafter the thermally developable light-sensitive material was conveyed into the heat developing device so that the surface of the heating drum was contacted to the protective layer of the image forming layer side, and developed for 15 seconds at 125° C., and then output from the apparatus. The conveying speed of the light-sensitive material from the light-sensitive material supplying means to the image exposing portion, the conveying speed in the exposing portion and the in the heat developing portion were each 20 mm/second. The exposing and the development were carried out in a room conditioned to a temperature of 23° C. and a relative humidity of 50%.

Image Density

The optical density of the image obtained as above measured by a densitometer.

Determination of u*, v* and a*, b* in CIE 1976 color space

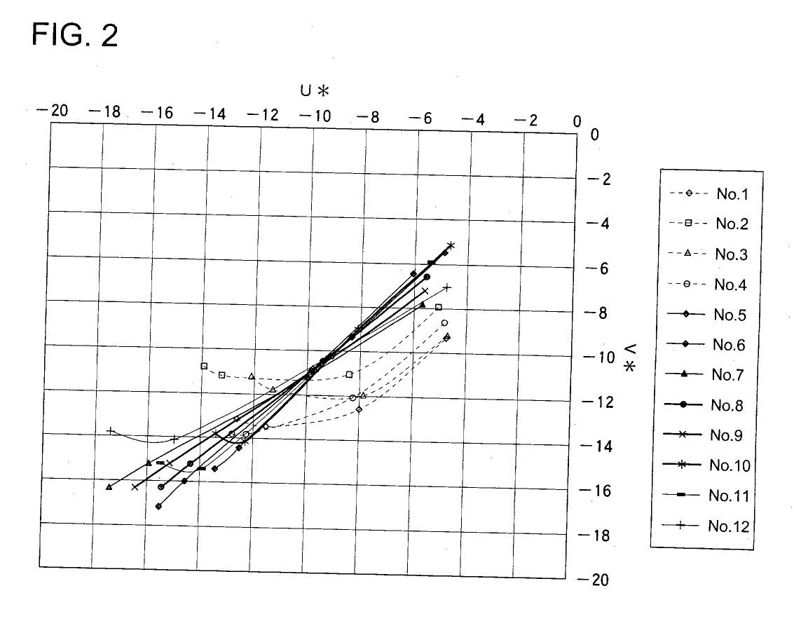

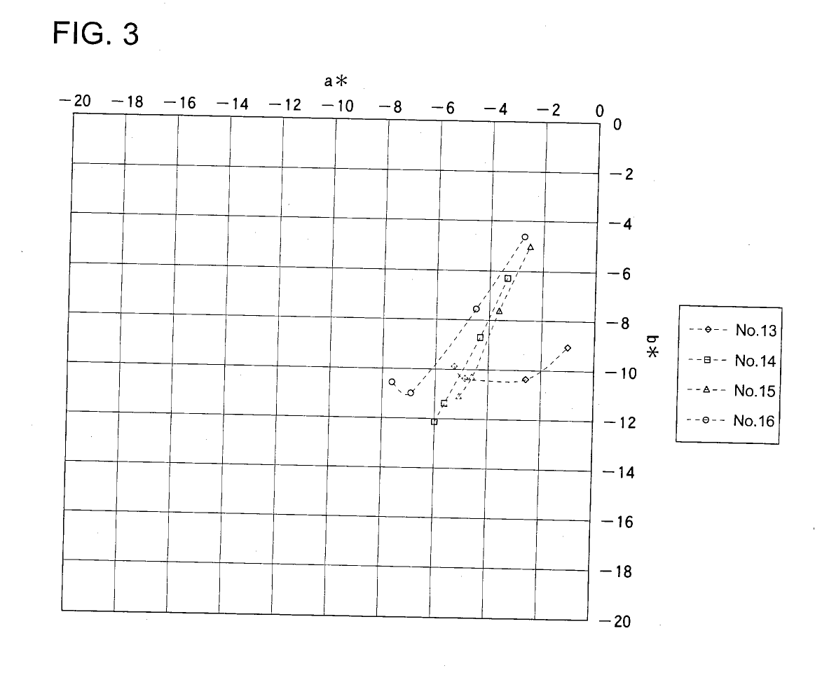

A four-step wedge sample including an unexposed area and areas each having density of 0.5, 1.0 and 1.5 was prepared by employing the thermal development apparatus shown in FIG. 1. The steps of the prepared sample were measured by CM-3600d manufactured by Minolta Co., Ltd. and u*, v* and a*, b* were calculated. The measurement was carried out in the transmission mode employing F7 light source and angle of field of vision of 10° C. The measured u*, v* or a*, b* were plotted on a graph in which u* or a* are set on the perpendicular axis and v* or b* are set on the lateral axis, and the regression line was determined and the coefficient of determination R², the ordinate intercept and the gradient of the regression line were calculated. The graph of the u*, v* is shown as FIG. 2, and the graph of a*, b* is shown as FIG. 3. The results of the tests are listed in Table 3.

Evaluation of Image Quality

On the samples according to the invention and the comparative samples, 30 simple chest image samples were output. The image density at the lunges field was controlled so as to be 1.7±0.02. The images were evaluated by BRH method by 7 observers on the viewer having a brightness of 3200 cd/m². The evaluation points were the average values as to 30 samples, and higher point corresponding to superior image quality in both of the anatomical evaluation and the physical evaluation. Results of the evaluation are listed in Tables 1 through 3.

TABLE 1

| | No. | | | | | | | | | |
|---|---|---|---|---|---|---|---|---|---|---|
| | No. 1 | | No. 2 | | No. 3 | | No. 4 | | No. 5 | |
| | u* | v* | u* | v* | u* | v* | u* | v* | u* | v* |
| Dmin | −12.6 | −13.1 | −13.9 | −10.8 | −12.1 | −11.2 | −12.8 | −13.8 | −13.4 | −15.4 |
| D = 0.5 | −11.5 | −13.4 | −13.2 | −11.2 | −11.3 | −11.7 | −12.2 | −13.8 | −12.5 | −14.4 |
| D = 1.0 | −8.0 | −12.6 | −8.4 | −11.0 | −7.9 | −11.9 | −8.2 | −12.0 | −8.3 | −9.3 |
| D = 1.5 | −4.8 | −9.3 | −5.1 | −7.9 | −4.7 | −9.1 | −4.8 | −8.6 | −4.9 | −5.5 |

| R² | 0.817 | | 0.630 | | 0.512 | | 0.949*¹ | | 1.000 | |
|---|---|---|---|---|---|---|---|---|---|---|
| Ordinate intercept | −7.6 | | −7.3 | | −8.6 | | −5.6*¹ | | 0.4 | |
| Gradient | 0.5 | | 0.3 | | 0.3 | | 0.7*¹ | | 1.2 | |
| Kind of compound | (4) | | (4) | | (4) | | (6) | | (4) | |
| employed in | | | | | | | | | | |
| Additive Solution | | | | | | | | | | |
| “e” | | | | | | | | | | |
| Kind of the | None | | (2-6) | | (2-6) | | (2-6) | | (2-6) | |
| compound | | | | | | | | | | |
| represented by | | | | | | | | | | |
| Formula A-4 | | | | | | | | | | |
| Adding amount of | None | | 3.08 | | 3.08 | | 3.08 | | 3.08 | |
| the compound | | | | | | | | | | |
| represented by | | | | | | | | | | |
| Formula A-4 (g) | | | | | | | | | | |
| Kind and Amount of | (1-18) | | (1-6) | | ▴27.98 | g | (1-18) | | (1-6) | |
| the reducing agent | 27.98 | g | 27.98 | g | | | 27.98 | g | 4.2 | g |
| | | | | | | | | | (1-18) | |
| | | | | | | | | | 23.78 | g |
| Image quality | | | | | | | | | | |
| Anatomical | 76 | | 78 | | 80 | | 83 | | 91 | |
| evaluation | | | | | | | | | | |
| Physical | 77 | | 79 | | 79 | | 82 | | 89 | |
| evaluation | | | | | | | | | | |

| | | | | | |
|---|---|---|---|---|---|
| Remarks | Comp. | Comp. | Comp. | Comp. | Inv. |

*1: is calculated from the value at D = 0.5, 1.0 and 1.5
▴: 1,1-bis(2-hydroxy-3,5-dimethylphenyl)-3,5,5-trimethylhexane
Comp.; Comparative
Inv.; Inventive

TABLE 2

| | No. | | | | | | | | | |
|---|---|---|---|---|---|---|---|---|---|---|
| | No. 6 | | No. 7 | | No. 8 | | No. 9 | | No. 10 | |
| | u* | u* | v* | u* | v* | u* | v* | u* | v* | v* |
| Dmin | −15.5 | −17.1 | −17.4 | −16.3 | −16.4 | −16.3 | −13.4 | −13.8 | −15.5 | −15.2 |
| D = 0.5 | −14.6 | −16.0 | −15.9 | −15.2 | −15.1 | −15.2 | −12.3 | −14.1 | −13.9 | −15.4 |
| D = 1.0 | −9.8 | −10.9 | −10.0 | −11.1 | −9.7 | −10.8 | −8.1 | −9.0 | −9.2 | −10.3 |
| D = 1.5 | −6.0 | −6.4 | −5.7 | −7.8 | −5.6 | −7.2 | −4.7 | −5.1 | −5.4 | −5.9 |

| | | | | | | | | | | |
|---|---|---|---|---|---|---|---|---|---|---|
| R² | 1.000 | | 0.999 | | 1.000 | | 1.000*¹ | | 1.000*¹ | |
| Ordinate intercept | 0.3 | | −3.8 | | −2.5 | | 0.5*¹ | | 0.1*¹ | |
| Gradient | 1.1 | | 0.7 | | 0.8 | | 1.2*¹ | | 1.1*¹ | |
| Kind of compound | (4) | | (4) | | (4) | | (6) | | (13) | |
| employed in | | | | | | | | | | |
| Additive Solution | | | | | | | | | | |
| “e” | | | | | | | | | | |
| Kind of the | (2-6) | | (2-6) | | (2-7) | | (2-7) | | (2-6) | |
| compound | | | | | | | | | | |
| represented by | | | | | | | | | | |
| Formula A-4 | | | | | | | | | | |
| Adding amount of | 3.08 | | 3.08 | | 3.08 | | 3.08 | | 3.08 | |
| the compound | | | | | | | | | | |
| represented by | | | | | | | | | | |
| Formula A-4 (g) | | | | | | | | | | |
| Kind and Amount of | (1-10) | | (1-10) | | (1-6) | | (1-10) | | (1-6) | |
| the reducing agent | 4.2 | g | 4.2 | g | 4.2 | g | 4.2 | g | 4.2 | g |
| | (1-18) | | (1-35) | | (1-18) | | (1-18) | | (1-18) | |
| | 23.78 | g | 23.78 | g | 23.78 | g | 23.78 | g | 23.78 | g |
| Image quality | | | | | | | | | | |
| Anatomical | 92 | | 89 | | 89 | | 91 | | 90 | |
| evaluation | | | | | | | | | | |
| Physical | 90 | | 87 | | 88 | | 92 | | 91 | |
| evaluation | | | | | | | | | | |

| | | | | | |
|---|---|---|---|---|---|
| Remarks | Inv. | Inv. | Inv. | Inv. | Inv. |

*1: is calculated from the value at D = 0.5, 1.0 and 1.5
Inv.; Inventive

TABLE 3

| | No. | | | | | | | | | |
|---|---|---|---|---|---|---|---|---|---|---|
| | No. 11 | | No. 12 | | No. 13 | | No. 14 | | No. 15 | |
| | u* | v* | a* | b* | a* | b* | a* | b* | a* | b* |
| Dmin | −17.4 | −13.8 | −5.3 | −9.8 | −6.0 | −12.1 | −5.1 | −11.0 | −7.7 | −10.5 |
| D = 0.5 | −15.0 | −14.1 | −4.9 | −10.3 | −5.6 | −11.3 | −4.6 | −10.2 | −6.9 | −10.9 |
| D = 1.0 | −9.0 | −10.1 | −2.6 | −10.3 | −4.3 | −8.6 | −3.6 | −7.5 | −4.5 | −7.5 |
| D = 1.5 | −4.8 | −7.0 | −1.0 | −9.0 | −3.4 | −6.2 | −2.5 | −4.9 | −2.8 | −4.5 |

| R² | 0.999*¹ | | 0.382 | | 0.998 | | 0.998 | | 0.999*¹ | |
|---|---|---|---|---|---|---|---|---|---|---|
| Ordinate intercept | −3.7*¹ | | −9.2 | | 1.0 | | 1.1 | | −0.4*¹ | |
| Gradient | 0.7*¹ | | 0.2 | | 2.2 | | 2.4 | | 1.5 | |
| Kind of compound | 13 | | 4 | | 6 | | 13 | | 13 | |
| employed in | | | | | | | | | | |
| Additive Solution | | | | | | | | | | |
| “e” | | | | | | | | | | |
| Kind of the | (2-6) | | None | | (2-6) | | (2-7) | | (2-7) | |
| compound | | | | | | | | | | |
| represented by | | | | | | | | | | |
| Formula A-4 | | | | | | | | | | |
| Adding amount of | 3.08 | | None | | 3.08 | | 3.08 | | 3.08 | |
| the compound | | | | | | | | | | |
| represented by | | | | | | | | | | |
| Formula A-4 (g) | | | | | | | | | | |
| Kind and Amount of | (1-10) | | (1-18) | | (1-10) | | (1-6) | | (1-10) | |
| the reducing agent | 4.2 | g | 27.98 | g | 4.2 | g | 4.2 | g | 4.2 | g |
| | (1-18) | | | | (1-18) | | (1-18) | | (1-18) | |
| | 23.78 | g | | | 23.78 | g | 23.78 | g | 23.78 | g |
| Image quality | | | | | | | | | | |
| Anatomical | 89 | | 74 | | 90 | | 91 | | 88 | |
| evaluation | | | | | | | | | | |
| Physical | 90 | | 76 | | 92 | | 91 | | 89 | |
| evaluation | | | | | | | | | | |

| | | | | | |
|---|---|---|---|---|---|
| Remarks | Inv. | Comp. | Inv. | Inv. | Inv. |

*1: is calculated from the value at D = 0.5, 1.0 and 1.5
Comp.; Comparative
Inv.; Inventive

It is clear that the thermally developable light-sensitive materials according to the invention are superior to the comparative materials since the evaluation points of the former are higher that those of the later in both of the anatomical evaluation and the physical evaluation.

### Effects of the Invention

According to the present invention, the thermally developable light-sensitive material and the image forming method having the higher image quality and image diagnosis suitability than those of the usual wet processing silver halide photographic material.

What is claimed is:

1. A thermally developable light-sensitive material comprising a support having thereon light-sensitive silver halide grains, an organic silver halide salt and a reducing agent,
wherein when a regression line is obtained by plotting color coordinates (u*, v*) of the thermally developable light-sensitive material at optical densities of 0.5, 1.0, 1.5 and the minimum density on a two dimensional coordinates of CIE 1976 (L* u* v*) color space, in which the abscissa is u* and the ordinate is v*,
a coefficient of determination R² of the regression line is from 0.998 to 1.000.

2. The thermally developable light-sensitive material of claim 1, wherein v* value of the regression line is within a range of −5 to 5 when u* is 0.

3. The thermally developable light-sensitive material of claim 1, wherein the regression line has a gradient (u*/v*) of 0.7 to 2.5.

4. A thermally developable light-sensitive material comprising a support having thereon light-sensitive silver halide grains, an organic silver halide salt and a reducing agent,
wherein when a regression line is obtained by plotting color coordinates (a*, b*) of the thermally developable light-sensitive material at optical densities of 0.5, 1.0, 1.5 and the minimum density on a two dimensional coordinates of CIE 1976 (L* a* b*) color space, in which the abscissa is a* and the ordinate is b*,
a coefficient of determination R² of the regression line is from 0.998 to 1.000.

5. The thermally developable light-sensitive material of claim 4, wherein b* value of the regression line is within a range of −5 to 5 when a* is 0.

6. The thermally developable light-sensitive material of claim 4, wherein the regression line has a gradient (a*/b*) of 0.7 to 2.5.

7. A thermally developable light-sensitive material comprising a support having thereon light-sensitive silver halide grains, an organic silver halide salt and a reducing agent,
wherein when a regression line is obtained by plotting color coordinates (u*, v*) of the thermally developable light-sensitive material at optical densities of 0.5, 1.0 and 1.5 on a two dimensional coordinates of CIE 1976 (L* u* v*) color space, in which the abscissa is u* and the ordinate is v*,
a coefficient of determination R² of the regression line is from 0.998 to 1.000.

8. The thermally developable light-sensitive material of claim 7, wherein v* value of the regression line is within a range of −5 to 5 when u* is 0.

9. The thermally developable light-sensitive material of claim 7, wherein the regression line has a gradient (u*/v*) of 0.7 to 2.5.

10. A thermally developable light-sensitive material comprising a support having thereon light-sensitive silver halide grains, an organic silver halide salt and a reducing agent,
wherein when a regression line is obtained by plotting color coordinates (a*, b*) of the thermally developable light-sensitive material at optical densities of 0.5, 1.0 and 1.5 on a two dimensional coordinates of CIE 1976 (L* a* b*) color space, in which the abscissa is a* and the ordinate is b*,
a coefficient of determination R² of the regression line is from 0.998 to 1.000.

11. The thermally developable light-sensitive material of claim 10, wherein b* value of the regression line is within a range of −5 to 5 when a* is 0.

12. The thermally developable light-sensitive material of claim 10, wherein the regression line has a gradient (a*/b*) of 0.7 to 2.5.

13. The thermally developable light-sensitive material of claim 1, comprising a reducing agent represented by following Formula (A-1) and a compound represented by following Formula (A-4), 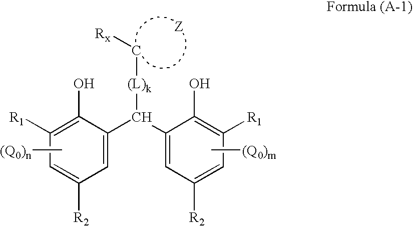
wherein Z is a group of atoms necessary for forming a 3- through 10-membered ring together with the carbon atom; Rₓ is a hydrogen atom, an alkyl group, an alkenyl group or alkynyl group; R₁, R₂ and Q₀ are each a group capable of substituting on the benzene ring; L is divalent linking group; k is an integer of 0 or 1; and n and m are each an integer of 0 through 2; plural R₁, R₂ and Q₀ each may be the same or different, 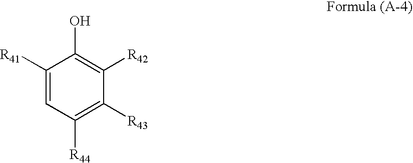
wherein R₄₁ is a substituted or unsubstituted alkyl group; R₄₂ is a hydrogen atom, a substituted or unsubstituted alkyl group or a substituted or unsubstituted acylamino group provided that R₄₁ and R₄₂ are not a 2-hydroxyphenylmethyl group; R₄₃ is a hydrogen atom of a substituted or unsubstituted alkyl group; and R₄₄ is a substituent capable of substituting on the benzene ring.

14. The thermally developable light-sensitive material of claim 13, wherein at least one of R₄₁ and R₄₂ is a divalent or trivalent alkyl group.

15. The thermally developable light-sensitive material of claim 13, wherein the reducing agent represented by Formula (A-1) is a reducing agent represented by following Formula (A-2), 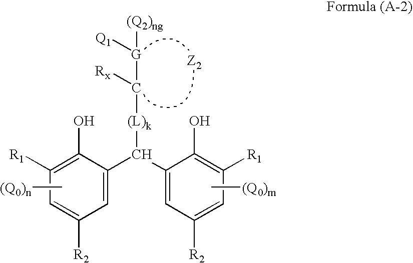
wherein Q₁ is a halogen atom, an alkyl group, an alkenyl group, an alkynyl group, an aryl group or a heterocyclic group; Q₂ is a hydrogen atom, a halogen atom, an alkyl group, an alkenyl group, an alkynyl group, an aryl group or a heterocyclic group; G is a nitrogen atom or a carbon atom that ng is 0 when G is the nitrogen atom and ng is 0 or 1 when the G is the oxygen atom; Z₂ is is a group of atoms necessary for forming a 3- through 10-membered non-aromatic ring together with the carbon atom and G; and R₁, R₂, Rₓ, Q₀, L, k, n and m are each the same as those in Formula A-1.

16. The thermally developable light-sensitive material of claim 15, wherein the non-aromatic ring formed by Z₂ together with the carbon atom and G in Formula (A-2) is a 6-member non-aromatic ring.

17. The thermally developable light-sensitive material of claim 1, wherein the thermally developable light-sensitive material further comprises a silver saving agent selected from the group consisiting of vinyl compounds, hydrazine derovatives, silane compounds and tetravalent onium salt on the silver halide grain side of the support.

18. An image forming method comprising the step of forming an image by developing the thermally developable light sensitive material described in claim 1 under a temperature of from 110° C. to 140° C. for a time of from 5 seconds to 20 seconds.

19. An image forming method comprising the step of forming an image by exposing the thermally developable light-sensitive material described in claim 1 with a laser having an wavelength of from 400 nm to 830 nm.

20. An image forming method comprising the step of forming an image by exposing the thermally developable light-sensitive material described in claim 1 with an laser having an wavelength of from 780 nm to 830 nm.
